(19) United States
(12) Patent Application Publication
(10) Pub. No.: US 2025/0300866 A1
(43) Pub. Date: Sep. 25, 2025

(54) METHOD AND DEVICE FOR FULL-DUPLEX COMMUNICATION IN WIRELESS COMMUNICATION SYSTEM

(71) Applicant: Samsung Electronics Co., Ltd., Gyeonggi-do (KR)

(72) Inventors: Kyungjun CHOI, Gyeonggi-do (KR); Hyoungju JI, Gyeonggi-do (KR); Hyemin CHOE, Gyeonggi-do (KR); Younsun KIM, Gyeonggi-do (KR)

(21) Appl. No.: 19/085,283

(22) Filed: Mar. 20, 2025

(30) Foreign Application Priority Data
Mar. 22, 2024 (KR) 10-2024-0039751
Apr. 18, 2024 (KR) 10-2024-0052351

(51) Int. Cl. H04L 27/26; H04L 1/00; H04L 5/14; H04W 8/22

(52) U.S. Cl. CPC H04L 27/2605; H04L 1/0003; H04L 5/14; H04L 27/26025; H04W 8/22

(57) ABSTRACT

The disclosure relates to a 5G or 6G communication system for supporting a higher data transmission rate. In particular, the disclosure provides a method for configuring SBFD frequency resources in a wireless communication system. A method performed by a UE includes receiving, from a base station, first information on a guard band between a UL subband and a DL subband for an SBFD via system information, wherein the first information on the guard band is cell-specific; transmitting, to the base station, capability information on the guard band of the UE; obtaining second information on the guard band, wherein the second information is UE-specific; and identifying the UL subband, the DL subband, and the guard band based on the first information and the second information

### CROSS-REFERENCE TO RELATED APPLICATION(S)

This application is based on and claims priority under 35 U.S.C. § 119 to Korean Patent Application Nos. 10-2024-0039751 and 10-2024-0052351, which were filed in the Korean Intellectual Property Office on Mar. 22, 2024, and Apr. 18, 2024, respectively, the entire disclosure of each of which is herein incorporated by reference.

### BACKGROUND

### 1. Field

The disclosure relates generally to operations of a user equipment (UE) and a base station in a wireless communication system, and more particularly, to an apparatus and method for performing subband non-overlapping full-duplex (SBFD) transmission.

### 2. Description of Related Art

5^{th} generation (5G) mobile communication technologies define broad frequency bands to enable high transmission rates and new services, and can be implemented not only in “sub 6 GHz” bands such as 3.5 GHZ, but also in “above 6 GHz” bands referred to as mm Wave including 28 GHz and 39 GHz. In addition, it has been considered to implement 6^{th} generation (6G) mobile communication technologies (referred to as Beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

Since the initial stages of 5G mobile communication technologies, in order to support services and to satisfy performance requirements in connection with enhanced mobile broadband (eMBB), ultra reliable & low latency communications (URLLC), and massive machine-type communications (mMTC), there has been ongoing standardization regarding beamforming and massive multi-input multi-output (MIMO) for alleviating radio-wave path loss and increasing radio-wave transmission distances in mmWave, numerology (e.g., operating multiple subcarrier spacings (SCSs) for efficiently utilizing mm Wave resources and dynamic operation of slot formats, initial access technologies for supporting multi-beam transmission and broadbands, definition and operation of a bandwidth part (BWP), new channel coding methods such as a low density parity check (LDPC) code for large-capacity data transmission and a polar code for highly reliable transmission of control information, layer 2 (L2) pre-processing, and network slicing for providing a dedicated network customized to a specific service.

There are also ongoing discussions regarding improvement and performance enhancement of initial 5G mobile communication technologies in view of services to be supported by newer 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) UE power saving, a non-terrestrial network (NTN), which is UE-satellite direct communication for securing coverage in an area in which communication with terrestrial networks is unavailable, and positioning.

There is ongoing standardization in wireless interface architecture/protocol fields regarding technologies such as industrial Internet of things (IIOT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There is also ongoing standardization in system architecture/service fields regarding a 5G baseline architecture (e.g., service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for securing coverage in THz bands of 6G mobile communication technologies, full dimensional MIMO (FD-MIMO), multi-antenna transmission technologies such as array antennas and large-scale antennas, metamaterial-based lenses and antennas for improving coverage of THz band signals, high-dimensional space multiplexing technology using orbital angular momentum (OAM), and reconfigurable intelligent surface (RIS), and also full-duplex (FD) technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to smoothly provide these services.

### SUMMARY

An aspect of the disclosure is to provide a device and a method capable of effectively providing services in a wireless communication system.

Another aspect of the disclosure is to provide a method and a device for frequency domain resource configurations in SBFD.

In accordance with an aspect of the disclosure, a method performed by a UE in a communication system is provided. The method includes receiving, from a base station, first information on a guard band between a UL subband and a DL subband for an SBFD via system information, wherein the first information on the guard band is cell-specific; transmitting, to the base station, capability information on the guard band of the UE; obtaining second information on the guard band, wherein the second information is UE-specific; and identifying the UL subband, the DL subband, and the guard band based on the first information and the second information

In accordance with an aspect of the disclosure, a method performed by a base station in a communication system is provided. The method includes transmitting, to a UE, first information on a guard band between a UL subband and a DL subband for an SBFD via system information, wherein the first information on the guard band is cell-specific; receiving, from the UE, capability information on the guard band of the UE; and identifying the UL subband, the DL subband, and the guard band based on the first information and the capability information.

In accordance with an aspect of the disclosure, a UE is provided for use in a communication system. The UE includes a transceiver; and a controller configured to receive, from a base station, first information on a guard band between a UL subband and a DL subband for an SBFD via system information, wherein the first information on the guard band is cell-specific, transmit, to the base station, capability information on the guard band of the UE, obtain second information on the guard band, wherein the second information is UE-specific, and identify the UL subband, the DL subband, and the guard band based on the first information and the second information.

In accordance with an aspect of the disclosure, a base station is provided for use in a communication system. The base station includes a transceiver; and a controller configured to transmit, to a UE, first information on a guard band between a UL subband and a DL subband for an SBFD via system information, wherein the first information on the guard band is cell-specific, receive, from the UE, capability information on the guard band of the UE, and identify the UL subband, the DL subband, and the guard band based on the first information and the capability information.

Embodiments set forth herein provide a device and a method capable of effectively providing services in a wireless communication system. In particular, the embodiments make it possible to efficiently configure frequency domain resources in order to provide services using SBFD.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a time-frequency domain in a wireless communication system according to an embodiment;

FIG. 2 illustrates a structure of a frame, a subframe, and a slot in a wireless communication system according to an embodiment;

FIG. 3 illustrates an example of a BWP configuration in a wireless communication system according to an embodiment;

FIG. 4 illustrates an example of a control resource set (CORESET) configuration of a downlink (DL) control channel in a wireless communication system according to an embodiment;

FIG. 5 illustrates a structure of a DL control channel in a wireless communication system according to an embodiment;

FIG. 6 illustrates a method in which a base station and a UE transmit/receive data inconsideration of a DL data channel and a rate matching resource in a wireless communication system according to an embodiment;

FIG. 7 illustrates an example of frequency domain resource allocation with regard to a physical DL shared channel (PDSCH) in a wireless communication system according to an embodiment;

FIG. 8 illustrates an example of time domain resource allocation with regard to a PDSCH in a wireless communication system according to an embodiment;

FIG. 9 illustrates an example of time domain resource allocation according to a SCS with regard to a data channel and a control channel in a wireless communication system according to an embodiment;

FIG. 10 illustrates radio protocol structures of a base station and a UE in single cell, carrier aggregation (CA), and dual connectivity (DC) situations in a wireless communication system according to an embodiment;

FIG. 11 illustrates a random access procedure according to an embodiment;

FIG. 12 illustrates an example in which SBFD is operated in a time division duplex (TDD) band of a wireless communication system to which the disclosure is applied;

FIG. 13 illustrates examples of an uplink (UL) subband, DL subbands, and guard bands interpreted based on common resource blocks (CRBs) of SCS μ′ according to method 3 according to an embodiment;

FIG. 14 illustrates a UL subband, DL subbands, and guard bands interpreted based on CRBs of SCS μ′ according to method 4 according to an embodiment;

FIG. 15 illustrates an example of a UL subband, DL subbands, and guard bands interpreted based on CRBs of SCS μ′ according to a guard band determination method and method 3 according to an embodiment;

FIG. 16 illustrates an example of a UL subband, DL subbands, and guard bands interpreted based on CRBs of SCS μ′ according to a guard band determination method and method 4 according to an embodiment;

FIG. 17 illustrates an example of a frequency axis configuration for an SBFD operation according to an embodiment;

FIG. 18 illustrates an example of a frequency axis configuration for an SBFD operation according to an embodiment;

FIG. 19 illustrates an example of a frequency axis configuration for an SBFD operation according to an embodiment;

FIG. 20 illustrates an example of a method of adding virtual resource blocks (RBs) to a frequency band where a DL subband and an UL subband are located according to an embodiment;

FIG. 21 illustrates an example of a method of adding virtual RBs to a frequency band where a DL subband and an UL subband are located according to an embodiment;

FIG. 22 illustrates an example of a method in which a UE determines a UE-specific subband based on subband and guard band configurations according to an embodiment.

FIG. 23 illustrates a UE in a wireless communication system according to an embodiment; and

FIG. 24 illustrates a base station in a wireless communication system according to an embodiment.

### DETAILED DESCRIPTION

Hereinafter, various embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

In the accompanying drawings, some elements may be exaggerated, omitted, or schematically illustrated. Furthermore, the size of each element does not completely reflect the actual size. In the respective drawings, the same or corresponding elements may be assigned the same reference numerals.

Advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

In describing the disclosure, a detailed description of known functions or configurations incorporated herein will be omitted when it is determined that the description may make the subject matter of the disclosure unnecessarily unclear.

The terms which will be described below are terms defined in consideration of the functions in the disclosure, and may be different according to users, intentions of the users, or customs. Therefore, the definitions of the terms should be made based on the contents throughout the specification.

Herein, a base station is an entity that allocates resources to terminals, and may be at least one of a gNode B, an eNode B, a Node B, a wireless access unit, a base station controller, and a node on a network. A terminal may include a UE, a mobile station (MS), a cellular phone, a smartphone, a computer, or a multimedia system capable of performing a communication function.

In the disclosure, a “DL” refers to a radio link via which a base station transmits a signal to a terminal, and a “UL” refers to a radio link via which a terminal transmits a signal to a base station.

Furthermore, in the following description, long term evolution (LTE) or LTE-Advanced (A) systems may be described by way of example, but the embodiments of the disclosure may also be applied to other communication systems having similar technical backgrounds or channel types. Examples of such communication systems may include 5G mobile communication technologies (e.g., NR) developed beyond LTE-A, and in the following description, “5G” may be referred to as a concept that covers the exiting LTE, LTE-A, and other similar services.

In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block in the flowchart illustrations may represent a module, segment, or portion of code, which includes one or more executable instructions for implementing the specified logical function(s).

In some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), and a “unit” may perform certain functions. However, “unit” does not always have a meaning limited to software or hardware. The “unit” may be constructed either to be stored in an addressable storage medium or to execute one or more processors. Therefore, the “unit” includes, e.g., software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (or evolved universal terrestrial radio access (E-UTRA)), LTE-A, LTE-Pro, high-rate packet data (HRPD) of 3GPP2, ultra-mobile broadband (UMB), IEEE 802.16e, etc., as well as typical voice-based services.

As an example of a broadband wireless communication system, an LTE system employs an orthogonal frequency division multiplexing (OFDM) scheme in a DL and employs a single carrier frequency division multiple access (SC-FDMA) scheme in a UL. The UL refers to a radio link via which a UE or an MS transmits data or control signals to a base station or eNode B, and the DL refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, should freely reflect various requirements of users, service providers, etc., services satisfying various requirements must be supported. The services considered in the 5G communication system include eMBB communication, mMTC, URLLC, etc.

eMBB aims at providing a data rate higher than that supported by existing LTE, LTE-A, or LTE-Pro. For example, in a 5G communication system, eMBB should provide a peak data rate of 20 Gbps in the DL and a peak data rate of 10 Gbps in the UL for a single base station. Furthermore, the 5G communication system should provide an increased user-perceived data rate to the UE, as well as the maximum data rate. In order to satisfy such requirements, transmission/reception technologies including a further enhanced MIMO transmission technique should be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of things (IoT) in the 5G communication system. mMTC has requirements, such as support of connection of a large number of UEs in a cell, enhancement coverage of UEs, improved battery time, a reduction in the cost of a UE, etc., in order to effectively provide IoT. Since the IoT provides communication functions while being provided to various sensors and various devices, it should support a large number of UEs (e.g., 1,000,000 UEs/km²) in a cell.

In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

URLLC is a cellular-based mission-critical wireless communication service. For example, URLLC may be used for services such as remote control for robots or machines, industrial automation, unmanned aerial vehicles, remote health care, and emergency alert. Thus, URLLC should provide communication with ultra-low latency and ultra-high reliability. For example, a service supporting URLLC should satisfy an air interface latency of less than 0.5 ms, and have a packet error rate of 10-5 or less. Therefore, for the services supporting URLLC, a 5G system should provide a transmit time interval (TTI) shorter than those of other services, and also may require a design for assigning a large number of resources in a frequency band in order to secure reliability of a communication link.

The three services in 5G, i.e., eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

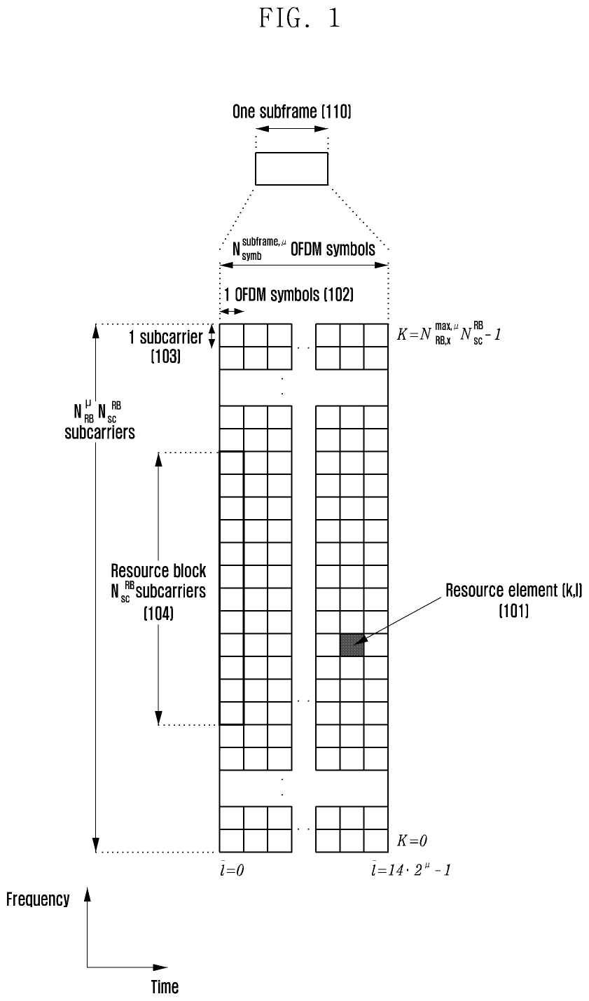

FIG. 1 illustrates a basic structure of a time-frequency domain in a wireless communication system according to an embodiment. More specifically, FIG. 1 illustrates a structure of a time-frequency domain, which is a radio resource domain used to transmit data or control channels, in a 5G system.

Referring to FIG. 1, the horizontal axis denotes a time domain, and the vertical axis denotes a frequency domain. A basic unit of resources in the time-frequency domain is a resource element (RE) 101, which may be defined as one OFDM symbol 102 on the time axis and one subcarrier 103 on the frequency axis. In the frequency domain, N_{SC}^{RB} (e.g., 12) consecutive REs may constitute one RB 104.

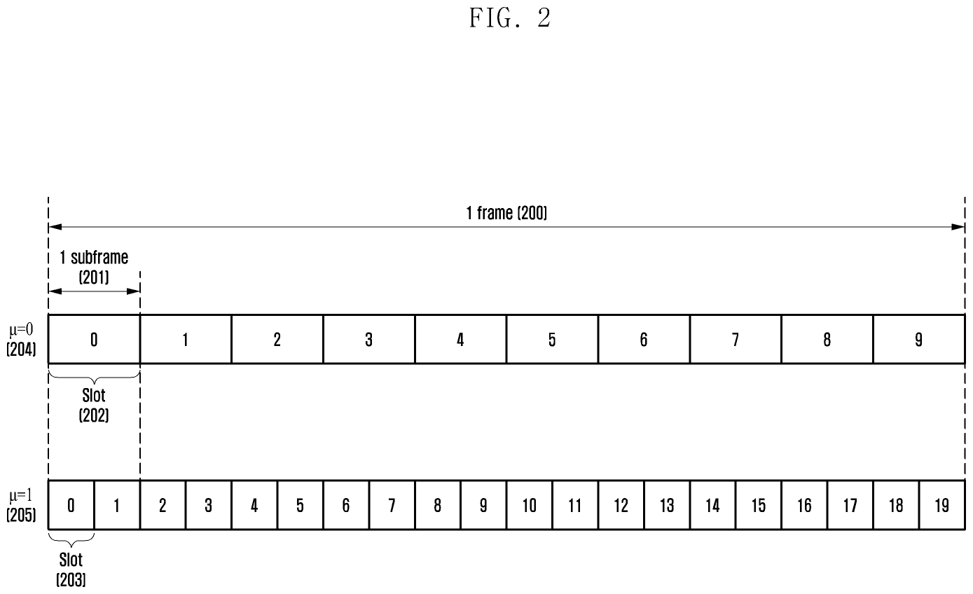

FIG. 2 illustrates a structure of a frame, a subframe, and a slot in a wireless communication system according to an embodiment.

Referring to FIG. 2, structures of a frame 200, a subframe 201, and a slot 202 are illustrated, wherein one frame 200 may be defined as 10 ms, one subframe 201 may be defined as 1 ms, and thus, one frame 200 may include a total of ten subframes 201. One slot 202 or 203 may be defined as 14 OFDM symbols (i.e., the number of symbols per one slot N_{symb}^{slot}=14). One subframe 201 may include one or multiple slots 202 and 203, and the number of slots 202 and 203 per one subframe 201 may vary depending on configuration values u for the SCS 204 or 205. The example in FIG. 2 illustrates a case in which the SCS configuration value is μ=0 (204), and a case in which μ=1 (205).

In the case of μ=0 (204), one subframe 201 may include one slot 202, and in the case of μ=1 (205), one subframe 201 may include two slots 203. That is, the number of slots per one subframe Nₛₗₒₜ^{subframe,μ} may differ depending on the SCS configuration value μ, and the number of slots per one frame Nₛₗₒₜ^{frame,μ} may differ accordingly. Nₛₗₒₜ^{subframe,μ} and Nₛₗₒₜ^{frame,μ} may be defined according to each SCS configuration u as in Table 1 below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

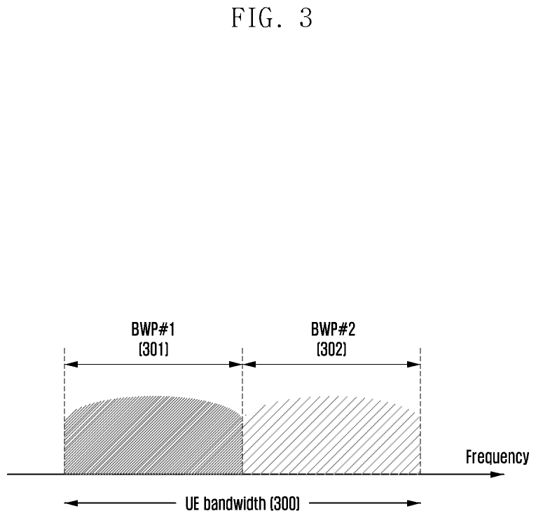

FIG. 3 illustrates an example of a BWP configuration in a wireless communication system according to an embodiment.

Referring to FIG. 3, a UE bandwidth 300 is configured to include two BWPs, i.e., BWP #1 301 and BWP #2 302.

A base station may configure one or multiple BWPs for a UE, and may configure the following pieces of information with regard to each BWP as given in Table 2 below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, |

```
    n5},
    (subcarrier spacing)
```

| | |
|---|---|
| cyclicPrefix | ENUMERATED { extended } |

(cyclic prefix)
}

The above example in Table 2 is not limiting, and various parameters related to the BWP may be configured for the UE, in addition to the above configuration information. The base station may transfer the configuration information to the UE through higher layer signaling, e.g., radio resource control (RRC) signaling. One configured BWP or at least one BWP among multiple configured BWPs may be activated. Whether or not the configured BWP is activated may be transferred from the base station to the UE semi-statically through RRC signaling, or dynamically through DL control information (DCI).

According to an embodiment, before an RRC connection, an initial BWP for initial access may be configured for the UE by the base station through a master information block (MIB). More specifically, the UE may receive configuration information regarding a CORESET and a search space which may be used to transmit a physical DL control channel (PDCCH) for receiving system information (SI) (which may correspond to remaining system information (RMSI) or system information block 1 (SIB1) necessary for initial access through the MIB in the initial access step. Each of the CORESET and the search space configured through the MIB may be considered identity (ID) 0. The base station may notify the UE of configuration information, such as frequency allocation information, time allocation information, and numerology, regarding CORESET #0 through the MIB. In addition, the base station may notify the UE of configuration information regarding the monitoring periodicity and occasion with regard to CORESET #0, that is, configuration information regarding search space #0, through the MIB. The UE may consider that a frequency domain configured by CORESET #0 acquired from the MIB is an initial BWP for initial access. The ID of the initial BWP may be considered to be 0.

The BWP-related configuration supported by 5G may be used for various purposes.

According to an embodiment, if the bandwidth supported by the UE is smaller than the system bandwidth, this may be supported through the BWP configuration. For example, the base station may configure the frequency location (configuration information 2) of the BWP for the UE, so that the UE can transmit/receive data at a specific frequency location within the system bandwidth.

In addition, the base station may configure multiple BWPs for the UE for the purpose of supporting different numerologies. For example, in order to support a UE's data transmission/reception using both a SCS of 15 kHz and a SCS of 30 kHz, two BWPs may be configured as SCSs of 15 kHz and 30 kHz, respectively. Different BWPs may be subjected to frequency division multiplexing (FDM), and if data is to be transmitted/received at a specific SCS, the BWP configured as the corresponding SCS may be activated.

In addition, the base station may configure BWPs having different sizes of bandwidths for the UE for the purpose of reducing power consumed by the UE. For example, if the UE supports a substantially large bandwidth, e.g., 100 MHz, and always transmits/receives data with the corresponding bandwidth, a substantially large amount of power consumption may occur.

Particularly, it may be inefficient from the viewpoint of power consumption to unnecessarily monitor the DL control channel with a large bandwidth of 100 MHz in the absence of traffic. In order to reduce power consumed by the UE, the base station may configure a BWP of a relatively small bandwidth (e.g., a BWP of 20 MHz) for the UE. The UE may perform a monitoring operation in the 20 MHz BWP in the absence of traffic, and may transmit/receive data with the 100 MHz BWP as instructed by the base station if data has occurred.

In connection with the BWP configuring method, UEs, before being RRC-connected, may receive configuration information regarding the initial BWP through an MIB in the initial access step. More specifically, a UE may have a CORESET configured for a DL control channel which may be used to transmit DCI for scheduling a system information block (SIB) from the MIB of a physical broadcast channel (PBCH). The bandwidth of the CORESET configured by the MIB may be considered as the initial BWP, and the UE may receive, through the configured initial BWP, a PDSCH through which an SIB is transmitted. The initial BWP may be used not only for the purpose of receiving the SIB, but also for other system information (OSI), paging, random access, etc.

If a UE has one or more BWPs configured therefor, the base station may indicate, to the UE, to change (or switch or transition) the BWPs by using a BWP indicator field inside DCI. For example, if a currently activated BWP of the UE is BWP #1 301 in FIG. 3, the base station may indicate BWP #2 302 with a BWP indicator inside DCI, and the UE may change the BWP to BWP #2 302 indicated by the BWP indicator inside received DCI.

As described above, DCI-based BWP changing may be indicated by DCI for scheduling a PDSCH or a PUSCH, and thus, upon receiving a BWP change request, the UE should to be able to receive or transmit the PDSCH or PUSCH scheduled by the corresponding DCI in the changed BWP with no problem. To this end, requirements for the delay time (T_{BWP}) required during a BWP change are specified in standards, and may be defined given in Table 3 below, for example.

TABLE 3

| | NR Slot | BWP switch delay T_{BWP} (slots) | |
|---|---|---|---|
| μ | length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
^{Note 2}:
If the BWP switch involves changing of SCS, the BWP switch delay is determined by the larger one between the SCS before BWP switch and the SCS after BWP switch.

As requirements for the BWP change delay time support type 1 or type 2 may depend on a capability of a UE, the UE may report a supportable BWP change delay time type to a base station.

If the UE has received DCI including a BWP change indicator in slot n, according to the above-described requirement regarding the BWP change delay time, the UE may complete a change to the new BWP indicated by the BWP change indicator at a timepoint not later than slot n+T_{BWP}, and may transmit/receive a data channel scheduled by the corresponding DCI in the newly changed BWP. If the base station wants to schedule a data channel by using the new BWP, the base station may determine time domain resource allocation regarding the data channel, based on the UE's BWP change delay time (T_{BWP}). That is, when scheduling a data channel by using the new BWP, the base station may schedule the corresponding data channel after the BWP change delay time, in connection with the method for determining time domain resource allocation regarding the data channel. Accordingly, the UE may not expect that the DCI that indicates a BWP change will indicate a slot offset (K0 or K2) value smaller than the BWP change delay time (T_{BWP}).

If the UE has received DCI (e.g., DCI format 1_1 or 0_1) indicating a BWP change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a BWP change in slot n, and if the slot offset value indicated by the corresponding DCI is K, the UE may perform no transmission or reception from the third symbol of slot n to the symbol before slot n+K (e.g., the last symbol of slot n+K−1).

A synchronization signal (SS)/PBCH block may refer to a physical layer channel block including a primary SS (PSS), a secondary SS (SSS), and a PBCH.

A PSS is a signal that becomes a reference of DL time/frequency synchronization, and provides partial information of a cell ID.

An SSS becomes a reference of DL time/frequency synchronization, and provides remaining cell ID information, not provided by the PSS. Additionally, the SSS may serve as a reference signal for PBCH demodulation of a PBCH.

A PBCH provides an MIB which is SI used for the UE to transmit/receive data channels and control channels. The SI may include search space-related control information indicating a control channel's radio resource mapping information, scheduling control information regarding a separate data channel for transmitting SI, etc.

An SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in an initial access stage, and may decode the PBCH. The UE may acquire an MIB from the PBCH, and this may be used to configure CORESET #0 (which may correspond to a CORESET having a CORESET index of 0). The UE may monitor CORESET #0 by assuming that the demodulation reference signal (DMRS) transmitted in the selected SS/PBCH block and CORESET #0 are quasi-co-located (QCL). The UE may receive SI with DCI transmitted in CORESET #0. The UE may acquire configuration information related to a random access channel (RACH) for initial access from the received SI. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that CORESET #0 associated therewith is monitored.

In a 5G system, scheduling information regarding UL data (or a physical UL shared channel (PUSCH)) or DL data (or a PDSCH) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a PDCCH after a channel coding and modulation process.

A cyclic redundancy check (CRC) may be attached to the DCI message payload, and the CRC may be scrambled by a radio network temporary identifier (RNTI) corresponding to the identity of the UE. Different RNTIs may be used according to the purpose of the DCI message, e.g., UE-specific data transmission, power control command, or random access response (RAR). That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding SI may be scrambled by an SI-RNTI. DCI for scheduling a PDSCH regarding an RAR message may be scrambled by a random access (RA)-RNTI. DCI for scheduling a PDSCH regarding a paging message may be scrambled by a paging (P)-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example.

TABLE 4

```
  - Identifier for DCI formats − [1] bit
  - Frequency domain resource assignment −[ ┌log₂
( N_{RB}^{UL,BWP}(N_{RB}^{UL,BWP} + 1)/2)┐ ] bits
  - Time domain resource assignment − X bits
  - Frequency hopping flag − 1 bit.
  - Modulation and coding scheme (MCS) − 5 bits
  - New data indicator − 1 bit
  - Redundancy version − 2 bits
  - Hybrid automatic repeat request (HARQ) process number − 4 bits
  - TPC command for scheduled PUSCH − [2] bits
  - UL/ supplementary UL (UL/SUL) indicator − 0 or 1 bit
```

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example.

TABLE 5

| - | Carrier indicator-0 or 3 bits | | |
|---|---|---|---|
| - | UL/SUL indicator-0 or 1 bit | | |
| - | Identifier for DCI formats-[1] bits | | |
| - | BWP indicator-0, 1 or 2 bits | | |
| - | Frequency domain resource assignment | | |
| | | * | $For resource allocation type 0 , ⌈ {N}_{RB}^{UL , BWP} / P ⌉ bits$ |
| | | * | $For resource allocation type 1 ,$ $⌈ {log}_{2} ( {N}_{RB}^{UL , BWP} ( {N}_{RB}^{UL , BWP} + 1 ) / 2 ) ⌉ bits$ |
| - | Time domain resource assignment-1, 2, 3, or 4 bits | | |
| - | Virtual RB (VRB)-to-physical RB (PRB) mapping-0 or 1 bit, only for | | |
| | resource allocation type 1. | | |
| | | * | 0 bit if only resource allocation type 0 is configured; |
| | | * | 1 bit otherwise. |
| - | Frequency hopping flag-0 or 1 bit, only for resource allocation type 1. | | |
| | | * | 0 bit if only resource allocation type 0 is configured; |
| | | * | 1 bit otherwise. |
| - | MCS-5 bits | | |
| - | New data indicator-1 bit | | |
| - | Redundancy version-2 bits | | |
| - | HARQ process number-4 bits | | |
| - | 1st DL assignment index-1 or 2 bits | | |
| | | * | 1 bit for semi-static HARQ-ACK codebook; |
| | | * | 2 bits for dynamic HARQ-ACK codebook with single HARQ-ACK |
| | | | codebook. |
| - | 2nd DL assignment index-0 or 2 bits | | |
| | | * | 2 bits for dynamic HARQ-ACK codebook with two HARQ-ACK |
| | | | sub-codebooks; |
| | | * | 0 bit otherwise. |
| | TPC command for scheduled PUSCH-2 bits | | |
| - | $SRS resource indicator - ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{S R S} ) ⌉ bits$ | | |
| | | * | $⌈ {log}_{2} ( {\sum }_{k = 1}^{{L}_{max} \sum } ( \begin{matrix}{N}_{SRS} \\ k\end{matrix} ) ) ⌉ bits for non - codebook based PUSCH$ |
| | | | transmission; |
| | | * | ┌log₂(N_{SRS})┐ bits for codebook based PUSCH transmission. |

| | |
|---|---|
| - | Precoding information and number of layers-up to 6 bits |
| - | Antenna ports-up to 5 bits |
| - | SRS request-2 bits |
| - | Channel state information (CSI) request-0, 1, 2, 3, 4, 5, or 6 bits |
| - | Code block group (CBG) transmission information-0, 2, 4, 6, or 8 its |
| - | Phase tracking reference signal (PTRS)-DMRS association-0 or 2 bits. |
| - | beta_offset indicator-0 or 2 bits |
| - | DMRS sequence initialization-0 or 1 bit |

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

```
TABLE 6
  - Identifier for DCI formats - [1] bit
  - Frequency domain resource assignment - [ ┌log₂(N_{RB}^{DL,BWP}(N_{RB}^{DL,BWP} + 1)/
2)┐ ] bits
  - Time domain resource assignment - X bits
  - VRB-to-PRB mapping - 1 bit.
  - MCS - 5 bits
  - New data indicator - 1 bit
  - Redundancy version - 2 bits
  - HARQ process number - 4 bits
  - DL assignment index - 2 bits
  - TPC command for scheduled PUCCH - [2] bits
  - PUCCH resource indicator - 3 bits
  - PDSCH-to-HARQ feedback timing indicator - [3] bits
```

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example.

```
TABLE 7
- Carrier indicator - 0 or 3 bits
- Identifier for DCI formats - [1] bits
- BWP indicator - 0, 1 or 2 bits
- Frequency domain resource assignment
    * For resource allocation type 0, ┌N_{RB}^{DL,BWP}/P┐ bits
    * For resource allocation type 1, ┌log₂(N_{RB}^{DL,BWP}(N_{RB}^{DL,BWP} + 1)/2)┐
    bits
- Time domain resource assignment -1, 2, 3, or 4 bits
- VRB-to-PRB mapping - 0 or 1 bit, only for resource allocation type 1.
    * 0 bit if only resource allocation type 0 is configured;
    * 1 bit otherwise.
- PRB bundling size indicator - 0 or 1 bit
- Rate matching indicator - 0, 1, or 2 bits
- Zero power (ZP) CSI-reference signal (RS) trigger - 0, 1, or 2 bits
For transport block (TB) 1:
  - MCS - 5 bits
  - New data indicator - 1 bit
  - Redundancy version - 2 bits
For TB 2:
  - MCS - 5 bits
  - New data indicator - 1 bit
  - Redundancy version - 2 bits
- HARQ process number - 4 bits
- DL assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5 or 6 bits
- Transmission configuration indication - 0 or 3 bits
- SRS request - 2 bits
- CBG transmission information - 0, 2, 4, 6, or 8 bits
- CBG flushing out information - 0 or 1 bit
- DMRS sequence initialization - 1 bit
```

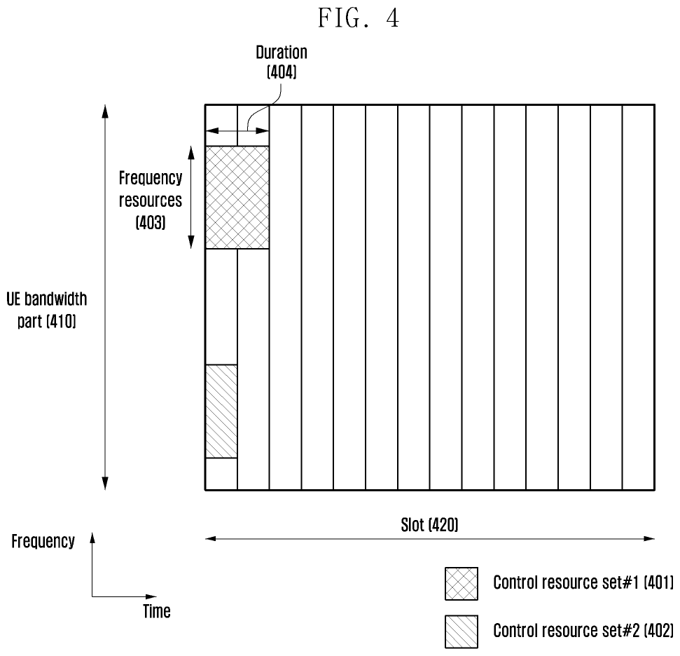

FIG. 4 illustrates an example of a CORESET used to transmit a DL control channel in a wireless communication system, according to an embodiment.

Referring to FIG. 4, a UE BWP 410 is configured along the frequency axis, and two CORESETs (CORESET #1 401 and CORESET #2 402) are configured within one slot 420 along the time axis. The CORESETs 401 and 402 may be configured in a specific frequency resource 410 within the entire UE BWP 403 along the frequency axis. The CORESETs 401 and 402 may be each configured as one or multiple OFDM symbols along the time domain, and the number of the OFDM symbols may be defined as a CORESET duration 404. In the example of FIG. 4, CORESET #1 401 is configured to have a CORESET duration corresponding to two symbols, and CORESET #2 402 is configured to have a CORESET duration corresponding to one symbol.

A CORESET in 5G described above may be configured for a UE by a base station through higher layer signaling (e.g., SI, MIB, RRC signaling). The description that a CORESET is configured for a UE means that information such as a CORESET identity, the CORESET's frequency location, and the CORESET's symbol duration is provided. For example, the CORESET may include the following pieces of information: given in Table 8 below.

TABLE 8

| | |
|---|---|
| ConControlResourceSet ::= | SEQUENCE { |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE |

(45)),
(frequency domain resource assignment information)

| | |
|---|---|
| duration | INTEGER |

```
(1..maxCoReSetDuration),
    (time domain resource assignment information)
      cce-REG-MappingType
  CHOICE {
    (CCE-to-REG mapping type)
        interleaved
  SEQUENCE {
          reg-BundleSize
  ENUMERATED {n2, n3, n6},
        (REG bundle size)
          precoderGranularity
  ENUMERATED {sameAsREG-bundle, allContiguousRBs},
          interleaverSize
  ENUMERATED {n2, n3, n6}
          (interleaver size)
          shiftIndex
  INTEGER(0..maxNrofPhysicalResourceBlocks−1)
          OPTIONAL
          (interleaver shift)
      },
```

| | |
|---|---|
| nonInterleaved | NULL |

```
      },
      tci-StatesPDCCH
  SEQUENCE(SIZE (1..maxNrofTCI-StatesPDCCH)) OF TCI-StateId
        OPTIONAL,
    (QCL configuration information)
```

| | |
|---|---|
| tci-PresentInDCI | ENUMERATED |

{enabled}

OPTIONAL, ... Need S

}

In Table 8, tci-StatesPDCCH (which may simply be referred to as a transmission configuration indication (TCI) state) configuration information may include information of one or multiple SS/PBCH block indexes or CSI-RS indexes, which are OCLed with a DMRS transmitted in a corresponding CORESET.

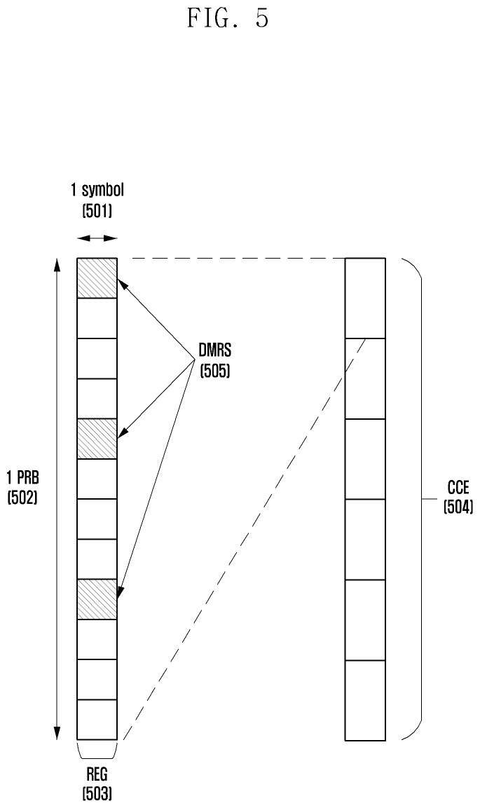

FIG. 5 illustrates a structure of a DL control channel in a wireless communication system according to an embodiment. More specifically, FIG. 5 illustrates an example of a basic unit of time and frequency resources constituting a DL control channel available in 5G.

Referring to FIG. 5, the basic unit of time and frequency resources constituting a control channel may be referred to as an RE group (REG) 503, and the REG 503 may be defined by one OFDM symbol 501 along the time axis and one PRB 502, that is, 12 subcarriers, along the frequency axis. The base station may configure a DL control channel allocation unit by concatenating the REGs 503.

Provided that the basic unit of DL control channel allocation in 5G is a control channel element 504 as illustrated in FIG. 5, one CCE 504 may include multiple REGs 503. The REG 503 may include 12 REs, and if one CCE 504 includes six REGs 503, one CCE 504 may then include 72 REs. A DL CORESET, once configured, may include multiple CCEs 504, and a specific DL control channel may be mapped to one or multiple CCEs 504 and then transmitted according to the aggregation level (AL) in the CORESET. The CCEs 504 in the CORESET are distinguished by numbers, and the numbers of CCEs 504 may be allocated according to a logical mapping scheme.

The basic unit of the DL control channel illustrated in FIG. 5, that is, the REG 503, may include both REs to which DCI is mapped, and an area to which a reference signal (DMRS 505) for decoding the same is mapped. Three DMRSs 503 may be transmitted inside one REG 505. The number of CCEs necessary to transmit a PDCCH may be 1, 2, 4, 8, or 16 according to the AL, and different number of CCEs may be used to implement link adaption of the DL control channel. For example, in the case of AL=L, one DL control channel may be transmitted through L CCEs. The UE needs to detect a signal while being no information regarding the DL control channel, and thus a search space indicating a set of CCEs has been defined for blind decoding. The search space is a set of DL control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured ALs.

Search spaces may be classified into common search spaces and UE-specific search spaces. A group of UEs or all UEs may search a common search space of the PDCCH in order to receive cell-common control information such as dynamic scheduling regarding SI or a paging message. For example, PDSCH scheduling allocation information for transmitting an SIB including a cell operator information or the like may be received by searching the common search space of the PDCCH. In the case of a common search space, a group of UEs or all UEs should receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through higher layer signaling (e.g., SIB, MIB, or RRC signaling). For example, the base station may provide the UE with configurations such as the number of PDCCH candidates at each AL (or L), the monitoring cycle regarding the search space, the monitoring occasion with regard to each symbol in a slot regarding the search space, the search space type (common search space or UE-specific search space), a combination of an RNTI and a DCI format to be monitored in the corresponding search space, a CORESET index for monitoring the search space, and the like. For example, the CORESET may include the following pieces of information: given in Table 9 below.

TABLE 9

| | |
|---|---|
| SearchSpace ::= | SEQUENCE { |

-- Identity of the search space. SearchSpaceId = 0 identifies the SearchSpace
configured via PBCH (MIB) or ServingCellConfigCommon.

| | |
|---|---|
| search SpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

```
  (monitoring slot level periodicity)
      sl1
    NULL,
      sl2
    INTEGER (0..1),
      sl4
    INTEGER (0..3),
      sl5
    INTEGER (0..4),
      sl8
    INTEGER (0..7),
      sl10
    INTEGER (0..9),
      sl16
    INTEGER (0..15),
      sl20
    INTEGER (0..19)
    }
```

| | |
|---|---|
| | OPTIONAL, |
| duration (monitoring duration) | INTEGER (2..2559) |
| monitoringSymbolsWithinSlot | BIT |

STRING (SIZE (14))

OPTIONAL,

```
  (monitoring symbols within slot)
    nrofCandidates
    SEQUENCE {
  (number of PDCCH candidates for each aggregation level)
      aggregationLevel1
    ENUMERATED {n0, n1, n2, n3, n4, n5, n6, n8},
      aggregationLevel2
    ENUMERATED {n0, n1, n2, n3, n4, n5, n6, n8},
      aggregationLevel4
    ENUMERATED {n0, n1, n2, n3, n4, n5, n6, n8},
      aggregationLevel8
    ENUMERATED {n0, n1, n2, n3, n4, n5, n6, n8},
      aggregationLevel16
    ENUMERATED {n0, n1, n2, n3, n4, n5, n6, n8}
    },
```

| | |
|---|---|
| searchSpaceType | CHOICE { |

```
    (search space type)
      -- Configures this search space as common search space (CSS) and DCI
formats to monitor.
      common
    SEQUENCE {
    (common search space)
    }
      ue-Specific
    SEQUENCE {
    (UE-specific search space)
        -- Indicates whether the UE monitors in this USS for DCI
formats 0-0 and 1-0 or for formats 0-1 and 1-1.
        formats
      ENUMERATED {formats0-0-And-1-0, formats0-1-And-1-1},
    ...
}
```

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space. Combinations of DCI formats and RNTIs given below may be monitored in a common search space. The examples given below are not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. The examples given below are not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below
C-RNTI: used to schedule a UE-specific PDSCH
Temporary cell RNTI (TC-RNTI): used to schedule a UE-specific PDSCH
Configured scheduling (CS-RNTI): used to schedule a semi-statically configured UE-specific PDSCH
RA-RNTI: used to schedule a PDSCH in a random access step
P-RNTI: used to schedule a PDSCH in which paging is transmitted
SI-RNTI: used to schedule a PDSCH in which SI is transmitted
Interruption RNTI (INT-RNTI): used to indicate whether a PDSCH is punctured
TPC for PUSCH RNTI (TPC-PUSCH-RNTI): used to indicate a power control command regarding a PUSCH
TPC for PUCCH RNTI (TPC-PUCCH-RNTI): used to indicate a power control command regarding a PUCCH
TPC for SRS RNTI (TPC-SRS-RNTI): used to indicate a power control command regarding an SRS

The DCI formats enumerated above may follow the definitions given in Table 10 below, for example.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In a 5G system, a search space at AL L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , ma x}^{( L )}} ⌋ + {n}_{CI} ) mod ⌊ \frac{{N}_{CCE , p}}{L} ⌋ \} + i \qquad [ Equation 1 ]$$

In Equation 1:
L: AL
n_{Cl}: carrier index
N_{CCE,p}: total number of CCEs existing in CORESET p
n_{s,f}^{μ}: slot index
M_{s,max}^{(L)}: number of PDCCH candidates at AL L
m_{s,n}_{_{Cl}}=0, . . . , M_{s,max}^{(L)}−1: PDCCH candidate index at AL L
i=0, . . . , L−1

$${Y}_{p , {n}_{s , f}^{μ}} = ( {A}_{p} \cdot {Y}_{p , {n}_{s , f}^{μ} - 1} )$$

mod D, Y_{p,-1}=n_{RNTI}≠0, Aₚ=39827 for pmod3=0, Aₚ=39829 for pmod3=1, Aₚ=39839 for pmod3=2, D=65537
N_{RNTI}: UE identity

In Equation 1, the

$${Y}_{p , {n}_{s , f}^{μ}}$$

value may correspond to 0 in the case of a common search space, and the

$${Y}_{p , {n}_{s , f}^{μ}}$$

value changed by the UE's identity (C-RNTI or ID configured for the UE by the base station) and the time index in the case of a UE-specific search space.

In 5G, multiple search space sets may be configured by different parameters (e.g., parameters in Table 9), and the group of search space sets monitored by the UE at each timepoint may differ accordingly. For example, if search space set #1 is configured at X-slot periodicity, if search space set #2 is configured at Y-slot periodicity, and if X and Y are different, the UE may monitor search space set #1 and search space set #2 both in a specific slot, and may monitor one of search space set #1 and search space set #2 both in another specific slot.

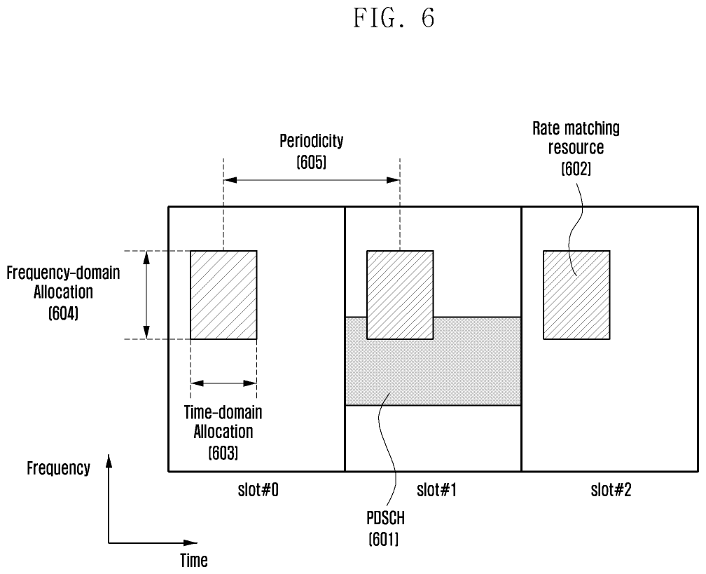

FIG. 6 illustrates a method in which a base station and a UE transmit/receive data inconsideration of a DL data channel and a rate matching resource in a wireless communication system according to an embodiment. Mor specifically, FIG. 6 illustrates an example of rate matching for a data channel in a 5G communication system.

Referring to FIG. 6, a DL data channel 601 and a rate matching resource 602 are provided. A BS may configure one or multiple rate matching resources 602 in a UE through higher layer signaling (e.g., RRC signaling). Configuration information of the rate matching resource 602 may include time-domain resource allocation information 603, frequency-domain resource allocation information 604, and periodicity information 605. If some or all of the time and frequency resources of the scheduled data channel 601 overlaps the configured rate matching resource 602, a BS may rate-match the data channel 601 in the rate matching resource 602 part and transmit it. A UE may perform reception and decoding, assuming that the data channel 601 has been rate-matched in the rate matching resource 602 part.

The BS may dynamically notify the UE whether the data channel will be rate-matched in the configured rate matching resource part through DCI through an additional configuration. Specifically, the BS may select some of the configured rate matching resources, may group the selected resources into a rate matching resource group, and may indicate whether the data channel has been rate-matched with each rate matching resource group through DCI using a bitmap method with respect to the UE. For example, if four rate matching resources RMR #1, RMR #2, RMR #3 and RMR #4 have been configured, the BS may configure RMG #1={RMR #1, RMR #2} and RMG #2={RMR #3, RMR #4} as rate matching groups, and may indicate whether rate matching in each of RMG #1 and RMG #2 has been performed using 2 bits of a DCI field with respect to the UE in the form of a bitmap. For example, the BS may indicate “1” if rate matching needs to be performed, and may indicate “0” if rate matching do not need to be performed.

An indicator indicating whether a data channel has been rate-matched with a rate matching resource is referred to as a “rate matching indicator.”

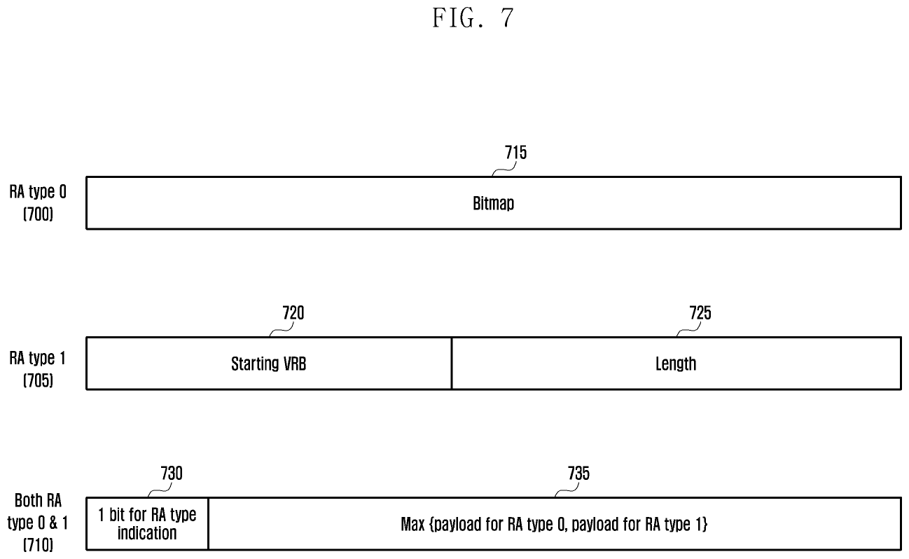

FIG. 7 illustrates an example of frequency domain resource allocation with regard to a PDSCH in a wireless communication system according to an embodiment. Mor specifically, FIG. 7 illustrates three frequency domain resource allocation methods of type 0 700, type 1 705, and dynamic switch 710, which can be configured through a higher layer in an NR wireless communication system.

Referring to FIG. 7, in the case in which a UE is configured to use only resource allocation type-0 through higher layer signaling (700), partial DCI for allocating a PDSCH to the UE includes a bitmap including NRBG bits. The conditions for this will be described below. Herein, NRBG refers to the number of RB groups (RBGs) determined according to the BWP size allocated by a BWP indicator and higher layer parameter rbg-Size, as in Table 11 below, and data is transmitted in RBGs indicated as “1” by the bitmap.

TABLE 11

| BWP Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

In the case in which the UE is configured to use only resource type 1 through higher layer signaling (705), partial DCI includes frequency domain resource allocation information including [log₂(N_{RB}^{DL,BWP}(N_{RB}^{DL,BWP}+1)/2] bits. The conditions for this will be described below.

The base station may thereby configure a starting VRB 720 and the length 725 of a frequency domain resource allocated continuously therefrom.

In the case in which the UE is configured to use both resource type 0 and resource type 1 through higher layer signaling (710), partial DCI for allocating a PDSCH to the corresponding UE includes frequency domain resource allocation information including as many bits as the larger value 735 between the payload 715 for configuring resource type 0 and the payload 720 and 725 for configuring resource type 1. The conditions for this will be described below.

One bit may be added to a foremost part (e.g., a most significant bit (MSB)) of the frequency domain resource allocation information inside the DCI. If the bit has the value of “0”, use of resource type 0 may be indicated, and if the bit has the value of “1”, use of resource type 1 may be indicated.

A base station may configure a table for time domain resource allocation information regarding a PDSCH and a PUSCH for a UE through higher layer signaling (e.g., RRC signaling). A table including a maximum of maxNrofDL-Allocations=16 entries may be configured for the PDSCH, and a table including a maximum of maxNrofUL-Allocations=16 entries may be configured for the PUSCH.

According to an embodiment, the time domain resource allocation information may include PDCCH-to-PDSCH slot timing (e.g., corresponding to a slot-unit time interval between a timepoint at which a PDCCH is received and a timepoint at which a PDSCH scheduled by the received PDCCH is transmitted; labeled K0), PDCCH-to-PUSCH slot timing (e.g., corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 12 or Table 13 below may be transmitted from the base station to the UE.

TABLE 12

| | |
|---|---|
| PDSCH-TimeDomainResourceAllocationList ::= | SEQUENCE (SIZE(1..maxNrofDL- |

Allocations)) OF
PDSCH-TimeDomainResourceAllocation

| | |
|---|---|
| PDSCH-TimeDomainResourceAllocation ::= | SEQUENCE { |

```
          k0
INTEGER(0..32)
    OPTIONAL, -- Need S
```

| | |
|---|---|
| (PDCCH-to-PDSCH timing, slot unit) | ENUMERATED |

```
      mappingType
{typeA, typeB},
      (PDSCH mapping type)
```

| | |
|---|---|
| startSymbolAndLength | INTEGER (0..127) |

```
    (start symbol and length of PDSCH)
    }
```

TABLE 13

| | |
|---|---|
| PUSCH-TimeDomainResourceAllocationList ::= | SEQUENCE (SIZE(1 .. maxNrofUL- |

Allocations)) OF
PUSCH-TimeDomainResourceAllocation

| | |
|---|---|
| PUSCH-TimeDomainResourceAllocation ::= | SEQUENCE { |

k2

| | |
|---|---|
| INTEGER(0..32) OPTIONAL, | -- Need S |

(PDCCH-to-PUSCH timing, slot unit)

| | |
|---|---|
| mappingType | ENUMERATED |

{typeA, typeB},
(PUSCH mapping type)

| | |
|---|---|
| startSymbolAndLength | INTEGER (0..127) |

```
        (start symbol and length of PUSCH)
  }
```

The base station may notify the UE of one of the entries of the table regarding time domain resource allocation information described above through L1 signaling (e.g., DCI) (e.g., “time domain resource allocation” field in DCI may indicate the same). The UE may acquire time domain resource allocation information regarding a PDSCH or PUSCH, based on the DCI acquired from the base station.

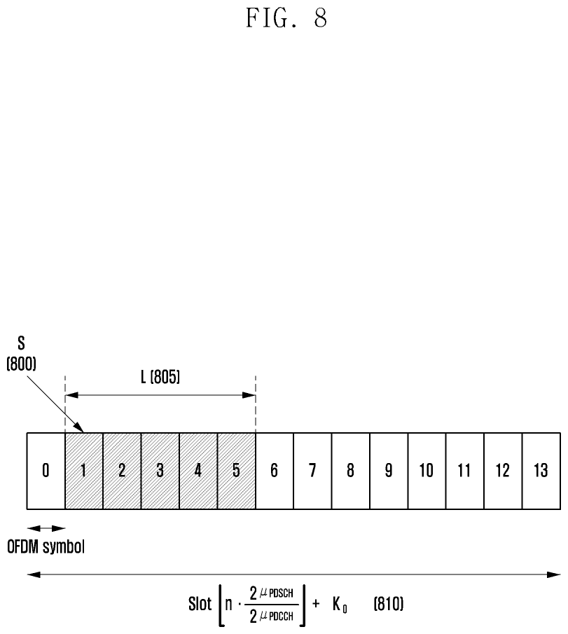

FIG. 8 illustrates an example of time domain resource allocation with regard to a PDSCH in a wireless communication system according to an embodiment.

Referring to FIG. 8, the base station may indicate the time domain location of a PDSCH resource according to the SCS (μ_{PDSCH}, μ_{PDCCH}) of a data channel and a control channel configured by using an higher layer, the scheduling offset (K0) value, and the OFDM symbol start location 800 and length 805 within one slot 810 dynamically indicated through DCI.

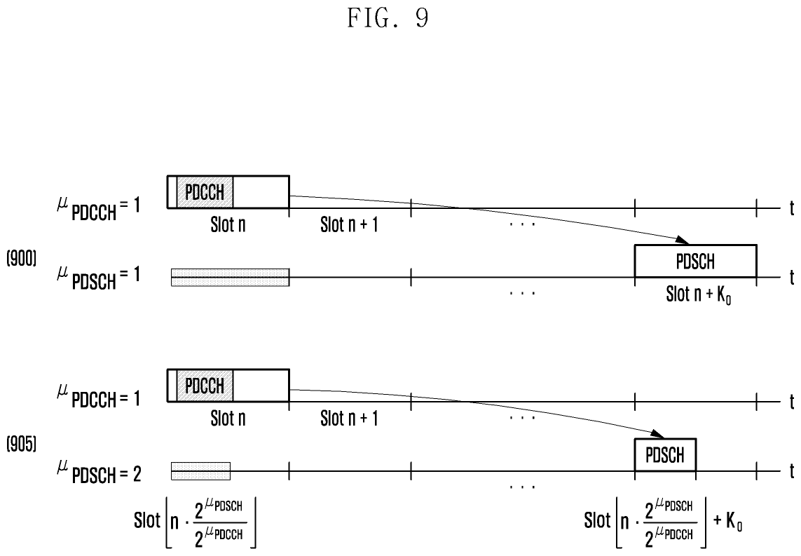

FIG. 9 illustrates an example of time domain resource allocation according to an SCS with regard to a data channel and a control channel in a wireless communication system according to an embodiment.

Referring to FIG. 9, if the data channel and the control channel have the same SCS (900, μ_{PDSCH}=μ_{PDCCH}), the slot number for data and that for control are identical, and the base station and the UE may accordingly generate a scheduling offset in conformity with a predetermined slot offset K0. However, if the data channel and the control channel have different SCSs (905, μ_{PDSCH}≠μ_{PDCCH}), the slot number for data and that for control are different, and the base station and the UE may accordingly generate a scheduling offset in conformity with a predetermined slot offset K0 with reference to the SCS of the PDCCH.

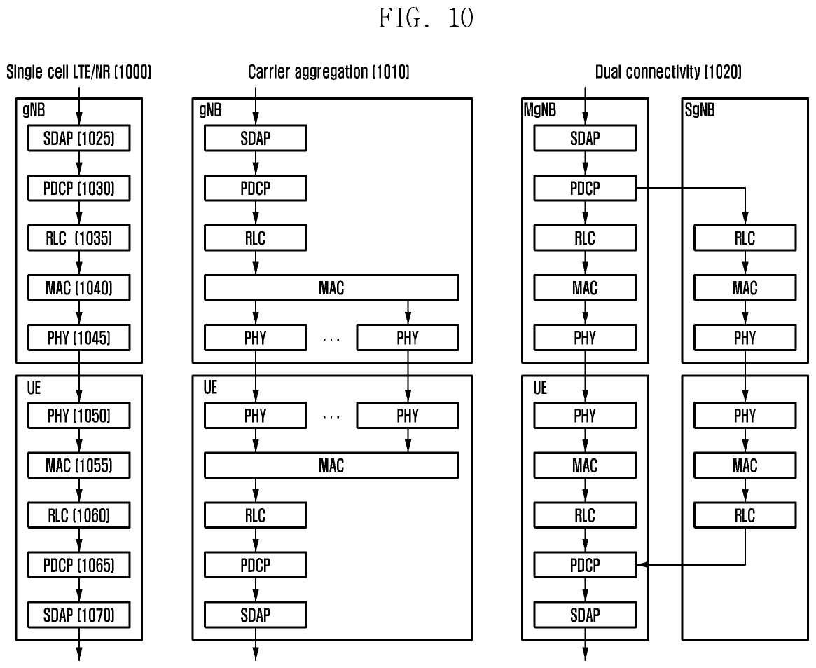

FIG. 10 illustrates radio protocol structures of a base station and a UE in single cell, CA, and DC situations according to an embodiment.

Referring to FIG. 10, the radio protocol of a next-generation mobile communication system includes an NR service data adaptation protocol (SDAP) 1025 or 1070, an NR packet data convergence protocol (PDCP) 1030 or 1065, an NR radio link control (RLC) 1035 or 1060, and an NR medium access control (MAC) 1040 or 1055, on each of UE and NR base station sides.

Functions of the NR SDAP 1025 or 1070 may include transfer of user plane data, mapping between a quality of service (QOS) flow and a data radio bearer (DRB) for both DL and UL, marking QoS flow ID in both DL and UL packets, and/or reflective QoS flow to DRB mapping for the UL SDAP protocol data units (PDUs).

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QOS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the UL and DL. The SDAP header may include QoS flow ID information indicating the QoS. The QoS information may be used as data processing priority, scheduling information, etc. for smoothly supporting services.

Functions of the NR PDCP 1030 or 1065 may include header compression and decompression: robust header compression (ROHC) only, transfer of user data, in-sequence delivery of upper layer PDUs, out-of-sequence delivery of upper layer PDUs, PDCP PDU reordering for reception, duplicate detection of lower layer SDUs, retransmission of PDCP SDUs, ciphering and deciphering, and/or timer-based SDU discard in UL.

The above-mentioned reordering of the NR PDCP device refers to a function of reordering PDCP PDUs received from a lower layer in an order based on the PDCP sequence number (SN), and may include a function of transferring data to an upper layer in the reordered sequence.

Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

Functions of the NR RLC 1035 or 1060 may include transfer of upper layer PDUs, in-sequence delivery of upper layer PDUs, out-of-sequence delivery of upper layer PDUs, error correction through ARQ, concatenation, segmentation and reassembly of RLC SDUs, re-segmentation of RLC data PDUs, reordering of RLC data PDUs, duplicate detection, protocol error detection, RLC SDU discard, and/or RLC re-establishment.

The above-mentioned in-sequence delivery of the NR RLC device refers to a function of delivering RLC SDUs, received from the lower layer, to the upper layer in sequence. The in-sequence delivery of the NR RLC device may include a function of reassembling and delivering multiple RLC SDUs received, into which one original RLC SDU has been segmented, may include a function of reordering the received RLC PDUs with reference to the RLC SN or PDCP SN, may include a function of recording RLC PDUs lost as a result of reordering, may include a function of reporting the state of the lost RLC PDUs to the transmitting side, and may include a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all RLC SDUs received until now to the upper layer.

In addition, the in-sequence delivery of the NR RLC device may include a function of processing RLC PDUs in the received order (regardless of the SN order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC 1040 or 1055 may be connected to multiple NR RLC layer devices configured in one UE, and functions of the NR MAC may include mapping between logical channels and transport channels, multiplexing/demultiplexing of MAC SDUs, scheduling information reporting, error correction through HARQ, priority handling between logical channels of one UE, priority handling between UEs by means of dynamic scheduling, multimedia broadcast multicast service (MBMS) service identification, transport format selection, and/or padding.

An NR PHY layer 1045 or 1050 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

A radio protocol structure may vary according to the carrier (or cell) operating scheme. For example, in case that the base station transmits data to the UE, based on a single carrier (or cell), the base station and the UE may use a protocol structure having a single structure with regard to each layer, such as 1000. However, in case that the base station transmits data to the UE, based on CA, which uses multiple carriers in a single transmission and reception point (TRP), the base station and the UE may use a protocol structure which has a single structure up to the RLC, but multiplexes the PHY layer through a MAC layer, such as 1010. As another example, in case that the base station transmits data to the UE, based on DC, which uses multiple carriers in multiple TRPs, the base station and the UE may use a protocol structure which has a single structure up to the RLC, but multiplexes the PHY layer through a MAC layer, such as 1020.

Hereinafter, determining priority between A and B may be variously described as, e.g., selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

In the following description, embodiments of the disclosure will be described in connection with 5G systems by way of example, but the embodiments of the disclosure may also be applied to other communication systems having similar technical backgrounds or channel types.

Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure. The contents of the disclosure may be applied to FDD and TDD systems.

In the following description of the disclosure, higher layer signaling may refer to signaling corresponding to at least one signaling among the following signaling, or a combination of one or more thereof.
MIB
SIB or SIB X (X=1, 2, . . . )
RRC
MAC control element (CE)

In addition, L1 signaling may refer to signaling corresponding to at least one signaling method among signaling methods using the following physical layer channels or signaling, or a combination of one or more thereof.
PDCCH
DCI
UE-specific DCI
Group common DCI
Common DCI
Scheduling DCI (e.g., DCI used for the purpose of scheduling DL or UL data)
Non-scheduling DCI (e.g., DCI not used for the purpose of scheduling DL or UL data)
PUCCH
UL control information (UCI)

In 3GPP, SBFD has been introduced as a new duplex scheme based on NR. SBFD is a technology of using a part of a DL resource as an UL resource in a TDD band (spectrum) of a frequency of 6 GHz or below or a frequency of 6 GHz or above to receive UL transmission from a UE as much as the amount of increased UL resources so as to expand the UL coverage of the UE, and receive feedback relating to DL transmission from the UE in the increased UL resources so as to reduce feedback delay. In the disclosure, a UE capable of receiving, from a base station, information on whether SBFD is supported, and performing UL transmission in a part of a DL resource may be referred to as an SBFD UE (SBFD-capable UE) for convenience. The SBFD scheme may be defined in the standard, and the following schemes may be considered for the SBFD UE to determine whether SBFD is supported in a specific cell (or a frequency or a frequency band).

First scheme: Besides the frame structure type of the existing unpaired spectrum (or TDD) or paired spectrum (or frequency division duplex (FDD)), a different frame structure type (e.g., frame structure type 2) may be introduced to define the above-described SBFD. The frame structure type 2 may be defined as being supported in the specific frequency or frequency band, or a base station may indicate to a UE whether SBFD is supported by using SI. The SBFD UE may receive the SI including whether SBFD is supported, and determine whether SBFD is supported in the specific cell (or frequency or frequency band).

Second scheme: Without defining a new frame structure type, it may be indicated whether SBFD is additionally supported at a specific frequency or frequency band of the existing unpaired spectrum (or TDD). A second scheme may define whether SBFD is additionally supported in the specific frequency or frequency band of the conventional unpaired spectrum, or a base station may indicate to a UE whether SBFD is supported by using SI. The SBFD UE may receive the SI including whether SBFD is supported, and determine whether SBFD is supported in the specific cell (or frequency or frequency band).

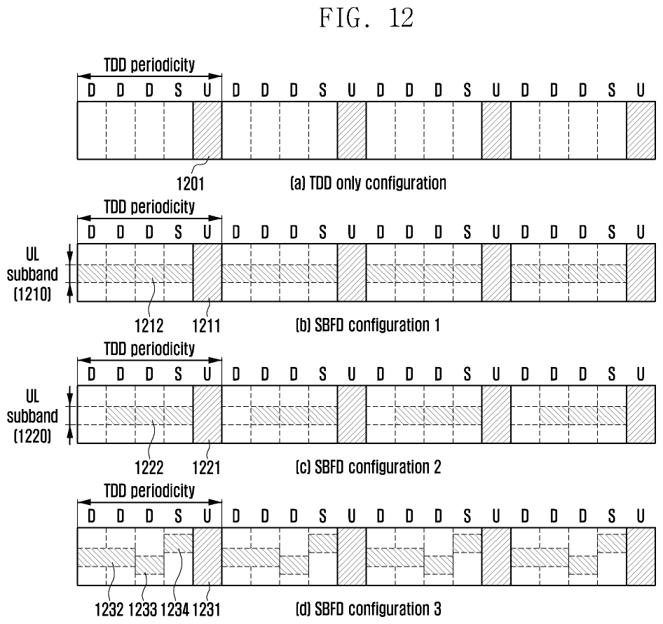

The information on whether SBFD is supported in the first and second schemes may be information (e.g., SBFD resource configuration information in FIG. 12) indirectly indicating whether SBFD is supported, by additionally configuring a part of a DL resource as an UL resource in addition to the configuration of TDD UL-DL resource configuration information indicating a DL slot (or symbol) resource and a UL slot (or symbol) resource in TDD, or may be information directly indicating whether SBFD is supported.

In the disclosure, the SBFD UE may receive a synchronization signal block (SSB) in an initial cell access for accessing a cell (or base station), so as to obtain cell synchronization. A process of obtaining the cell synchronization may be the same as for an SBFD UE and an existing TDD UE. Thereafter, the SBFD UE may determine whether the cell supports SBFD, through MIB acquisition, SIB acquisition, or a random access process.

The SI for transmitting information on whether SBFD is supported may be SI distinguished from and transmitted separately from SI for a UE (e.g., an existing TDD UE) supporting a different version of protocol in a cell, and the SBFD UE may obtain the entirety or part of the SI transmitted separately from the SI for the existing TDD UE, to determine whether SBFD is supported. If the SBFD UE obtains only the SI for the existing TDD UE or SI indicating that SBFD is not supported, the SBFD UE may determine that the cell (or base station) supports only TDD.

If the information on whether SBFD is supported is included in SI for a UE (e.g., an existing TDD UE) supporting a different version of protocol, the information on whether SBFD is supported may be inserted in the last part of the SI not to affect acquisition of the SI of the existing TDD UE. If the SBFD UE fails to obtain the information on whether SBFD is supported, which is inserted in the last part, or obtains information indicating that SBFD is not supported, the SBFD UE may determine that the cell (or base station) supports only TDD.

If the information on whether SBFD is supported is included in SI for a UE (e.g., an existing TDD UE) supporting a different version of protocol, the information on whether SBFD is supported may be transmitted through a separate PDSCH so as not to affect acquisition of the SI of the existing TDD UE. That is, a non-SBFD-supporting UE may receive a first SIB (or SIB1) including existing TDD-related SI through a first PDSCH. An SBFD-supporting UE may receive the first SIB (or SIB) including the existing TDD-related SI through the first PDSCH, and may receive a second SIB including SBFD-related SI through a second PDSCH. The first PDSCH and the second PDSCH may be scheduled through a first PDCCH and a second PDCCH, and a CRC of the first PDCCH and the second PDCCH may be scrambled with the same RNTI (e.g., SI-RNTI). A search space for monitoring the second PDCCH may be obtained from SI of the first PDSCH, and if the same is not obtained (i.e., if the SI of the first PDSCH does not include information on the search space), the second PDCCH may be received in the same search space as a search space of the first PDCCH.

As described above, when the SBFD UE determines that the cell (or base station) supports only TDD, the SBFD UE may perform a random access procedure and transmit or receive a data/control signal in the same manner as the existing TDD UE.

A base station may configure a separate random access resource for an existing TDD UE or an SBFD UE (e.g., an SBFD UE supporting duplex communication and an SBFD UE supporting half-duplex (HD) communication), and transmit configuration information (e.g., control information or configuration information indicating a time-frequency resource available for a PRACH on the random access resource to the SBFD UE through SI. The SI for transmitting information on the random access resource may be SI distinguished from and transmitted separately from SI for a UE (e.g., an existing TDD UE) supporting a different version of protocol in a cell.

The base station may configure a random access resource for the TDD UE, and may additionally configure a separate random access resource for the SBFD UE. The SBFD UE may be able to use the random access resource for the TDD UE or may be unable to use the random access resource for the TDD UE. In the latter case, the SBFD UE may always use only the separate random access resource for the SBFD UE.

The SBFD UE may receive, from the base station, an indication regarding whether the random access resource for the TDD UE is available. Such an indication may be included in and indicated by an SIB. That is, the SIB may configure a separate random access resource for the SBFD UE and may indicate, together with the configuration, whether the random access resource for the TDD UE is available. This may be indicated by 1 bit. If 1 bit is “0” (or FALSE), then the random access resource for the TDD UE is unavailable to the SBFD UE. If 1 bit is “1” (or TRUE), then the random access resource for the TDD UE is available to the SBFD UE.

The base station may determine the type of a UE which attempts to access a cell, based on the random access resource used by the UE. For example, the SBFD UE may transmits a PRACH through a separate random access resource for the SBFD UE, and upon receiving the PRACH, the base station may determine that the SBFD UE is attempting a cell access. For example, the TDD UE may transmit a PRACH through a random access resource for the TDD UE, and upon receiving the PRACH, the base station may determine that the TDD UE is attempting a cell access. For reference, in case that the SBFD UE is allowed to transmit a PRACH through the random access resource for the TDD UE, the base station may be uncertain about whether the type of the UE that has transmitted the PRACH is a TDD UE or an SBFD UE. In this case, the base station may assume that the type of the UE described above is always a TDD UE.

In case that the base station has determined that the relevant UE is an SBFD UE, the base station may schedule msg2, msg3, msg4, or the like for the UE, based on a UL subband configuration. That is, when the base station schedules reception of msg2 and msg4 for the UE, the base station may schedule msg2 and msg4 so as not to be received in the UL subband (when the UE receives a PDSCH including msg2 and msg4, the UE receives the PDSCH in a frequency resource other than the UL subband). When the base station schedules a msg3 PUSCH, the base station may schedule the msg3 PUSCH so as to be transmitted in the UL subband.

In case that the base station has determined that the relevant UE is a TDD UE, the base station may be unable to use the UL subband configuration when scheduling msg2, msg3, msg4, or the like for the UE. That is, even though the UL subband is configured for a DL symbol or flexible symbol, the base station may assume that the UE cannot acquire the configured UL subband configuration information. When scheduling a msg3 PUSCH for the UE, the base station may schedule the msg3 PUSCH for a flexible symbol or UL symbol. In other words, the msg3 PUSCH cannot be scheduled for the UL subband.

Alternatively, the base station may not configure a separate random access resource for the SBFD UE, and may configure a common random access resource for all UEs in a cell. In this case, the configuration information on the random access resource may be transmitted to all the UEs in the cell through SI, and the SBFD UE having received the SI may perform a random access on the random access resource. Thereafter, the SBFD UE may complete a random access process to enter an RRC connection mode for transmission or reception of data with the cell. After the RRC connection mode, the SBFD UE may receive, from the base station, an higher layer signal or a physical signal enabling determination that a partial frequency resource of the DL time resource is configured as an UL resource, and thus perform an SBFD operation, e.g., transmit an UL signal in the UL resource.

If the SBFD UE determines that the cell supports SBFD, the SBFD UE transmits, to the base station, capability information including at least one of whether the UE supports SBFD, whether the UE supports FD communication or HD communication, and the number of transmission or reception antennas included in (or supported by) the UE, thereby notifying the base station that the UE attempting to access is the SBFD UE. Alternatively, if supporting HD communication is necessarily implemented for the SBFD UE, whether the HDD communication is supported may be omitted from the capability information. A report of the SBFD UE on the capability information may be reported to the base station through a random access process, may be reported to the base station after completion of the random access process, or may be reported to the base station after entering the RRC connection mode for transmission or reception of the data with the cell.

The SBFD UE may support HD communication in which only UL transmission or DL reception is performed at one time like the existing TDD UE, or may support FD communication in which both UL transmission and DL reception are performed at one time. Therefore, the SBFD UE may report, to the base station through capability reporting, whether the SBFD UE supports the HD communication or FD communication, and after the reporting, the base station may configure, for the SBFD UE, whether the SBFD UE is to use HD communication for transmission or reception or is to use FD communication for transmission or reception. If the SBFD UE reports the capability for the HD communication to the base station, since a duplexer generally does not exist, a switching gap for changing an RF between transmission and reception may be required in a case of operating in FDD or TDD.

In general, the UE may establish a radio link with a network via a random access procedure, based on synchronization with the network and SI acquired during a cell search process of the cell. As the random access, a contention-based scheme or a contention-free scheme may be used. If the UE performs cell selection and cell reselection in the initial access step, the contention-based scheme may be used, e.g., in the case of transitioning from an RRC_IDLE (RRC idle) state to an RRC_CONNECTED (RRC connected) state, and for other purposes. The contention-free scheme may be used in order to reconfigure UL synchronization in the case where DL data reaches, in the case of handover, or in the case of location measurement.

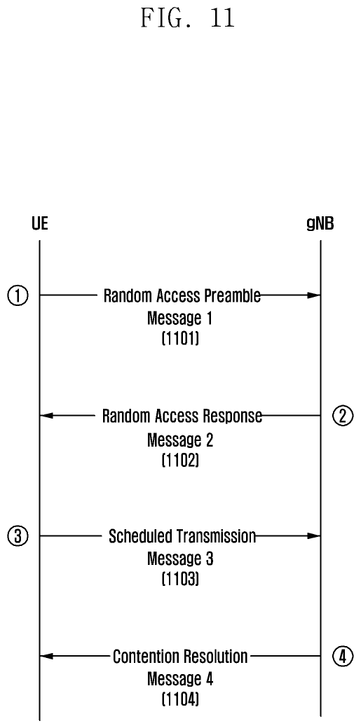

FIG. 11 illustrates a random-access procedure in a wireless communication system according to an embodiment.

Referring to FIG. 11, a contention-based random-access procedure is illustrated as an example. In addition, although not illustrated, a base station (e.g., a gNB) may transmit an SSB as described in the aforementioned embodiments. In this case, the base station may periodically transmit SSBs by using beam sweeping. For example, the base station may transmit an SSB including a PSS/SSS and a PBCH signal by using up to 64 different beams for 5 ms, and multiple SSBs may be transmitted using different beams. A UE may detect (select) an SSB having an optimal beam direction (e.g., a beam direction having a strongest reception signal strength or a reception signal strength greater than a predetermined threshold), and transmit a preamble by using a PRACH resource associated with the detected SSB.

For example, as a first operation 1101 of a random-access procedure, a UE may transmit a random-access preamble (or message 1) to a base station. The base station having received the random-access preamble may measure a transmission delay value between the UE and the base station, and perform UL synchronization. Specifically, the UE may transmit a random-access preamble randomly selected from a random-access preamble set given by SI in advance, and initial transmission power of the random-access preamble may be determined according to a path loss between the base station and the UE, the path loss being measured by the UE. In addition, the UE may determine a transmission beam direction (or transmission beam or beam) of the random-access preamble, based on an SSB received from the base station, and transmit the random-access preamble by applying the determined transmission beam direction.

In a second operation 1102, the base station may transmit, to the UE, a response (e.g., an RAR or message 2 (msg2)) to the detected random-access attempt. The base station may transmit a UL transmission timing control command to the UE, based on the transmission delay value measured from the random-access preamble received in the first operation. In addition, the base station may transmit, as scheduling information, a power control command and a UL resource to be used by the UE. The scheduling information may include control information for a UL transmission beam of the UE. The RAR is transmitted via a PDSCH and may include at least one piece of a random-access preamble sequence index detected by the network (or the base station), a TC-RNTI, a UL scheduling grant, or a timing advance value,

If the UE fails to receive the RAR, which is the scheduling information for message 3, from the base station, for a predetermined time in the second operation 1102, the first operation 1101 may be performed again. If the first operation is performed again, the UE increases transmission power of the random-access preamble by a predetermined step (which is referred to as power ramping) and performs transmission, thereby increasing a probability of the base station receiving the random-access preamble.

In a third operation 1103, the UE may transmit UL information (scheduled transmission or message 3) including its own UE identifier (which may be referred to as a UE contention resolution (CR) identity. Alternatively, if the UE already has a valid UE identifier (e.g., a C-RNTI) within a cell before random-access procedure initiation, the UE identifier of the UE is the valid UE identifier) to the base station via an UL data channel (e.g., a PUSCH) by using the UL resource allocated in the second operation 1102. The PUSCH may be referred to as a message 3 PUSCH (msg3 PUSCH).

Transmission timing of the UL data channel for transmitting message 3 may follow the UL transmission timing control command received from the base station in the second operation 1102. In addition, transmission power of the UL data channel for transmitting message 3 may be determined by considering a power ramping value of the random-access preamble and the power control command received from the base station in the second operation 1102. The UL data channel for transmitting message 3 may be a first UL data signal transmitted by the UE to the base station after the UE transmits the random-access preamble.

Finally, in a fourth operation 1104, if it is determined that the UE has performed random access without collision with another UE, the base station may transmit, to the UE, a message (a CR message or message 4) including the identifier of the UE having transmitted the UL data in the third operation 1103.

In relation to this, if multiple UEs receive the same TC-RNTI in the second operation 1102, the respective multiple UEs having received the same TC-RNTI may include their own UE identifiers (UE CR identities) in message 3 and transmit message 3 to the base station in the third operation 1103, and for CR, the base station may transmit message 4 (CR message) including one UE identifier among the identifiers of the multiple UEs. If the UE receives message 4 (CR message) including its own UE identifier from the base station in the fourth 1104 (alternatively, if the UE transmits message 3 including the UE identifier (C-RNTI) in the third operation 1103, and receives UE-specific control information including a CRC based on the UE identifier (C-RNTI) via a PDCCH in the fourth operation 1104), the UE may determine that random access has been successful. Therefore, among the multiple UEs having received the same TC-RNTI from the base station, the UE having identified that its own UE identifier is included in message 4 (CR message) may identify that the contention has been successful. In addition, the UE may transmit HARQ-acknowledgment (ACK)/negative ACK (NACK), which indicates whether message 4 has been successfully received, to the base station via a UL control channel (e.g., a PUCCH).

If the data transmitted by the UE in the third operation 1103 conflicts with data of another UE, and thus the base station fails to receive a data signal from the UE, the base station may no longer transmit data to the UE. Accordingly, if the UE fails to receive the data transmitted in the fourth operation 1104 from the base station within a certain time period, the UE may determine that the random-access procedure has failed, and start operation again from the first operation 1101.

As described above, in the first operation 1101 of the random-access procedure, the UE may transmit the random-access preamble on the PRACH. Each cell has 64 available preamble sequences, and four long-preamble formats and nine short-preamble formats may be used depending on a transmission type. The UE may generate 64 preamble sequences by using a cyclic shift value and a root sequence index signaled via SI, and may randomly select one sequence to use the sequence as a preamble.

The base station may inform the UE of configuration information for a random-access resource, e.g., control information (or configuration information) indicating a time-frequency resource available for the PRACH, by using at least one of an SIB, higher-layer signaling, or DCI. The frequency resource for PRACH transmission may be indicated to the UE as a starting RB point of transmission, and the number of RBs used may be determined according to a format of the preamble transmitted via the PRACH and an applied SCS. The time resource for PRACH transmission, such as a pre-configured PRACH configuration periodicity, a subframe index including a PRACH transmission time point (which may be used interchangeably with a PRACH occasion and a transmission time point), a start symbol, and the number of PRACH transmission time points in a slot, may be known via PRACH configuration indexes (0 to 255) as shown in Table 14 below. The UE may determine validity of PRACH transmission time points indicated by the PRACH configuration indexes, and determine only valid PRACH transmission time points as PRACH transmission time points available for transmitting the random-access preamble. The UE may identify the time and frequency resource for transmitting the random-access preamble, via the PRACH configuration index, random-access configuration information included in the SIB, and an SSB index selected by the UE, and transmit a selected sequence as the preamble to the base station.

TABLE 14

| | | | | | | | Nₜ^{RA, slot}, | |
|---|---|---|---|---|---|---|---|---|
| | | | | | | | number | |
| | | | | | | | of time- | |
| | | | | | | Number | domain | |
| | | | | | | of | PRACH | |
| | | | | | | PRACH | occasions | |
| PRACH | | n_{f} mod | | | | slots | within a | N_{dur}^{RA}, |
| Configuration | Preamble | x = y | | Subframe | Starting | within a | PRACH | PRACH |
| Index | format | x | y | number | symbol | subframe | slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| . . . | . . . | | | | | | | |
| 104 | A1 | 1 | 0 | 1, 4, 7 | 0 | 2 | 6 | 2 |
| . . . | . . . | | | | | | | |
| 251 | C2 | 1 | 0 | 2, 7 | 0 | 2 | 2 | 6 |
| 252 | C2 | 1 | 0 | 1, 4, 7 | 0 | 2 | 2 | 6 |
| 253 | C2 | 1 | 0 | 0, 2, 4, 6, 8 | 0 | 2 | 2 | 6 |
| 254 | C2 | 1 | 0 | 0, 1, 2, 3, 4, 5, 6, 7, 8, 9 | 0 | 2 | 2 | 6 |
| 255 | C2 | 1 | 0 | 1, 3, 5, 7, 9 | 0 | 2 | 2 | 6 |

FIG. 12 illustrates an example of an SBFD operation in a TDD band of the wireless communication system to which the disclosure is applied.

Referring to FIG. 12, configuration (a) illustrates a case where TDD is operated in a specific frequency band. In a cell in which the TDD is operated, a base station may transmit and receive signals including data/control information to and from an existing TDD UE or SBFD UE in a DL slot (or symbol), an UL slot (or symbol) 1201, and a flexible slot (or symbol), based on a configuration of TDD UL-DL resource configuration information indicating a DL slot (or symbol) resource and an UL slot (or symbol) resource of the TDD.

In FIG. 12, it may be assumed that a DDDSU slot format is configured according to the TDD UL-DL resource configuration information. Here, “D” is a slot composed entirely of DL symbols, “U” is a slot composed entirely of UL symbols, and “S” is a slot that is neither “D” nor “U”, i.e., a slot including a DL symbol, an UL symbol, or including a flexible symbol. Here, for convenience, it may be assumed that S includes 12 DL symbols and 2 flexible symbols. In addition, the DDDSU slot format may be repeated according to the TDD UL-DL resource configuration information. That is, a repetition periodicity of a TDD configuration is 5 slots (5 ms for 15 kHz SCS, 2.5 ms for SCS of 30 kHz, etc.)

In FIG. 12, configurations (b), (c), and (d) illustrate cases in which both SBFD and TDD are operated in a specific frequency band.

Referring to configuration (b), a UE may be configured with a partial band of frequency of a cell, as a frequency band 1210 where UL transmission is possible. This band may be referred to as a UL subband. In addition, the UL subband may be applied to all symbols of all slots. The UE may transmit UL channels or signals scheduled for all symbols 1212 within the UL subband. However, the UE may not be able to transmit an UL channel or signal in a band other than the UL subband.

Referring to configuration (c), a UE may be configured with a partial band of frequency of a cell, as a frequency band 1220 where UL transmission is possible, and may be configured with a time domain in which the frequency band is activated. Here, this frequency band may be referred to as a UL subband. Here, the UL subband (is deactivated in a first slot, and the UL subband may be activated in the remaining slots. Therefore, the UE may transmit a UL channel or signal in the UL subband 1222 of the remaining slots. Accordingly, although the UL subband is activated in units of slots here, the activation may be configured in units of symbols.

Referring to configuration (d), a UE may be configured with a time-frequency resource on which UL transmission is possible. The UE may be configured with one or more time-frequency resources as time-frequency resources on which UL transmission is possible. For example, a partial frequency band 1232 of a first slot and a second slot may be configured as a time-frequency resource on which UL transmission is possible. In addition, a partial frequency band 1233 of a third slot and a partial frequency band 1234 of a fourth slot may be configured as time-frequency resources on which UL transmission is possible.

In the following description, a time-frequency resource on which UL transmission is possible in a DL symbol or a flexible symbol may be referred to as an SBFD resource/UL subband.

### Reference SCS and Frequency Domain Interpretation in SBFD

According to an embodiment, a method is provided for a UE to determine a UL subband, a DL subband, and a guard band from a base station.

The UE may receive at least one piece of the first or second information from the base station, or based on received information.

The first information may include an index (RBₛₜₐᵣₜ^{UL-SB,μ}) of an RB where a UL subband starts, the number (RB_{size}^{UL-SB,μ}) of RBs included in the UL subband, and the number (RB_{size}^{Guard,μ}) of RBs included in a guard band located near the frequency axis of the UL subband. The UE may determine that RBs, which are not included in the UL subband but are included in a guard band, are of a DL subband. Here, if the number of RBs included in the guard band has one value, a size of a guard band located below one frequency axis of the UL subband and a size of a guard band located above the other frequency axis of the UL subband are the same, and the size of each guard band may be determined to be the number of RBs corresponding to the one value. Here, if the number of RBs included in the guard band has two values (a first value (RB_{size,1}^{Guard,μ}) and a second value (RB_{size,2}^{Guard,μ}) which are included in the first information, the UE may determine that a size of a guard band located under the UL subband on the frequency axis is the number of RBs corresponding to the first value (RB_{size,1}^{Guard,μ}), and that a size of a guard band located on the UL subband on the frequency axis is the number of RBs corresponding to the second value (RB_{size,2}^{Guard,μ}). Alternatively, the converse is also possible.

The second information may include an index (RBₛₜₐᵣₜ^{UL-SB,μ}) of an RB where the UL subband starts, the number (RB_{size}^{UL-SB,μ}) of RBs included in the UL subband, an index (RBₛₜₐᵣₜ^{UL-SB1,μ}) of an RB where a first DL subband starts, the number (RB_{size}^{UL-SB1,μ}) of RBs included in the first DL subband, an index (RBₛₜₐᵣₜ^{UL-SB2,μ}) of an RB where a second DL subband starts, and the number (RB_{size}^{UL-SB2,μ}) of RBs included in the second DL subband. Note that, if only one DL subband is configured, information (RBₛₜₐᵣₜ^{UL-SB2,μ}, RB_{size}^{UL-SB2,μ}) on the second DL subband may not be included. The UE may determine that RBs which are included neither in the UL subband nor in the DL subbands are RBs of the guard band.

In the following description, unless otherwise specified, the description is provided based on the second information. However, the embodiments of the disclosure are also applicable to the first information.

An index of an RB where the UL subband ends may be RB_{end}^{UL-SB,μ}=RBₛₜₐᵣₜ^{UL-SB,μ}+RB_{size}^{UL-SB,μ}−1, an index of an RB where a first DL subband ends may be RB_{end}^{UL-SB1,μ}=RBₛₜₐᵣₜ^{UL-SB1,μ}+RB_{size}^{UL-SB1,μ}−1, and an index of an RB where a second DL subband ends may be RB_{end}^{UL-SB2,μ}=RBₛₜₐᵣₜ^{UL-SB2,μ}+RB_{size}^{UL-SB2,μ}−1.

For the indexes of the RBs in the first information and the second information, the UE may follow a common RB index of specific SCS μ. Here, the common RB index may be determined as follows.

All UEs in a cell may determine a single frequency point (pointA) regardless of an SCS. The UE may acquire the information above from SI that the base station transmits to the UEs in the cell. The UE may index subcarriers according to a SCS from the frequency point (pointA). An index of a subcarrier having pointA as a center frequency is 0, and the index may increase by 1 in ascending order of frequency. The UE may generate a CRB by grouping 12 consecutive subcarriers. Here, a CRB having an index of n may be a group of subcarriers having indexes of 12*n, 12*n+1, . . . , 12*n+11.

Herein, an index of an RB may be interpreted as at least one of the following.

According to a first interpretation, an RB with index 0 may be CRB 0 (a CRB including a subcarrier of pointA). Therefore, an RB with index i may be CRB i.

According to a second interpretation, the RB with index 0 may be a CRB obtained from CRB 0 to which an offset of offsetToCarrier has been applied. That is, an RB with index i is CRB i+X, where X may be equal to a value of offsetToCarrier. The UE may receive offsetToCarrier from the base station. The value may be included in one of FrequencyInfoDL-SIB and FrequencyInfoUL-SIB included in SIB1 or FrequencyInfoDL and FrequencyInfoUL included in a UE-specific RRC configuration. offsetToCarrier may be configured for each SCS. That is, different SCSs may have different offsetToCarrier values.

The first information, the second information, and embodiments associated therewith are described by assuming an RB basis configuration. That is, RB indexes may be used in the description. When configured in units of RB sets obtained by combining RBs, an RB index may be replaced with an RB set index in the embodiments to be described below.

In the following description, a specific SCS for determination of an RB index in the first information and the second information is referred to as a reference SCS. When the UE is provided with the first information or the second information from the base station, the specific SCS may also be provided. Alternatively, the UE may determine the reference SCS based on other signals, e.g., by using a SCS used for a TDD configuration of a cell, a SCS used for an initial DL BWP used during initial cell access, a SCS used for an initial UL BWP used during initial cell access, a SCS of an SS/PBCH block, SCSs (SCS configured for FrequencyInfoDL-SIB or FrequencyInfoUL-SIB in the SI) used for the cell, or at least one of a maximum value and a minimum value of the SCSs.

The UE may receive a configuration for a DL BWP and a UL BWP from the base station. Here, the DL BWP and the UL BWP may be configured with a SCS. For example, the DL BWP and the UL BWP may be configured with a 30 KHz SCS. Therefore, when the UE receives a DL channel or a DL signal in the DL BWP, and transmits an UL channel or an UL signal in the UL BWP, an OFDM symbol may be determined based on the 30 KHz SCS. The SCS used for the DL BWP and the UL BWP is μ′ (2^{μ′} kHz) which may be the same as or different from the reference SCS μ (2^{μ} kHz).

It is assumed that an index (e.g., a CRB index) of a start RB of the UL BWP is RBₛₜₐᵣₜ^{UL-BWP,μ′}, the number of RBs included in the UL BWP is RB_{size}^{UL-BWP,μ′}, and an index (e.g., a CRB index) of a last RB of the UL BWP is RB_{end}^{UL-BWP,μ′}=RBₛₜₐᵣₜ^{UL-BWP,μ′}+RB_{size}^{UL-BWP,μ′}−1.

It is assumed that an index (e.g., a CRB index) of a start RB of the DL BWP is RBₛₜₐᵣₜ^{DL-BWP,μ′}, the number of RBs included in the DL BWP is RB_{size}^{DL-BWP,μ′}, and an index (e.g., a CRB index) of a last RB of the DL BWP is RB_{end}^{DL-BWP,μ′}=RBₛₜₐᵣₜ^{DL-BWP,μ′}+RB_{size}^{DL-BWP,μ′}−1.

The reference SCS used by the UE and the SCS used for the DL BWP and UL BWP may be the same or may be different. If the reference SCS and the SCS used for the DL BWP and UL BWP are the same (μ=μ′), the UE may determine an actual UL subband and an actual DL subband within the DL BWP and UL BWP, as follows.

### Actual UL Subband:

An index of a starting RB of the actual UL subband may be RBₛₜₐᵣₜ^{UL-actual,μ′}=max{RBₛₜₐᵣₜ^{UL-BWP,μ′}, RBₛₜₐᵣₜ^{UL-SB,μ}} and an index of a last RB of the actual UL subband may be RB_{end}^{UL-actual,μ′}=min{RB_{end}^{UL-BWP,μ′}, RB_{end}^{UL-SB,μ}}. In addition, the number of RBs included in the actual UL subband may be RB_{size}^{UL-actual,μ′}=RB_{end}^{UL-actual,μ′}−RBₛₜₐᵣₜ^{UL-actual,μ′}+1=min{RB_{end}^{UL-BWP,μ′}, RB_{end}^{UL-SB,μ}}−max{RBₛₜₐᵣₜ^{UL-BWP,μ′}, RBₛₜₐᵣₜ^{UL-SB,μ}}+1. When RB_{size}^{UL-actual,μ′}≤0, the UE may determine that there is no UL subband in the UL BWP.

### Actual DL Subband:

DL subbands included in the DL BWP may be referred to as actual DL subbands. Up to two DL subbands may be configured. When two DL subbands are configured, the UE may determine up to two actual DL subbands in the DL BWP.

An index of a starting RB of a first actual DL subband may be RBₛₜₐᵣₜ^{DL-actual,μ′}=max{RBₛₜₐᵣₜ^{DL-BWP,μ′},RBₛₜₐᵣₜ^{DL-SB1,μ}}, and an index of a last RB of the first actual DL subband may be RB_{end}^{DL-actual,μ′}=min{RB_{end}^{DL-BWP,μ′}, RB_{end}^{DL-SB1,μ}}. In addition, the number of RBs included in the first actual DL subband may be RB_{size}^{DL-actual1,μ′}=RB_{end}^{DL-actual1,μ′}−RBₛₜₐᵣₜ^{DL-actual1,μ′}+1=min{RB_{end}^{DL-BWP,μ′}, RB_{end}^{DL-BWP,μ}}−max{RBₛₜₐᵣₜ^{DL-BWP,μ′},RBₛₜₐᵣₜ^{DL-SB1,μ}}+1. When RB RB_{size}^{DL-actual1,μ′}≤0, the UE may determine that there is no first DL subband in the DL BWP.

An index of a starting RB of a second actual DL subband may be RBₛₜₐᵣₜ^{DL-actual2,μ′}=max{RBₛₜₐᵣₜ^{DL-BWP,μ′}, RBₛₜₐᵣₜ^{DL-SB2,μ}}, and an index of a last RB of the second actual DL subband may be RB_{end}^{DL-actual2,μ′}=min{RB_{end}^{DL-BWP,μ′}, RB_{end}^{DL-SB2,μ}}. In addition, the number of RBs included in the second actual DL subband may be RB_{size}^{DL-actual2,μ′}=RB_{end}^{DL-actual,μ′}−RBₛₜₐᵣₜ^{DL-actual,μ′}+1=min{RB_{end}^{DL-BWP,μ′}, RB_{end}^{DL-SB2,μ}}−max{RBₛₜₐᵣₜ^{DL-BWP,μ′}, RBₛₜₐᵣₜ^{DL-SB2,μ}}+1. When RB_{size}^{DL-actual2,μ′}≤0, the UE may determine that there is no second DL subband in the DL BWP.

If the reference SCS and the SCS used for the DL BWP and UL BWP are different, the UE may determine an actual UL subband and an actual DL subband within the DL BWP and UL BWP, as follows. Here, the SCS used for the DL BWP and the UL BWP is μ′ which may be different from reference SCS μ. The indexes of the actual UL subbands and the actual DL subbands may be indicated by the CRB indexes having SCS of μ′.

First, μ′<μ is assumed. In this case, determinations may be made as follows.

### Actual UL Subband:

An index of a starting RB of the actual UL subband may be RBₛₜₐᵣₜ^{UL-actual,μ′}=max{RBₛₜₐᵣₜ^{UL-BWP,μ′}, 2^{μ-μ′}*RBₛₜₐᵣₜ^{UL-SB,μ}} and an index of a last RB of the actual UL subband may be RB_{end}^{UL-actual,μ′}=min{RB_{end}^{UL-BWP,μ′}, 2^{μ-μ′}*(RB_{end}^{UL-SB,μ}+1)−1}. In addition, the number of RBs included in the actual UL subband may be RB_{size}^{UL-actual,μ′}=RBₛₜₐᵣₜ^{UL-actual,μ′}−RBₛₜₐᵣₜ^{UL-actual,μ′}+1=min{RB_{end}^{UL-BWP,μ′}, 2^{μ-μ′}*(RB_{end}^{UL-SB,μ}+1)−1}−max{RBₛₜₐᵣₜ^{UL-BWP,μ′}, 2^{μ-μ′}*RBₛₜₐᵣₜ^{UL-SB,μ}}+1. When RB_{size}^{UL-actual,μ′}≤0, the UE may determine that there is no UL subband in the UL BWP.

### Actual DL Subband:

An index of a starting RB of a first actual DL subband may be RBₛₜₐᵣₜ^{DL-actual1,μ′}=max{RBₛₜₐᵣₜ^{DL-BWP,μ′}, 2^{μ-μ′}*RBₛₜₐᵣₜ^{DL-SB1,μ} }, and an index of a last RB of the first actual DL subband may be RB_{end}^{DL-BWP,μ′}=min{RB_{end}^{DL-BWP,μ′},2^{μ-μ′}*(RB_{end}^{DL-SB1,μ}+1)−1}. In addition, the number of RBs included in the first actual DL subband may be RB_{size}^{DL-actual1,μ′}=RB_{end}^{DL-actual1,μ′}−RBₛₜₐᵣₜ^{DL-actual,μ′}+1=min{RB_{end}^{DL-BWP,μ′},2^{μ-μ′}*(RB_{end}^{DL-SB1,μ}+1)−1}−max{RBₛₜₐᵣₜ^{DL-BWP,μ′},2^{μ-μ′}*RBₛₜₐᵣₜ^{DL-SB1,μ′}}+1. When RB_{size}^{DL-actual1,μ′}≤0, the UE may determine that there is no first DL subband in the DL BWP.

An index of a starting RB of a second actual DL subband may be RBₛₜₐᵣₜ^{DL-actual,μ′}=max{RBₛₜₐᵣₜ^{DL-BWP,μ′},2^{μ-μ′}*RBₛₜₐᵣₜ^{DL-SB2,μ}}, and an index of a last RB of the second actual DL subband may be RB_{end}^{DL-actual2,μ′}=min{RB_{end}^{DL-BWP,μ′},2^{μ-μ′}*(RB_{end}^{DL-SB2,μ}+1)−1}. In addition, the number of RBs included in the second actual DL subband may be RB_{size}^{DL-actual2,μ′}=RB_{end}^{DL-actual2,μ′}−RBₛₜₐᵣₜ^{DL-actual2,μ′}+1=min{RB_{end}^{DL-BWP,μ′}, 2^{μ-μ′}*(RB_{end}^{DL-SB2,μ}+1)−1}−max{RBₛₜₐᵣₜ^{DL-BWP,μ′},2^{μ-μ′}*RBₛₜₐᵣₜ^{DL-SB2,μ}}+1. When RB_{size}^{DL-actual,μ′}≤0, the UE may determine that there is no second DL subband in the DL BWP. μ′>μ is assumed. If μ′=μ or μ′<μ, there is only one subband RB (reference SCS of 2^{μ} kHz) overlapping with one RB (SCS of 2^{μ′} kHz) of an active BWP. Here, the subband RB refers to an RB included in a subband configured according to information 1 or information 2. However, if μ′>μ, there may be two or more subband RBs (reference SCS of 2^{μ} kHz) overlapping with one RB (SCS of 2^{μ′} kHz) of the active BWP. For example, a bandwidth occupied by one RB of the active BWP, for which a SCS of 30 kHz has been configured, is 30*12=360 kHz, and a bandwidth occupied by one subband RB for which a reference SCS of 15 kHz has been configured is 15*12=180 kHz. Therefore, one RB of the active BWP, for which the SCS of 30 kHz has been configured, is overlapping with two subband RBs for which 15 kHz has been configured.

According to the configuration, a subband RB (reference SCS of 24 kHz) overlapping with one RB (SCS of 2^{μ′} kHz) of the active BWP may belong to different subbands. For example, one subband RB may belong to a UL subband, and the other subband RB may belong to a DL subband. In addition, one subband RB may belong to a UL subband or a DL subband, and the other RB may belong to a guard band. The disclosure provides a method of determining an actual DL subband and an actual UL subband within an active BWP when a subband RB (reference SCS of 2^{μ} kHz) overlapping with one RB (SCS of 2^{μ′} kHz) of the active BWP belong to different subbands.

Method 1: RBs of an active UL BWP, which include at least one UL subband RB (e.g., an RB included in a UL subband configuration), may be included in an actual UL subband. In addition, RBs of an active DL BWP, which include at least one DL subband RB (e.g., an RB included in a DL subband configuration), may be included in an actual DL subband. RBs between the actual UL subband and the actual DL subband may be considered as RBs of a guard band.

### Actual UL Subband:

According to method 1, an index of a starting RB of the actual UL subband may be RBₛₜₐᵣₜ^{UL-actual,μ′}=max{RBₛₜₐᵣₜ^{UL-BWP,μ′}, └2^{μ-μ′}*RBₛₜₐᵣₜ^{UL-SB,μ}┘}, and an index of a last RB of the actual UL subband may be RB_{end}^{UL-actual,μ′}=min{RB_{end}^{UL-BWP,μ′}, └2^{μ-μ′}*RB_{end}^{UL-SB,μ}┘}. In addition, the number of RBs included in the actual UL subband may be RB_{size}^{UL-actual,μ′}=RB_{end}^{UL-actual,μ′}−RBₛₜₐᵣₜ^{UL-actual,μ′}+1=min{RB_{end}^{UL-BWP,μ′}, └2^{μ-μ′}*RB_{end}^{UL-SB,μ}┘}−max{RBₛₜₐᵣₜ^{UL-BWP,μ′}, └2^{μ-μ′}*RBₛₜₐᵣₜ^{UL-SB,μ}┘}+1 When RB_{size}^{UL-actual,μ′}≤0, the UE may determine that there is no UL subband in the UL BWP.

### Actual DL Subband:

According to method 1, an index of a starting RB of a first actual DL subband may be RBₛₜₐᵣₜ^{DL-actual1,μ′}=max{RBₛₜₐᵣₜ^{DL-BWP,μ′}, └2^{μ-μ′}*RBₛₜₐᵣₜ^{DL-SB1,μ}┘}, and an index of a last RB of the first actual DL subband may be RB_{end}^{DL-actual1,μ′}=min{RB_{end}^{DL-BWP,μ′}, └2^{μ-μ′}*RB_{end}^{DL-SB1,μ}┘}, In addition, the number of RBs included in the first actual DL subband may be RB_{size}^{DL-actual1,μ′}=RB_{end}^{DL-actual1,μ′}−RBₛₜₐᵣₜ^{DL-actual1,μ′}+1=min{RB_{end}^{DL-BWP,μ′}, └2^{μ-μ′}*RB_{end}^{DL-SB,μ}┘}−max{RBₛₜₐᵣₜ^{DL-BWP,μ′}, └2^{μ-μ′}*RBₛₜₐᵣₜ^{DL-SB1,μ}┘}+1. When RB_{size}^{DL-actual1,μ′}≤0, the UE may determine that there is no first DL subband in the DL BWP.

An index of a starting RB of a second actual DL subband may be RBₛₜₐᵣₜ^{DL-actual2,μ′}=max{RBₛₜₐᵣₜ^{DL-BWP,μ′}, └2^{μ-μ′}*RBₛₜₐᵣₜ^{DL-SB2,μ}┘}, and an index of a last RB of the second actual DL subband may be RB_{end}^{DL-actual2,μ′}=min{RB_{end}^{DL-BWP,μ′}, └2^{μ-μ′}*RB_{end}^{UL-SB2,μ}┘}. In addition, the number of RBs included in the second actual DL subband may be RB_{size}^{DL-actual2,μ′}=RB_{end}^{DL-actual2,μ′}−RBₛₜₐᵣₜ^{DL-actual2,μ′}+1=min{RB_{end}^{DL-BWP,μ′}, └2^{μ-μ′}*RB_{end}^{DL-SB2,μ}┘}−max{RBₛₜₐᵣₜ^{DL-BWP,μ′}, └2^{μ-μ′}*RBₛₜₐᵣₜ^{DL-SB2,μ}┘}+1 When RB_{size}^{DL-actual2,μ′}≤0, the UE may determine that there is no second DL subband in the DL BWP.

Method 2: If all RBs overlapping with RBs of an active UL BWP are UL subband RBs (e.g., RBs included in a UL subband configuration), the RBs of the active UL BWP may be included in an actual UL subband. In addition, if all RBs overlapping with RBs of an active DL BWP are DL subband RBs (e.g., RBs included in a DL subband configuration), the RBs of the active DL BWP may be included in an actual DL subband. RBs between the actual UL subband and the actual DL subband may be considered as RBs of a guard band.

### Actual UL Subband:

According to method 2, an index of a starting RB of the actual UL subband may be RBₛₜₐᵣₜ^{UL-actual,μ′}=max{RBₛₜₐᵣₜ^{UL-BWP,μ′}, └2^{μ-μ′}*(RBₛₜₐᵣₜ^{UL-SB,μ}−1)┘+1}, and an index of a last RB of the actual UL subband may be RB_{end}^{UL-actual,μ′}=min{RB_{end}^{UL-BWP,μ′}, └2^{μ-μ′}*(RB_{end}^{UL-SB,μ}+1)┘−1}. In addition, the number of RBs included in the actual UL subband may be RB_{size}^{UL-actual,μ′}=RB_{end}^{UL-actual,μ′}−RBₛₜₐᵣₜ^{UL-actual,μ′}+1=min{RB_{end}^{UL-BWP,μ′}, └2^{μ-μ′}*(RB_{end}^{UL-SB,μ}+1)┘−1}−max{RBₛₜₐᵣₜ^{UL-BWP,μ′}, └2^{μ-μ′}*(RBₛₜₐᵣₜ^{UL-SB,μ}−1)┘+1}+1. When RB_{size}^{UL-actual,μ′}≤0, the UE may determine that there is no UL subband in the UL BWP.

### Actual DL Subband:

According to method 2, an index of a starting RB of a first actual DL subband may be RBₛₜₐᵣₜ^{DL-actual1,μ′}=max{RBₛₜₐᵣₜ^{DL-BWP,μ′}, └2^{μ-μ′}*RBₛₜₐᵣₜ^{DL-SB1,μ}┘}, and an index of a last RB of the first actual DL subband may be RB_{end}^{DL-actual1,μ′}=min{RB_{end}^{DL-BWP,μ′}, └2^{μ-μ′}*RB_{end}^{DL-SB1,μ}┘}. In addition, the number of RBs included in the first actual DL subband may be RB_{size}^{DL-actual1,μ′}=RB_{end}^{DL-actual1,μ′}−RBₛₜₐᵣₜ^{DL-actual1,μ′}+1=min{RB_{end}^{DL-BWP,μ′}, └2^{μ-μ′}*RBₛₜₐᵣₜ^{DL-SB1,μ}┘}−max{RBₛₜₐᵣₜ^{DL-BWP,μ′}, └2^{μ-μ′}*RBₛₜₐᵣₜ^{DL-SB1,μ}┘}+1. When RB_{size}^{DL-actual1,μ′}≤0, the UE may determine that there is no first DL subband in the DL BWP.

An index of a starting RB of a second actual DL subband may be RBₛₜₐᵣₜ^{DL-actual2,μ′}=max{RBₛₜₐᵣₜ^{DL-BWP,μ′}, └2^{μ-μ′}*RBₛₜₐᵣₜ^{DL-SB2,μ}┘}, and an index of a last RB of the second actual DL subband may be RB_{end}^{DL-actual2,μ′}=min{RB_{end}^{DL-BWP,μ′}, └2^{μ-μ′}*RB_{end}^{DL-SB2,μ}┘}. In addition, the number of RBs included in the second actual DL subband may be RB_{size}^{DL-actual2,μ′}=RB_{end}^{DL-actual2,μ′}−RBₛₜₐᵣₜ^{DL-actual2,μ′}+1=min{RB_{end}^{DL-BWP,μ′}, └2^{μ-μ′}*RB_{end}^{UL-SB2,μ}┘}−max{RBₛₜₐᵣₜ^{DL-BWP,μ′}, └2^{μ-μ′}*RBₛₜₐᵣₜ^{DL-SB2,μ}┘}+1. When RB_{size}^{DL-actual2,μ′}≤0, the UE may determine that there is no second DL subband in the DL BWP.

Methods 1 and 2, as described above, determine an actual DL subband and an actual UL subband within an active DL BWP or an active UL BWP. In another method, the UE may interpret DL and UL subbands, which have been configured based on CRBs of a reference SCS μ, based on CRBs of another SCS μ′. In addition, the UE may determine an actual DL subband and an actual UL subband, based on DL and UL subbands interpreted based on an SCS of an active DL BWP or active UL BWP of the UE.

The method in which the UE interprets DL and UL subbands, which have been configured based on the CRBs of a reference SCS, based on CRBs of another SCS μ′ may be as follows.

First, μ′<μ is assumed. In this case, determinations may be made as follows.

### UL Subband Interpreted Based on CRBs of SCS μ′:

An index of a starting RB of a UL subband interpreted based on CRBs of SCS μ′ may be RBₛₜₐᵣₜ^{UL-SB,μ′}=2^{μ-μ′}*RBₛₜₐᵣₜ^{UL-SB,μ}, and an index of a last RB of a UL subband interpreted based on the CRBs of SCS μ′ may be RB_{end}^{UL-SB,μ′}=2^{μ-μ′}*(RB_{end}^{UL-SB,μ}+1)−1. In addition, the number of RBs included in the UL subband interpreted based on the CRBs of SCS μ′ may be RB_{size}^{UL-SB,μ′}=RB_{end}^{UL-SB,μ′}−RBₛₜₐᵣₜ^{UL-SB,μ′}+1. When RB_{size}^{UL-SB,μ′}≤0, the UE may determine that there is no UL subband interpreted based on the CRBs of SCS μ′.

### DL Subband Interpreted Based on CRBs of SCS μ′:

An index of a starting RB of a first DL subband interpreted based on the CRBs of an SCS μ′ may be RBₛₜₐᵣₜ^{DL-SB1,μ′}=2^{μ-μ′}*RBₛₜₐᵣₜ^{DL-SB1,μ}, and an index of a last RB of the first DL subband interpreted based on the CRBs of an SCS μ′ may be RB_{end}^{DL-SB1,μ′}=2^{μ-μ′}*(RB_{end}^{RDL-SB1,μ}+1)−1. In addition, the number of RBs included in the first DL subband interpreted based on the CRBs of an SCS μ′ may be RB_{size}^{DL-SB1,μ′}=RB_{end}^{DL-SB1,μ′}<RBₛₜₐᵣₜ^{DL-SB1,μ′}+1. For reference, when RB_{size}^{DL-SB1,μ′}≤0, the UE may determine that there is no first DL subband interpreted based on the CRBs of an SCS μ′.

An index of a starting RB of a second DL subband interpreted based on the CRBs of an SCS μ′ may be RBₛₜₐᵣₜ^{DL-SB2,μ′}=2^{μ-μ′}*RBₛₜₐᵣₜ^{DL-SB2,μ}, and an index of a last RB of the second DL subband interpreted based on the CRBs of an SCS μ′ may be RB_{end}^{DL-SB2,μ′}=2^{μ-μ′}*(RB_{end}^{DL-SB2,μ}+1)−1. In addition, the number of RBs included in the second DL subband interpreted based on the CRBs of an SCS μ′ may be RB_{size}^{DL-SB2,μ′}=RB_{end}^{DL-SB2,μ′}−RBₛₜₐᵣₜ^{DL-SB2,μ′}+1. For reference, when RB_{size}^{DL-SB2,μ′}≤0, the UE may determine that there is no second DL subband interpreted based on the CRBs of an SCS μ′.

In this case, μ′>μ is assumed.

Method 3: RBs of an SCS μ′, which include at least one UL subband RB (e.g., an RB included in a UL subband configuration configured based on reference SCS μ), may be included in a UL subband interpreted based on the CRBs of an SCS μ′. That is, when multiple RBs of a reference SCS μ correspond to one specific RB of an SCS μ′, and at least one RB of a reference SCS μ among the multiple RBs of a reference SCS μ is an RB included in the UL subband configuration configured based on a reference SCS μ, the one specific RB of an SCS μ′ may be included in the UL subband. In addition, RBs of an SCS μ′, which include at least one DL subband RB (e.g. an RB included in a DL subband configuration configured based on reference an SCS μ), may be included in a DL subband interpreted based on the CRBs of an SCS μ′. RBs between the UL subband interpreted based on the CRBs of an SCS μ′ and the DL subband interpreted based on the CRBs of an SCS μ′ may be considered as RBs of a guard band. That is, when multiple RBs of a reference SCS μ correspond to one specific RB of an SCS μ′, and at least one RB of a reference SCS μ among the multiple RBs of a reference SCS μ is an RB included in the DL subband configuration configured based on a reference SCS μ, the one specific RB of an SCS μ′ may be included in the UL subband.

### UL Subband Interpreted Based on CRBs of SCS μ′:

An index of a starting RB of the UL subband interpreted based on the CRBs of an SCS μ′ may be RBₛₜₐᵣₜ^{UL-SB,μ′}=└2^{μ-μ′}*RBₛₜₐᵣₜ^{UL-SB,μ}┘, and an index of a last RB of the UL subband interpreted based on the CRBs of an SCS μ′ may be RB_{end}^{UL-SB,μ′}=└2^{μ-μ′}*RB_{end}^{UL-SB,μ}┘. In addition, the number of RBs included in the UL subband interpreted based on the CRBs of an SCS μ′ may be RB_{size}^{UL-SB,μ′}=RB_{end}^{UL-SB,μ′}−RBₛₜₐᵣₜ^{UL-SB,μ′}+1.

When RB_{size}^{UL-SB,μ′}≤0, the UE may determine that there is no UL subband interpreted based on the CRBs of the SCS μ′.

### DL Subband Interpreted Based on CRBs of SCS μ′:

An index of a starting RB of a first DL subband interpreted based on the CRBs of an SCS μ′ may be RBₛₜₐᵣₜ^{DL-SB1,μ′}=└2^{μ-μ′}*RBₛₜₐᵣₜ^{DL-SB1,μ}┘, and an index of a last RB of the first DL subband interpreted based on the CRBs of the SCS μ′ may be RB_{end}^{DL-SB1,μ′}=└2^{μ-μ′}*RB_{end}^{DL-SB1,μ}┘. In addition, the number of RBs included in the first DL subband interpreted based on the CRBs of the SCS μ′ may be RB_{size}^{DL-SB1,μ′}=RB_{end}^{DL-SB1,μ′}−RBₛₜₐᵣₜ^{DL-SB1,μ′}+1.

When RB_{size}^{DL-SB1,μ′}≤0, the UE may determine that there is no first DL subband interpreted based on the CRBs of SCS μ′.

An index of a starting RB of a second DL subband interpreted based on the CRBs of the SCS μ′ may be RBₛₜₐᵣₜ^{DL-SB2,μ′}=└2^{μ-μ′}*RBₛₜₐᵣₜ^{DL-SB2,μ}┘, and an index of a last RB of the second DL subband interpreted based on the CRBs of the SCS μ′ may be RB_{end}^{DL-SB2,μ′}=└2^{μ-μ′}*RB_{end}^{DL-SB2,μ}┘. In addition, the number of RBs included in the second DL subband interpreted based on the CRBs of the SCS μ′ may be RB_{size}^{DL-SB2,μ′}=RB_{end}^{DL-SB2,μ′}−RBₛₜₐᵣₜ^{DL-SB2,μ′}+1. When RB_{size}^{DL-SB2,μ′}≤0, the size UE may determine that there is no second DL subband interpreted based on the CRBs of the SCS μ′.

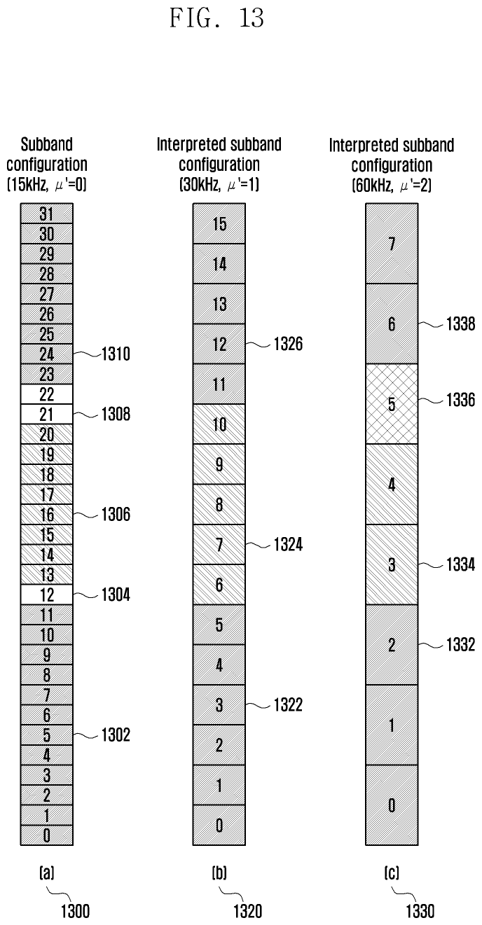

FIG. 13 illustrates examples of a UL subband, DL subbands, and guard bands interpreted based on CRBs of an SCS μ′ according to method 3 according to an embodiment.

Referring to FIG. 13, it is assumed 1300 that an SCS of 15 kHz includes 32 CRBs (CRBs 0, 1, . . . , 31). It is also assumed 1320 that an SCS of 30 kHz includes 16 CRBs (CRBs 0, 1, . . . , 15). It is also assumed 1330 that an SCS of 60 kHz includes 8 CRBs (CRBs 0, 1, . . . , 7). A reference SCS is 15 kHz (μ=0). Based on the SCS of 15 kHz, in configuration (a) 1300, CRB 0 to CRB 11 are configured (RBₛₜₐᵣₜ^{DL-SB1,μ}=0, RB_{end}^{DL-SB1,μ=}11) as a first DL subband 1302, CRB 13 to CRB 20 are configured (RBₛₜₐᵣₜ^{UL-SB,μ}=13, RB_{end}^{UL-SB,μ=}20) as a UL subband 1306, and CRB 23 to CRB 31 are configured (RBₛₜₐᵣₜ^{DL-SB2,μ}=23, RB_{end}^{DL-SB2,μ=}31) as a second DL subband 1310. In addition, CRB 12 is configured as a first guard band (RBₛₜₐᵣₜ^{GB1,μ}=12, RB_{end}^{GB2,μ=}12) 1304, and CRB 21 and CRB 22 are configured as a second guard band (RBₛₜₐᵣₜ^{GB2,μ}=21, RB_{end}^{GB2,μ=}22) 1310.

Referring to configuration (b) 1320, a UL subband, DL subbands, and guard bands interpreted based on the CRBs of the SCS of 30 kHz (μ′=1) are illustrated. When interpretation is performed based on the CRBs of SCS μ′=1 according to method 3, the UE may make determinations as follows.
A starting RB of a UL subband 1324 interpreted based on the CRBs of the SCS μ′=1 is RBₛₜₐᵣₜ^{UL-SB,μ′}=└2^{μ-μ′}*RBₛₜₐᵣₜ^{UL-SB,μ}┘=[13/2]=6, and a last RB is

$${RB}_{end}^{UL - SB , {μ}^{′}} = ⌊ {2}^{μ - {μ}^{′}} * {RB}_{end}^{UL - SB , μ} ⌋ = ⌊ \frac{20}{2} ⌋ = 10.$$

In CRBs 12 and 13 of configuration (a) 1300 corresponding to CRB 6 of configuration (b) 1320, CRB 13 corresponds to the UL subband, and thus, CRB 6 of configuration (b) 1320 may correspond to a UL subband.
An index of a starting RB of a first DL subband 1322 interpreted based on the CRBs of the SCS μ′=1 is RBₛₜₐᵣₜ^{DL-SB1,μ′}=└2^{μ-μ′}*RBₛₜₐᵣₜ^{DL-SB1,μ}┘=└0/2┘=0, and an index of a last RB is RB_{end}^{DL-SB1,μ′}=└2^{μ-μ′}*RB_{end}^{DL-SB1,μ}┘=└11/2┘=5.
An index of a starting RB of a second DL subband 1326 interpreted based on the CRBs of the SCS μ′=1 is RBₛₜₐᵣₜ^{DL-SB2,μ′}=┌2^{μ-μ′}*RBₛₜₐᵣₜ^{DL-SB2,μ}┘=└23/2┘=11, and an index of a last RB is RB_{end}^{DL-SB2,μ′}=|2^{μ-μ′}*RB_{end}^{DL-SB2,μ}┘=└31/2┘=15. In CRBs 22 and 23 of configuration (a) 1300 corresponding to CRB 11 of configuration (b) 1320, CRB 23 corresponds to the DL subband, and thus, CRB 11 of configuration (b) 1320 may correspond to a DL subband.
There may be no first guard band (e.g., RBs between the first DL subband and the UL subband) interpreted based on the CRBs of an SCS μ′=1.
There may be no second guard band (e.g., RBs between the second DL subband and the UL subband) interpreted based on the CRBs of an SCS μ′=1.

Referring to configuration (c) 1330, a UL subband, DL subbands, and guard bands interpreted based on the CRBs of the SCS of 30 kHz (μ′=1) are illustrated. When interpretation is performed based on the CRBs of an SCS μ′=2 according to method 3, the UE may make determinations as follows.
A starting RB of a UL subband 1334 interpreted based on the CRBs of an SCS μ′=2 is RBₛₜₐᵣₜ^{UL-SB,μ′}=└2^{μ-μ′}*RBₛₜₐᵣₜ^{UL-SB,μ}┘=└13/4┘=3, and a last RB is RB_{end}^{UL-SB,μ′}=└2^{μ-μ′}*RB_{end}^{UL-SB,μ}┘=[20/4]=5. In CRBs 12 to 15 of configuration (a) 1300 corresponding to CRB 3 of configuration (c) 1330, CRBs 13 to 15 correspond to the UL subband, and thus, CRB 3 of configuration (c) 1330 may correspond to a UL subband.
An index of a starting RB of a first DL subband 1332 interpreted based on the CRBs of an SCS μ′=2 is RBₛₜₐᵣₜ^{DL-SB1,μ′}=└2^{μ-μ′}*RBₛₜₐᵣₜ^{DL-SB1,μ}┘=└0/4┘=0, and an index of a last RB is RB_{end}^{DL-SB1,μ′}=└2^{μ-μ′}*RB_{end}^{DL-SB1,μ}┘=└11/4┘=2.
An index of a starting RB of a second DL subband 1338 interpreted based on the CRBs of an SCS μ′=2 is RBₛₜₐᵣₜ^{DL-SB2,μ′}=└2^{μ-μ′}*RBₛₜₐᵣₜ^{DL-SB2,μ}┘=└23/4┘=5, and an index of a last RB is RB_{end}^{DL-SB2,μ′}=└2^{μ-μ′}*RB_{end}^{DL-SB2,μ}┘=└31/4┘=7.
There may be no first guard band (e.g., RBs between the first DL subband and the UL subband) interpreted based on the CRBs of an SCS μ′=2.
There may be no second guard band (e.g., RBs between the second DL subband and the UL subband) interpreted based on the CRBs of an SCS μ′=2.

As shown in configuration (c) 1330, CRB 5 1336 (or CRBs 20 to 23 of configuration (a) 1300) may be included in both the UL and DL subbands. In SBFD, a UL subband and a DL subband cannot be configured to the same frequency, so that CRB 5 1336 should be determined to be one subband. Based on one of the following examples of the disclosure, CRB 5 1336 may be determined to be one subband or guard band.

As a first example, the UE may always determine CRB 5 1336 to be the UL subband. That is, if a specific frequency band, such as CRB 5 1336, is included in both a UL subband and a DL subband, the UE may include CRB 5 1300 in the UL subband and exclude CRB 5 1300 from the DL subband.

As a second example, the UE may always determine CRB 5 1300 to be the DL subband. That is, if a specific frequency band, such as CRB 5 1300, is included in both a UL subband and a DL subband, the UE may include CRB 5 1300 in the DL subband and exclude CRB 5 1300 from the UL subband.

As a third example, the UE may always determine CRB 5 1300 to be a guard band. That is, if a specific frequency band, such as CRB 5 1300, is included in both a UL subband and a DL subband, the UE may exclude CRB 5 1300 from both the UL subband and the DL subband. That is, CRB 5 1300 may be used as a guard band.

Method 4: If all RBs overlapping with RBs of an SCS μ′ are UL subband RBs (e.g., RBs included in a UL subband configuration configured based on reference SCS μ), the RBs of the SCS μ′ may be included in a UL subband interpreted based on the CRBs of the SCS μ′. That is, when multiple RBs of a reference SCS μ correspond to one specific RB of an SCS μ′, and all the multiple RBs of the reference SCS μ are RBs included in the UL subband configuration configured based on the reference SCS μ, the one specific RB of the SCS μ′ may be included in the UL subband. In addition, if all RBs overlapping with RBs of an SCS μ′ are DL subband RBs (e.g., RBs included in a DL subband configuration configured based on a reference SCS μ), the RBs of the SCS μ′ may be included in a DL subband interpreted based on the CRBs of the SCS μ′. That is, when multiple RBs of a reference SCS μ correspond to one specific RB of an SCS μ′, and all the multiple RBs of the reference SCS μ are RBs included in the DL subband configuration configured based on the reference SCS μ, the one specific RB of the SCS μ′ may be included in the DL subband. RBs between the UL subband interpreted based on the CRBs of the SCS μ′ and the DL subband interpreted based on the CRBs of the SCS μ′ may be considered as RBs of a guard band.

### UL Subband Interpreted Based on CRBs of SCS μ′:

An index of a starting RB of the UL subband interpreted based on the CRBs of the SCS μ′ may be RBₛₜₐᵣₜ^{UL-SB,μ′}=└2^{μ-μ′}*(RBₛₜₐᵣₜ^{UL-SB,μ}−1)┘+1, and an index of a last RB of the UL subband interpreted based on the CRBs of the SCS μ′ may be RB_{end}^{UL-SB,μ′}=└2^{μ-μ′}*(RB_{end}^{UL-SB,μ}+1)┘−1. In addition, the number of RBs included in the UL subband interpreted based on the CRBs of the SCS μ′ may be RB_{size}^{UL-SB,μ′}=RB_{end}^{UL-SB,μ′}−RBₛₜₐᵣₜ^{UL-SB,μ′}+1. When RB_{size}^{UL-SB,μ′}≤0, the UE may determine that there is no UL subband interpreted based on the CRBs of SCS μ′.

### DL Subband Interpreted Based on CRBs of SCS μ′:

An index of a starting RB of a first DL subband interpreted based on the CRBs of the SCS μ′ may be RBₛₜₐᵣₜ^{DL-SB1,μ′}=└2^{μ-μ′}*(RBₛₜₐᵣₜ^{DL-SB1,μ}−1)┘+1, and an index of a last RB of the first DL subband interpreted based on the CRBs of the SCS μ′ may be RB_{end}^{DL-SB1,μ′}=└2^{μ-μ′}*(RB_{end}^{DL-SB1,μ}+1)┘−1. In addition, the number of RBs included in the first DL subband interpreted based on the CRBs of the SCS μ′ may be RB_{size}^{DL-SB1,μ′}=RB_{end}^{DL-SB1,μ′}−RBₛₜₐᵣₜ^{DL-SB1,μ′}+1. When RB_{size}^{DL-SB1,μ′}≤0, the UE may determine that there is no first DL subband interpreted based on the CRBs of the SCS μ′.

An index of a starting RB of a second DL subband interpreted based on the CRBs of the SCS μ′ may be RBₛₜₐᵣₜ^{DL-SB2,μ}=└2^{μ-μ′}*(RBₛₜₐᵣₜ^{DL-SB2,μ}−1)┘+1, and an index of a last RB of the second DL subband interpreted based on the CRBs of the SCS μ′ may be RB_{end}^{DL-SB2,μ′}=└2^{μ-μ′}*(RB_{end}^{DL-SB2,μ}+1)┘−1. In addition, the number of RBs included in the second DL subband interpreted based on the CRBs of the SCS μ′ may be RB_{size}^{DL-SB2,μ′}=RB_{end}^{DL-SB2,μ′}−RBₛₜₐᵣₜ^{DL-SB2,μ′}+1. When RB_{size}^{DL-SB2,μ′}≤0, the UE may determine that there is no second DL subband interpreted based on the CRBs of the SCS μ′.

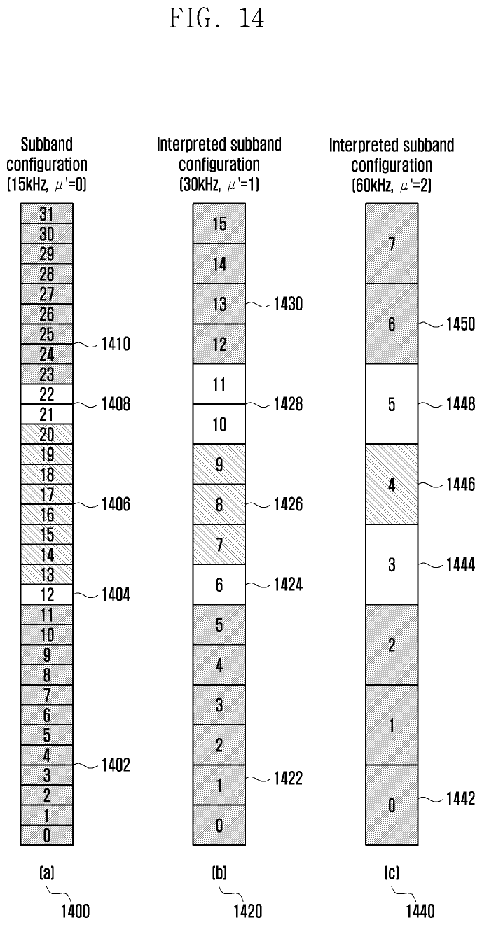

FIG. 14 illustrates a UL subband, DL subbands, and guard bands interpreted based on CRBs of an SCS μ′ according to method 4 according to an embodiment.

Referring to FIG. 14, in configuration (a) 1400, it is assumed that an SCS of 15 kHz includes 32 CRBs (CRBs 0, 1, . . . , 31). It is also assumed 1420 that a SCS of 30 kHz includes 16 CRBs (CRBs 0, 1, . . . , 15). It is also assumed 1440 that a SCS of 60 kHz includes 8 CRBs (CRBs 0, 1, . . . , 7. A reference SCS is 15 kHz (μ=0). Based on the SCS of 15 kHz, CRB 0 to CRB 11 are configured (RBₛₜₐᵣₜ^{DL-SB1,μ}=0, RB_{end}^{DL-SB1,μ}=11) as a first DL subband 1402, CRB 13 to CRB 20 are configured (RBₛₜₐᵣₜ^{UL-SB,μ}=13, RB_{end}^{UL-SB,μ}=20) as a UL subband 1406, and CRB 23 to CRB 31 are configured (RBₛₜₐᵣₜ^{DL-SB2,μ}=23, RB_{end}^{DL-SB2,μ}=31) as a second DL subband 1410. In addition, CRB 12 is configured as a first guard band (RBₛₜₐᵣₜ^{GB1,μ}=12, RB_{end}^{GB1,μ}=12) 1404, and CRB 21 and CRB 22 are configured as a second guard band (RBₛₜₐᵣₜ^{GB2,μ}=21, RB_{end}^{GB2,μ}=22) 1408. Referring to configuration (b) 1420, a UL subband, DL subbands, and guard bands interpreted based on the CRBs of the an SCS of 30 kHz (u′=1) are illustrated. When interpretation is performed based on the CRBs of the SCS μ′=1 according to method 4, the UE may make determinations as follows.
A starting RB of a UL subband 1426 interpreted based on the CRBs of the SCS μ′=1 is RBₛₜₐᵣₜ^{UL-SB,μ′}=└2^{μ-μ′}*RBₛₜₐᵣₜ^{UL-SB,μ}−1)┘+1=└(13−1)/2┘+1=7 and a last RB is RB_{end}^{UL-SB,μ′}=2^{μ-μ′}*(RB_{end}^{UL-SB,μ}+1)┘−1=└(20+1)/2┘−1=9.
An index of a starting RB of a first DL subband 1422 interpreted based on the CRBs of the SCS μ′=1 is RBₛₜₐᵣₜ^{DL-SB1,μ′}=└2^{μ-μ′}*(RBₛₜₐᵣₜ^{DL-SB1,μ}−1)┘+1=[(0−1)/2]+1=0, and an index of a last RB is RB_{end}^{DL-SB1,μ′}=└2^{μ-μ′}*(RB_{end}^{DL-SB1,μ}+1)┘−1=└(11+1)/2┘−1=5.
An index of a starting RB of a second DL subband 1430 interpreted based on the CRBs of the SCS μ′=1 is RBₛₜₐᵣₜ^{DL-SB2,μ′}=└2^{μ-μ′}*(RBₛₜₐᵣₜ^{DL-SB2,μ}−1)┘+1=└(23−1)/2┘+1=12, and an index of a last RB is RB_{end}^{DL-SB2,μ′}=└2^{μ-μ′}*(RB_{end}^{DL-SB2,μ}+1)┘−1=└(31+1)/2┘−1=15.
A first guard band (e.g., RBs between the first DL subband and the UL subband) interpreted based on the CRBs of the SCS μ′=1 may be CRB 6 (RBₛₜₐᵣₜ^{GB1,μ′}=6, RB_{end}^{GB1,μ′}=6) 1424. In CRBs 12 and 13 of configuration (a) 1400 corresponding to CRB 6 of configuration (b) 1420, CRB 13 corresponds to the UL subband but CRB 12 corresponds to the guard band, so that CRB 6 of configuration (b) 1420 does not correspond to the UL subband.
A second guard band (e.g., RBs between the second DL subband and the UL subband) interpreted based on the CRBs of the SCS μ′=1 may be CRBs 10 and 11 (RBₛₜₐᵣₜ^{GB2,μ′}=10, RB_{end}^{GB2,μ′}=11) 1428. In CRBs 22 and 23 of configuration (a) 1400 corresponding to CRB 11 of configuration (b) 1420, CRB 23 corresponds to the DL subband but CRB 22 corresponds to the guard band, so that CRB 11 of configuration (b) 1420 does not correspond to the DL subband.

Referring to configuration (c) 1440, a UL subband, DL subbands, and guard bands interpreted based on the CRBs of the SCS of 30 kHz (μ′=1) are illustrated. When interpretation is performed based on the CRBs of the SCS μ′=2 according to method 4, the UE may make determinations as follows.
A starting RB of a UL subband 1446 interpreted based on the CRBs of the SCS μ′=2 is RBₛₜₐᵣₜ^{UL-SB,μ′}=└2^{μ-μ′}*RBₛₜₐᵣₜ^{UL-SB,μ}−1)┘+1=└(13−1)/4┐+1=4, and a last RB is RB_{end}^{UL-SB,μ′}=└2^{μ-μ′}*RB_{end}^{UL-SB,μ}+1)┘−1=└(20+1)/4┘−1=4.
An index of a starting RB of a first DL subband 1442 interpreted based on the CRBs of the SCS μ′=2 is RBₛₜₐᵣₜ^{DL-SB1,μ′}=└2^{μ-μ′}*RBₛₜₐᵣₜ^{DL-SB1,μ}−1)┘+1=└(0−1)/4┘+1=0, and an index of a last RB is RB_{end}^{DL-SB1,μ′}=└2^{μ-μ′}*RB_{end}^{DL-SB1,μ}+1)┘−1=└(11+1)/4┘−1=2.
An index of a starting RB of a second DL subband 1450 interpreted based on the CRBs of the SCS μ′=2 is RBₛₜₐᵣₜ^{DL-SB2,μ′}=└2^{μ-μ′}*RBₛₜₐᵣₜ^{DL-SB2,μ}−1)┘+1=└(23−1)/4┘+1=6, and an index of a last RB is RB_{end}^{DL-SB2,μ′}=└2^{μ-μ′}*RB_{end}^{DL-SB2,μ}+1)┘−1=└(31+1)/4┘−1=7.
A first guard band (e.g., RBs between the first DL subband and the UL subband) interpreted based on the CRBs of the SCS μ′=2 may be CRB 3 (RBₛₜₐᵣₜ^{GB1,μ′}=3, RB_{end}^{GB1,μ}′=3) 1444.
A second guard band (e.g., RBs between the second DL subband and the UL subband) interpreted based on the CRBs of the SCS μ′=2 may be CRB 5 (RBₛₜₐᵣₜ^{GB2,μ′}=5, RB_{end}^{GB2,μ′}=5) 1448.

In FIG. 14, the first guard band and the second guard band configured for the UE have 1 RB (180 kHz frequency bandwidth) and 2 RBs (360 kHz frequency bandwidth) with the SCS of 15 kHz, respectively. However, the first guard band and the second guard band interpreted based on the CRBs of the SCS of 30 kHz (μ′=1) have 1 RB (360 kHz frequency bandwidth) and 2 RBs (720 KHz frequency bandwidth). Therefore, the guard band of the SCS of 30 kHz may be greater than the guard band of the SCS of 15 kHz. According to an embodiment, a method to solve this issue is disclosed.

More specifically, a UE may determine a guard band interpreted based on CRBs of an SCS μ′, based on a bandwidth of a guard band configured with a reference SCS. That is, the UE may determine a guard band to have the smallest number of RBs among RBs having a bandwidth greater than or equal to a bandwidth of a guard band configured with a reference SCS.

For example, if a guard band is configured to have 1 RB (180 KHz frequency bandwidth) with an SCS of 15 kHz, a guard band interpreted based on CRBs of an SCS of 30 kHz (μ′=1) has 1 RB (360 KHz frequency bandwidth). If a guard band is configured to have 2 RBs (360 kHz frequency bandwidth) with the SCS of 15 kHz, a guard band interpreted based on the CRBs of the SCS of 30 kHz (μ′=1) has 1 RB (360 KHz frequency bandwidth). Typically, if a guard band is configured to have X RBs (180*X KHz frequency bandwidth) with the SCS of 15 kHz, a guard band interpreted based on the CRBs of the SCS of 30 kHz (μ′=1) has ┌X/2┐ RBs (360*^{┌X/2┐} kHz frequency bandwidth).

If a guard band is configured to have 1, 2, 3, or 4 RBs (180 kHz, 360 kHz, 540 kHz, or 720 KHz frequency bandwidth) with the SCS of 15 kHz, a guard band interpreted based on CRBs of a SCS of 60 kHz (μ′=2) has 1 RB (720 KHz frequency bandwidth). If a guard band is configured to have 5, 6, 7, or 8 RBs (900 kHz, 1080 kHz, 1260 kHz, or 1440 kHz frequency bandwidth) with the SCS of 15 kHz, a guard band interpreted based on the CRBs of the SCS of 60 kHz (μ′=2) has 2 RBs (1440 kHz frequency bandwidth). Typically, if a guard band is configured to have X RBs (180*X kHz frequency bandwidth) with the SCS of 15 kHz, a guard band interpreted based on the CRBs of the SCS of 60 kHz (μ′=2) has ┌X/4┐ RBs (720*^{┌X/4┐} kHz frequency bandwidth).

In other words, if a guard band configured with reference SCS (u) includes X RBs, a guard band interpreted based on the CRBs of SCS (μ′) may be determined to be ┌2^{μ-μ′}*X┐.

In accordance with an embodiment of the disclosure, the UE may first determine a UL subband interpreted based on CRBs of an SCS μ′ via methods 3 or 4 described above. The UE may determine, as a first guard band, ┌2^{μ-μ′}*RB_{size}^{GB1}┐ RBs (RBₛₜₐᵣₜ^{UL-SB,μ′}−1, RBₛₜₐᵣₜ^{UL-SB,μ′}−2, . . . , RBₛₜₐᵣₜ^{UL-SB,μ′}−┌2^{μ-μ′}*RB_{size}^{GB1}┐) below the frequency axis of the determined UL subband. The UE may determine, as a second guard band, ┌2^{μ-μ′}*RB_{size}^{GB1}┐ RBs (RB_{end}^{UL-SB,μ′}+1, RB_{end}^{UL-SB,μ′}+2, . . . , RB_{end}^{UL-SB,μ′}+ ┌2^{μ-μ′}*RB_{size}^{GB1}┐) above the frequency axis of the determined UL subband. The UE may determine, as a first DL subband, RBs (RBₛₜₐᵣₜ^{UL-SB,μ′}−┌2^{μ-μ′}*RB_{size}^{GB1}┐−1, RBₛₜₐᵣₜ^{UL-SB,μ′}−┌2^{μ-μ′}*RB_{size}^{GB1}┐−1, . . . , RBₛₜₐᵣₜ^{DL-SB1,μ′}) below the frequency axis of the first guard band. The UE may determine, as a second DL subband, RBs (RB_{end}^{UL-SB,μ′}+┌2^{μ-μ′}*RB_{size}^{GB2}┐+1, RB_{end}^{UL-SB,μ′}+┌2^{μ-μ′}*RB_{size}^{GB2}┐+2, . . . , RB_{end}^{DL-SB2,μ′}) above the frequency axis of the second guard band.

Here, RB_{size}^{GB1} and RB_{size}^{GB2} are the numbers of RBs included in the first guard band and the second guard band, respectively, which are configured according to reference SCS (u).

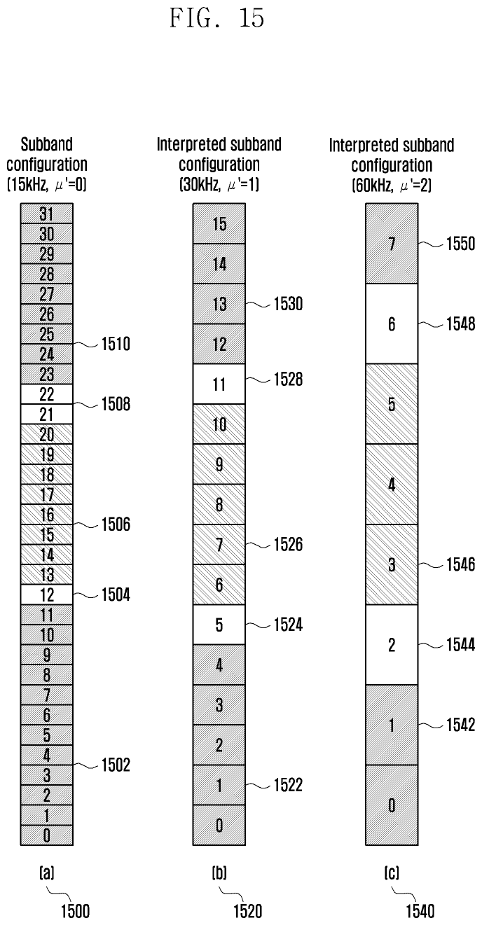

FIG. 15 illustrates examples of a UL subband, DL subbands, and guard bands interpreted based on CRBs of an SCS μ′ according to the guard band determination method and method 3 according to an embodiment.

Referring to FIG. 15, in configuration (a) 1500, it is assumed that a SCS of 15 kHz includes 32 CRBs (CRBs 0, 1, . . . , 31). It is also assumed 1520 that a SCS of 30 kHz includes 16 CRBs (CRBs 0, 1, . . . , 15). It is also assumed 1540 that an SCS of 60 kHz includes 8 CRBs (CRBs 0, 1, . . . , 7). A reference SCS is 15 kHz (μ′=0). Based on the SCS of 15 kHz, CRB 0 to CRB 11 are configured (RBₛₜₐᵣₜ^{DL-SB1,μ}=0, RB_{end}^{DL-SB1,μ}=11) as a first DL subband 1502, CRB 13 to CRB 20 are configured (RBₛₜₐᵣₜ^{UL-SB,μ}=13, RB_{end}^{UL-SB,μ}=20) as a UL subband 1506, and CRB 23 to CRB 31 are configured (RBₛₜₐᵣₜ^{DL-SB2,μ}=23, RB_{end}^{DL-SB2,μ}=31) as a second DL subband 1510. In addition, CRB 12 is configured as a first guard band (RBₛₜₐᵣₜ^{GB1,μ}=12, RB_{end}^{GB1,μ}=12) 1504, and CRB 21 and CRB 22 are configured as a second guard band (RBₛₜₐᵣₜ^{GB2,μ}=21, RB_{end}^{GB2,μ}=22) 1508 The number of RBs included in the first guard band is RB_{size}^{GB1,μ}=1, and the number of RBs included in the second guard band is RB_{size}^{GB2,μ}=2.

Referring to configuration (b) 1520, a UL subband, DL subbands, and guard bands interpreted based on the CRBs of the SCS of 30 kHz (μ′=1) are illustrated. When interpretation is performed based on the CRBs of SCS μ′=1 according to the guard band determination method and method 3, the UE may make determinations as follows.
A starting RB of a UL subband 1526 interpreted based on the CRBs of the SCS μ′=1 is RBₛₜₐᵣₜ^{UL-SB,μ′}=└2^{μ-μ′}*RBₛₜₐᵣₜ^{UL-SB,μ}┘=└13/2┘=6, and a last RB is RB_{end}^{UL-SB,μ′}=└2^{μ-μ′}*RB_{end}^{UL-SB,μ}┘=└20/2┘=10.
The number of RBs included in a first guard band (RBs between a first DL subband and the UL subband) interpreted based on the CRBs of the SCS μ′=1 may be ┌2^{μ-μ′}*RB_{size}^{GB1}┐=┌1/2┐=1. That is, 5 RBs (RBₛₜₐᵣₜ^{UL-SB,μ′}−1=5) may be included in the first guard band 1524.
The number of RBs included in a second guard band (e.g., RBs between a second DL subband and the UL subband) interpreted based on the CRBs of SCS μ′=1 may be ┌2^{μ-μ′}*RBₛₜₐᵣₜ^{UL-SB,μ}┐=1. That is, 11 RBs (RB_{end}^{UL-SB,μ′}+1=11) may be included in the second guard band 1528.
An index of a starting RB of the first DL subband 1522 interpreted based on the CRBs of the SCS μ′=1 may be RBₛₜₐᵣₜ^{DL-SB1,μ′}=└2^{μ-μ′}*RBₛₜₐᵣₜ^{DL-SB1,μ}┘=└0/2┘=0, and an index of a last RB may be RB_{end}^{DL-SB1,μ′}=RBₛₜₐᵣₜ^{UL-SB,μ′}−┌2^{μ-μ′}*RBₛₜₐᵣₜ^{UL-SB,μ}┐−1=6−1−1=4.
An index of a starting RB of the second DL subband 1530 interpreted based on the CRBs of the SCS μ′=1 may be RBₛₜₐᵣₜ^{DL-SB2,μ′}=RB_{end}^{UL-SB,μ′}+┌2^{μ-μ′}*RB_{size}^{GB2}┐+1=10+1+1=12, and an index of a last RB may be RB_{end}^{DL-SB2,μ′}=└2^{μ-μ′}*RB_{end}^{DL-SB2,μ}┘=└31/2┘=15.

Referring to configuration (c) 1540, a UL subband, DL subbands, and guard bands interpreted based on the CRBs of the SCS of 60 kHz (μ′=2) are illustrated. When interpretation is performed based on the CRBs of the SCS μ′=2 according to the guard band determination method and method 3, the UE may make determinations as follows.
A starting RB of a UL subband 1546 interpreted based on the CRBs of the SCS μ′=2 is RBₛₜₐᵣₜ^{UL-SB,μ′}=└2^{μ-μ′}*RBₛₜₐᵣₜ^{UL-SB,μ}┘=└13/4┘=3, and a last RB is RB_{end}^{UL-SB,μ′}=└2^{μ-μ′}*RB_{end}^{UL-SB,μ}┘=└20/4┘=5.
The number of RBs included in a second guard band (e.g., RBs between a second DL subband and the UL subband) interpreted based on the CRBs of the SCS μ′=2 may be ┌2^{μ-μ′}*RB_{size}^{GB1}┐=[1/4]=1. That is, 1 RBs (RBₛₜₐᵣₜ^{UL-SB,μ′}−1=2) may be included in the first guard band 1544.
The number of RBs included in a second guard band (e.g., RBs between a second DL subband and the UL subband) interpreted based on the CRBs of the SCS μ′=2 may be ┌2^{μ-μ′}*RB_{size}^{GB2}┐=[2/4]=1. That is, 6 RBs (RB_{end}^{UL-SB,μ′}+1=6) may be included in the second guard band 1548.
An index of a starting RB of the first DL subband 1542 interpreted based on the CRBs of the SCS μ′=2 may be RBₛₜₐᵣₜ^{DL-SB1,μ′}=└2^{μ-μ′}*RBₛₜₐᵣₜ^{DL-SB1,μ}┘=└0/4┘=0, and an index of a last RB may be RB_{end}^{DL-SB1,μ′}=RBₛₜₐᵣₜ^{UL-SB,μ′}−┌2^{μ-μ′}*RB_{size}^{GB1}┐−1=3−1−1=1.
An index of a starting RB of the second DL subband 1550 interpreted based on the CRBs of the SCS μ′=2 may be RBₛₜₐᵣₜ^{DL-SB2,μ′}=RB_{end}^{UL-SB,μ′}+┌2^{μ-μ′}*RB_{size}^{GB2}┐+1=5+1+1=7, and an index of a last RB may be RB_{end}^{DL-SB2,μ′}=└2^{μ-μ′}*RB_{end}^{DL-SB2,μ}┘=└31/4┘=7.

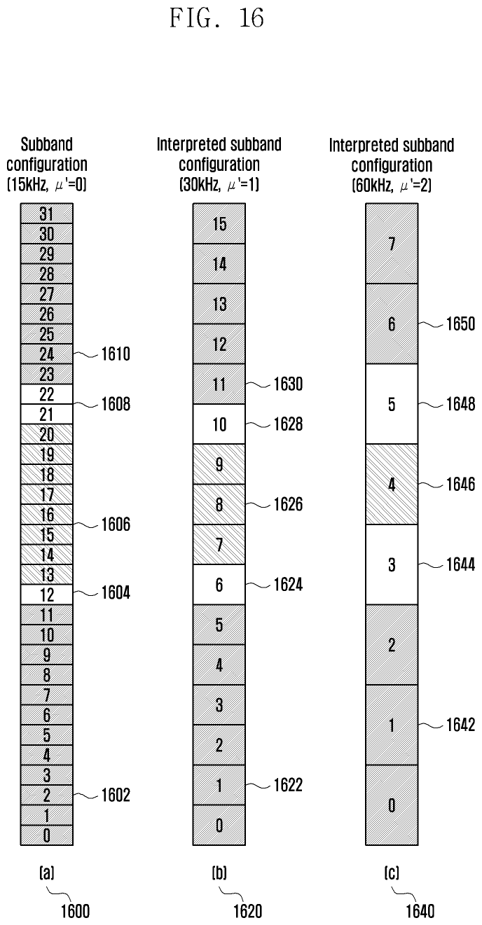

FIG. 16 illustrates examples of a UL subband, DL subbands, and guard bands interpreted based on CRBs of an SCS according to the guard band determination method and method 4 according to an embodiment.

Referring to FIG. 16, in configuration (a) 1600, it is assumed that an SCS of 15 kHz includes 32 CRBs (CRBs 0, 1, . . . , 31). It is also assumed 1620 that a SCS of 30 kHz includes 16 CRBs (CRBs 0, 1, . . . , 15). It is also assumed 1640 that a SCS of 60 kHz includes 8 CRBs (CRBs 0, 1, . . . , 7. A reference SCS is 15 kHz (μ=0). Based on the SCS of 15 kHz, CRB 0 to CRB 11 are configured (RBₛₜₐᵣₜ^{DL-SB1,μ}=0, RB_{end}^{DL-SB1,μ}=11) as a first DL subband 1602, CRB 13 to CRB 20 are configured (RBₛₜₐᵣₜ^{UL-SB,μ}=13, RB_{end}^{UL-SB,μ}=20) as a UL subband 1606, and CRB 23 to CRB 31 are configured (RBₛₜₐᵣₜ^{DL-SB2,μ}=23, RB_{end}^{DL-SB2,μ}=31) as a second DL subband 1610. In addition, CRB 12 is configured as a first guard band (RBₛₜₐᵣₜ^{GB1,μ}=12, RB_{end}^{GB1,μ}=12) 1604, and CRB 21 and CRB 22 are configured as a second guard band (RBₛₜₐᵣₜ^{GB2,μ}=21, RB_{end}^{GB2,μ}=22) 1608. The number of RBs included in the first guard band is RB_{size}^{GB1,μ}=1, and the number of RBs included in the second guard band is RB_{size}^{GB2,μ}=2.

Referring to configuration (b) 1620, a UL subband, DL subbands, and guard bands interpreted based on the CRBs of the SCS of 30 kHz (μ′=1) are illustrated. When interpretation is performed based on the CRBs of the SCS μ′=1 according to the guard band determination method and method 4, the UE may make determinations as follows.
A starting RB of a UL subband 1626 interpreted based on the CRBs of the SCS μ′=1 is RBₛₜₐᵣₜ^{UL-SB,μ′}=└2^{μ-μ′}*(RBₛₜₐᵣₜ^{UL-SB,μ}−1)┘+1=└(13−1)/2┘+1=7, and a last RB is RB_{end}^{UL-SB,μ′}=└2^{μ-μ′}*(RB_{end}^{UL-SB,μ}+1)┘−1=└(20+1)/2┘−1=9.
The number of RBs included in a first guard band (e.g., RBs between a first DL subband and the UL subband) interpreted based on the CRBs of the SCS μ′=1 may be ┌2^{μ-μ′}*RB_{size}^{GB1}┐=┌1/2┐=1. That is, 6 RBs (RBₛₜₐᵣₜ^{UL-SB,μ′}−1=6) may be included in the first guard band 1624.
The number of RBs included in a second guard band (e.g., RBs between a second DL subband and the UL subband) interpreted based on the CRBs of the SCS μ′=1 may be ┌2^{μ-μ′}*RB_{size}^{GB2}┐=┌2/2┐=1. That is, 10 RBs (RB_{end}^{UL-SB,μ′}−1=10) may be included in the second guard band 1628.
An index of a starting RB of the first DL subband 1622 interpreted based on the CRBs of the SCS μ′=1 may be RBₛₜₐᵣₜ^{DL-SB1,μ′}=└2^{μ-μ′}*(RBₛₜₐᵣₜ^{DL-SB1,μ}−1)┘+1=└(0−1)/2┘+1=0, and an index of a last RB may be RB_{end}^{DL-SB1,μ′}=RBₛₜₐᵣₜ^{UL-SB,μ′}−┌2^{μ-μ′}*RB_{size}^{GB1}┐−1=7−1−1=5.
An index of a starting RB of the second DL subband 1630 interpreted based on the CRBs of the SCS μ′=1 may be RBₛₜₐᵣₜ^{DL-SB2,μ′}=RB_{end}^{UL-SB,μ′}+┌2^{μ-μ′}*RB_{size}^{GB2}┐+1=9+1+1=11, and an index of a last RB may be RB_{end}^{DL-SB2,μ′}=└2^{μ-μ′}*(RB_{end}^{DL-SB2,μ}+1)┘−1=└(31+1)/2┘−1=15.

Referring to configuration (c) 1640, a UL subband, DL subbands, and guard bands interpreted based on the CRBs of the SCS of 60 kHz (μ′=2) are illustrated. When interpretation is performed based on the CRBs of the SCS μ′=2 according to the guard band determination method and method 4, the UE may make determinations as follows.
A starting RB of a UL subband 1646 interpreted based on the CRBs of the SCS μ′=2 is RBₛₜₐᵣₜ^{UL-SB,μ′}=└2^{μ-μ′}*(RBₛₜₐᵣₜ^{UL-SB,μ}−1)┘+1=└13−1)/4┘+1=4, and a last RB is RB_{end}^{UL-SB,μ′}=└2^{μ-μ′}*(RB_{end}^{UL-SB,μ}−1)┘−1=└(20+1)/4┘−1=4.
The number of RBs included in a first guard band (e.g., RBs between a first DL subband and the UL subband) interpreted based on the CRBs of the SCS μ′=2 may be ┌2^{μ-μ′}*RB_{size}^{GB1}┐=┌1/4┐=1. That is, 3 RBs (RB_{end}^{UL-SB,μ′}−1=3) may be included in the first guard band 1644.
The number of RBs included in a second guard band (e.g., RBs between a second DL subband and the UL subband) interpreted based on the CRBs of the SCS μ′=2 may be ┌2^{μ-μ′}*RB_{size}^{GB2}┐=┌2/4┐=1. That is, 5 RBs (RB_{end}^{UL-SB,μ′}−1=5) may be included in the second guard band 1648.
An index of a starting RB of the first DL subband 1642 interpreted based on the CRBs of the SCS μ′=2 may be RBₛₜₐᵣₜ^{DL-SB1,μ′}=└2^{μ-μ′}*(RBₛₜₐᵣₜ^{DL-SB1,μ}−1)┘+1=└(0−1)/4┘+1=0, and an index of a last RB may be RB_{end}^{DL-SB1,μ′}=RBₛₜₐᵣₜ^{UL-SB,μ′}−┌2^{μ-μ′}*RB_{size}^{GB1}┐−1=4−1−1=2.
An index of a starting RB of the second DL subband 1650 interpreted based on the CRBs of the SCS μ′=2 may be RBₛₜₐᵣₜ^{DL-SB2,μ′}=RB_{end}^{UL-SB,μ}′+┌2^{μ-μ′}*RB_{size}^{GB2}┐+1=4+1+1=6, and an index of a last RB may be └2^{μ-μ′}*(RB_{end}^{DL-SB2,μ}+1)┘−1=└(31+1)/4┘−1=15.

In the aforementioned embodiments of the disclosure, the start RBs of the first DL subbands and the last RBs of the second DL subbands corresponding to the respective SCSs may be determined without separate signaling. More specifically, the UE may be configured with an OffsetToCarrier value (A) and a carrierBandwidth value (B) corresponding to each SCS from the base station. The UE may assume A as the start RB index of the first DL subband in each SCS. The UE may assume A+B as the last RB index of the second DL subband in each SCS. For example, if the last RB index of the first DL subband determined in each SCS is smaller than A, the UE may consider that there is no first DL subband. If the start RB index of the second DL subband determined in each SCS is greater than A+B, the UE may consider that there is no second DL subband.

In accordance with an embodiment of the disclosure, SBFD frequency axis configuration information may be provided to a UE as follows.

A UE attempting initial cell access may receive a configuration of initial DL BWP and initial UL BWP via an SIB. The UE may consider a specific SCS as the SCSs of the initial DL BWP and the initial UL BWP. The UE may be configured with a DL subband, a UL subband, and a guard band, based on the specific SCS. The DL subband, UL subband, and guard band may be valid only in the initial DL BWP and the initial UL BWP.

The UE may receive information for an RRC connection (RRC configuration information) from a base station. In this case, the UE may be configured with BWPs other than the initial DL BWP and the initial UL BWP. When the UE is configured with the BWPs, the UE may consider that the SCSs of the BWPs are the specific SCS. The UE may be configured with DL subbands, UL subbands, and guard bands for the BWPs, based on the specific SCS. The DL subbands, UL subbands, and guard bands may be valid when the BWPs are activated, and may not be applied to other BWPs. Alternatively, the DL subbands, UL subbands, and guard bands may be valid when a BWP with the same SCS as the BWPs is activated, and may not be valid when a BWP with a different SCS is activated. That is, the DL subbands, UL subbands, and guard bands may be configured for respective SCSs.

According to an embodiment, the UE may receive, from the SIB, a configuration of DL subband, UL subband, and guard band to be used for initial cell access. Therefore, information included in the SIB may be reduced, and this may improve reception performance of the SIB. In addition, the RRC connected UE may receive additional DL subband, UL subband, and guard band configurations during an RRC configuration operation. When activating a BWP other than the initial BWP, the RRC connected UE may use the DL subband, the UL subband, and guard band.

According to an embodiment, the UE may receive, from the SIB, a configuration of DL subband, UL subband, and guard band of the first cell to be used for initial cell access, and may receive, from the RRC configuration information, a configuration of DL subband, UL subband, and guard band of the second cell. Here, the configuration of DL subband, UL subband, and guard band of the first cell may be cell-common and a configuration of DL subband, UL subband, and guard band of the second cell may be UE-specific.

A task to be achieved in the disclosure may be associated with frequency axis configuration information (e.g., SBFD frequency axis configuration information) for an SBFD operation for a UE. More specifically, the disclosure relates to a method of configuring a UL subband, a DL subband, and a guard band for a UE according to a reference SCS.

The UE may be configured with one UL subband, up to two DL subbands, and up to two guard bands. A guard band between the lower end on the frequency axis (e.g., interchangeable with lower frequency end) of a UL subband and the upper end on the frequency axis (interchangeable with upper frequency end) of a first DL subband may be referred to as a first guard band, and a guard band between the upper end on the frequency axis of the UL subband and the lower end on the frequency axis of a second DL subband may be referred to as a second guard band.

In the following description, RB indexes of the frequency domain of the UE are based on CRBs corresponding to a reference SCS. For example, the UE may be configured with an offsetToCarrier value (A) corresponding to the reference SCS. In this case, a start RB of an RB interpreted by the UE corresponds to an RB indicated by offsetToCarrier, that is, RB0 interpreted by the UE may correspond to CRB A. For convenience of description, the offsetToCarrier value (A) is assumed to be 0.

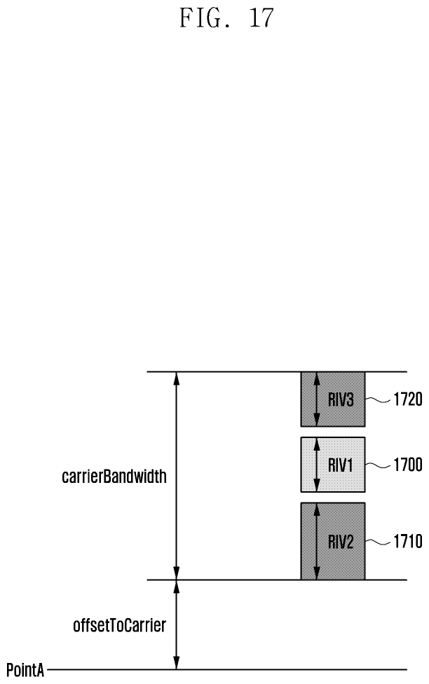

FIG. 17 illustrates an example of a frequency axis configuration for an SBFD operation according to an embodiment.

Referring to FIG. 17, frequency axis configuration information for an SBFD operation may include the following.
Information (i.e., resource indication value 1 (RIV1)) 1700 on a UL subband may indicate a start index of RBs included in the UL subband among CRBs determined according to a reference SCS and the number of included RBs. The start index and the number of RBs may be jointly coded and included in the form of an RIV. A specific joint coding method will be described later.
Information (RIV2) 1710 on a first DL subband may indicate a start index of RBs included in the first DL subband among the CRBs determined according to the reference SCS and the number of included RBs. The start index and the number of RBs may be jointly coded and included in the form of RIV. A specific joint coding method will be described later.
Information (RIV3) 1720 on a second DL subband may indicate a start index of RBs included in the second DL subband among the CRBs determined according to the reference SCS and the number of included RBs. The start index and the number of RBs may be jointly coded and included in the form of RIV. A specific joint coding method will be described later.

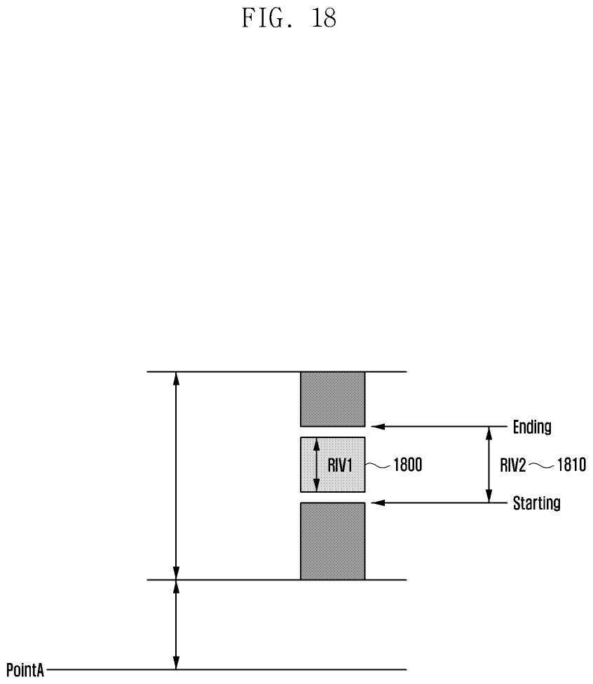

FIG. 18 illustrates an example of a frequency axis configuration for an SBFD operation according to an embodiment.

Referring to FIG. 18, frequency axis configuration information for an SBFD operation may include the following.
Information (RIV1) 1800 on a UL subband may indicate a start index of RBs included in the UL subband among CRBs determined according to a reference SCS and the number of included RBs. The start index and the number of RBs may be jointly coded and included in the form of an RIV. A specific joint coding method will be described later.
Information (RIV2) on a first DL subband and a second DL subband 1810 may include an index of a last RB of RBs included in the first DL subband and an index of a start RB of RBs included in the second DL subband among the CRBs determined according to the reference SCS. The last RB of the RBs included in the first DL subband may be considered as a start RB, and (the index of the start RB of the RBs included in the second DL subband—the index of the last RB of the RBs included in the first DL subband+1) may be considered as the number of consecutive RBs, so that the two numbers may be jointly coded and included in the form of RIV.

The start index (RBₛₜₐᵣₜ) and the number (L_{RBs}) of RBs may be jointly coded and expressed in the form of RIV as shown in Table 15 below. Here, N_{BWP}^{size}=275 may be assumed.

```
TABLE 15
  if (L_{RBs} − 1) ≤ └N_{BWP}^{size}/2┘ then
      RIV = N_{BWP}^{size}(L_{RBs} − 1) + RBₛₜₐᵣₜ
  else
    RIV = N_{BWP}^{size}(N_{BWP}^{size} − L_{RBs} + 1) + (N_{BWP}^{size} − 1 − RBₛₜₐᵣₜ)
whereL_{RBs}≥ 1 and shall not exceed N_{BWP}^{size} − RBₛₜₐᵣₜ.
```

In FIG. 18, frequency axis configuration information for the SBFD operation may include the following.
Information (RIV1) 1800 on the UL subband may indicate the start index of RBs included in the UL subband among CRBs determined according to the reference SCS and the number of included RBs. The start index and the number of RBs may be jointly coded and included in the form of RIV. A specific joint coding method will be described below.
The number of RBs included in the first DL subband may be indicated. Here, the start RB of the first DL subband may be RB0 interpreted by a UE (or an RB indicated by offsetToCarrier, i.e., a CRB having an index of offsetToCarrier), and the RBs included in the first DL subband may be as many RBs as the number indicated in ascending order of frequency axis from the start RB. If the number of RBs is not indicated, or 0 is indicated, the UE may determine that there is no first DL subband.
The number of RBs included in the second DL subband may be indicated according to a first or second method below.

In a first method, a last RB of the second DL subband may be a last RB of a bandwidth indicated by carrierBandwidth from the RB indicated by offsetToCarrier, i.e., a CRB having an index of offsetToCarrier+carrierBandwidth−1, and the RBs included in the second DL subband may be as many RBs as the number indicated in descending order of frequency axis from the last RB.

In a second method, the last RB of the second DL subband may be a CRB having an index of offsetToCarrier+275−1, and the RBs included in the second DL subband may be as many RBs as the number indicated in descending order of frequency axis from the last RB. When compared to the first method, a carrierBandwidth value is used in the first method, while a value of 275 is used instead of the carrierBandwidth value in the second method.

The UE may interpret frequency axis configuration information for the SBFD operation by using the signaling method in Table 16. For example, the UE may receive a combination value of r generated according to Table 16, and may identify k₀, k₁ or k₀, k₁, k₂ indicated according to Table 17 or 18 below. Tables 16 to 18 below are merely examples, and it is also possible that other k₀, k₁, . . . , k_{N-1} values correspond to the r value.

TABLE 16

For a given M, frequency indication of subbands is indicated by a combinatorial index
$r corresponding to the N indexes {\{ {k}_{i} \}}_{i = 0}^{N - 1} ( 0 \leq {k}_{i} \leq M - 1 , {k}_{i} < {k}_{i + 1} ) , where r is$
$given by the equation r = {\sum }_{i = 0}^{N - 1} 〈 \begin{matrix}M - {k}_{i} - 1 \\ N - i\end{matrix} 〉 , where 〈 \begin{matrix}x \\ y\end{matrix} 〉 = \{ \begin{matrix}( \begin{matrix}x \\ y\end{matrix} ) & x \geq y \\ 0 & x < y\end{matrix} , is the$
$extended binomial coefficient , resulting in unique label r ∈ \{ 0 , … , ( \begin{matrix}M \\ N\end{matrix} ) - 1 \} .$

Referring to Table 16, N indexes {k₀, k₁, . . . , k_{N-1}} are non-negative integers and satisfy a condition of 0≤k₀<k₁< . . . <k_{N-1}≤M−1. In addition, the N indexes {k₀, k₁, . . . , k_{N-1}} may be represented by a unique combinational index of r. Tables 17 and 18 show unique combinational values of the N indexes for M=4 and N=2 and for M=4 and N=3, respectively.

Referring to Table 17, there may be 6 combinations that {k₀, k₁} may have: {0,1}, {0,2}, {0,3}, {1,2}, {1,3}, {2,3}. These combinations may correspond to unique combination values of 0, 1, . . . , 5.

Referring to Table 18, there may be 4 combinations that {k₀, k₁, k₂} may have: {0,1,2}, {0,1,3}, {0,2,3}, {1,2,3}. These combinations may correspond to unique combination values of 0, 1, . . . , 3.

TABLE 17

| | r (combinatorial index) |
|---|---|
| M = 4, N = 2 | r = < 3-k₀, 2> + <3-k₁, 1> |
| {k₀, k₁} = {0, 1} | r = < 3, 2> + <2, 1> = (3, 2) + (2, 1) = 3 + 2 = 5 |
| {k₀, k₁} = {0, 2} | r = < 3, 2> + <1, 1> = (3, 2) + (1, 1) = 3 + 1 = 4 |
| {k₀, k₁} = {0, 3} | r = < 3, 2> + <0, 1> = (3, 2) + 0 = 3 + 0 = 3 |
| {k₀, k₁} = {1, 2} | r = < 2, 2> + <1, 1> = (2, 2) + (1, 1) = 1 + 1 = 2 |
| {k₀, k₁} = {1, 3} | r = < 2, 2> + <0, 1> = (2, 2) + 0 = 1 + 0 = 1 |
| {k₀, k₁} = {2, 3} | r = < 1, 2> + <0, 1> = 0 + 0 = 0 |

TABLE 18

| | r (combinatorial index) |
|---|---|
| M = 4, N = 3 | r = < 3-k₀, 3> + <3-k₁, 2> + <3-k₂, 1> |
| {k₀, k₁, k₂} = {0, 1, 2} | r = < 3, 3> + <2, 2> + <1, 1> = (3, 3) + |
| | (2, 2) + (1, 1) = 3 |
| {k₀, k₁, k₂} = {0, 1, 3} | r = < 3, 3> + <2, 2> + <0, 1> = (3, 3) + |
| | (2, 2) + 0 = 2 |
| {k₀, k₁, k₂} = {0, 2, 3} | r = < 3, 3> + <1, 2> + <0, 1> = (3, 2) + |
| | 0 = 3 + 0 = 1 |
| {k₀, k₁, k₂} = {1, 2, 3} | r = < 2, 3> + <1, 2> + <0, 1> = 0 |

Unless otherwise specified in the following description, an RB with index 0 may be a CRB with index 0 (CRB 0), or an RB with index 0 may be a CRB with an index of offsetToCarrier. Here, offsetToCarrier may be configured in a higher-layer signal.

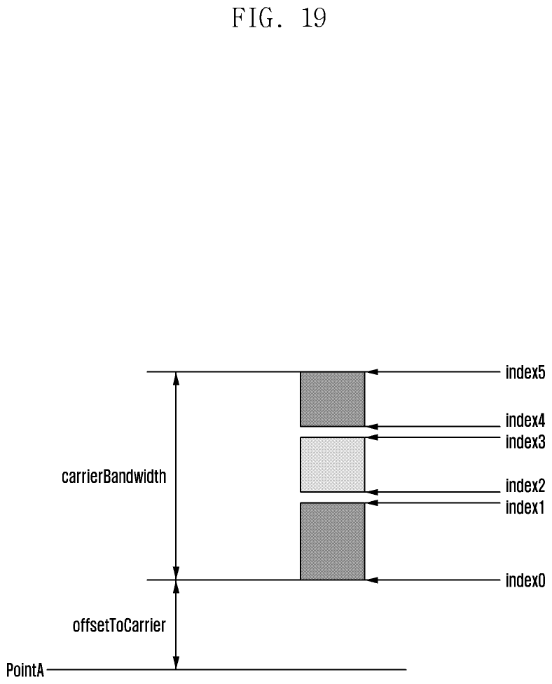

FIG. 19 illustrates an example of a frequency axis configuration for an SBFD operation according to an embodiment.

Referring to FIG. 19, frequency axis configuration information for an SBFD operation for a UE may include the following.
Six indexes (index0, index1, index2, index3, index4, and index5) may be jointly coded. The six indexes may be a start RB index (index0) of a first DL subband, a last RB index (index1) of the first DL subband, a start RB index (index2) of an UL subband, a last RB index (index3) of the UL subband, a start RB index (index4) of a second DL subband, and a last RB index (index5) of the second DL subband. This information is merely an example, and multiple RB indexes among the RB indexes described above may be jointly coded.

Table 19 is an example of a method of jointly coding the six indexes. The six indexes (N=6) (index0, index1, index2, index3, index4, and index5) may be converted to k0, k1, . . . , k5 and jointly coded. Here, k0<k1< . . . <k5 may be satisfied. The relationship between jointly coded k0, k1, . . . , k5 and index0, index1, . . . , index5 may be as follows.
index0=k0, index1=k1, index2=k2, index3=k3, index4=k4, index5=k5

In Table 19, a value configured via a higher-layer signal of carrierBandwidth or a value of 273 or 275 may be used for M.

Referring to Table 19, the UE is always configured with the first DL subband (e.g., index k0 of the start RB and index k1 of the last RB) and the second DL subband (e.g., index k4 of the start RB and index k5 of the last RB) from a base station. In other words, the UE cannot be configured with only one DL subband from the base station.

To address this, the UE may determine that no first DL subband has been configured if k0 and k1 values corresponding to the first DL subband have a specific combination. For example, if k0=0 and k1=1, the UE may determine that no first DL subband has been configured. For example, if k1−k0 or k1−k0+1 has a value smaller than a certain value (i.e., the number of RBs included in the first DL subband is less than the certain value), the UE may determine that no first DL subband has been configured.

The UE may determine that no second DL subband has been configured if k4 and k5 values corresponding to the second DL subband have a specific combination. For example, if k4=M−2 and k5=M−1, the UE may determine that no second DL subband has been configured. For example, if k5−k4 or k5−k4+1 has a value smaller than a certain value (i.e., the number of RBs included in the second DL subband is less than the certain value), the UE may determine that no second DL subband has been configured.

TABLE 19
For a given M, frequency indication of subbands is indicated by a combinatorial index
$r corresponding to the N = 6 indexes {\{ {k}_{i} \}}_{i = 0}^{N - 1} ( 0 \leq {k}_{i} \leq M - 1 , {k}_{i} < {k}_{i + 1} ) , where$
$r is given by the equation r = {\sum }_{i = 0}^{N - 1} 〈 \begin{matrix}M - {k}_{i} - 1 \\ N - i\end{matrix} 〉 , where 〈 \begin{matrix}x \\ y\end{matrix} 〉 = \{ \begin{matrix}( \begin{matrix}x \\ y\end{matrix} ) & x \geq y \\ 0 & x < y\end{matrix} , is the$
$extended binomial coefficient , resulting in unique label r ∈ \{ 0 , … , ( \begin{matrix}M \\ N\end{matrix} ) - 1 \} .$

| | |
|---|---|
| • | The first DL subband is started from PRB of index k0 and ended at PRB of |
| | index k1. |
| • | The second DL subband is started from PRB of index k4 and ended at PRB of |
| | index k5. |

The UL subband is started from PRB of index k2 and ended at PRB of index k3

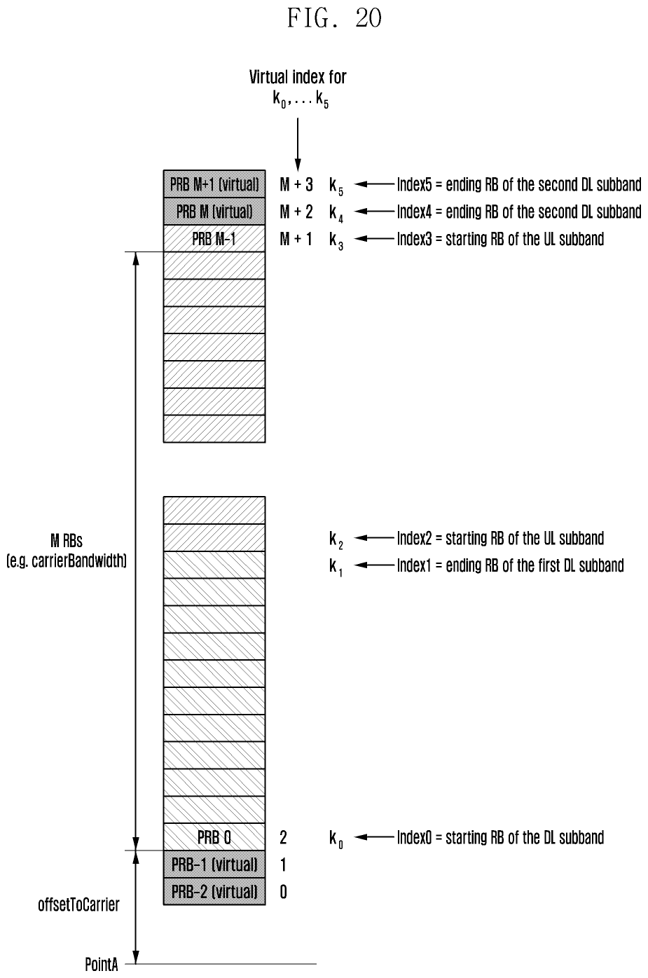

FIG. 20 illustrates an example of a method of adding virtual RBs to a frequency band where a DL subband and an UL subband are located according to an embodiment.

Referring to FIG. 20, a UE may add four virtual RBs in addition to M RBs. Here, two of the four virtual RBs may be added to the bottom of the frequency axis, and the remaining two may be added to the top of the frequency axis. Indexes of the M RBs may be 0, 1, . . . , M−1, indexes of the two virtual RBs at the bottom of the frequency axis may be −2 and −1, and indexes of the two virtual RBs at the top of the frequency axis may be M and M+1.

The UE may determine a unique combination value by changing a value of M, which is the number of RBs, to a value of M+4. In addition, a start RB index of a first DL subband may be index0=k0−2, a last RB index of the first DL subband may be index1=k1−2, a start RB index of a UL subband may be index2=k2−2, a last RB index of the UL subband may be index3=k3−2, a start RB index of a second DL subband may be index4=k4−2, and a last RB index of the second DL subband may be index5=k5−2. Here, due to the two RBs added to the bottom of the frequency axis, an offset of 2 has been applied to the start RB index and last RB index of the UL subband and the start RB index and last RB index of the second DL subband.

For example, if k0=0 and k1=1 are indicated (index0=−2 and index1=−1), it may be determined that no first DL subband has been configured. This is because the start RB and last RB of the first DL subband are located in the virtual RBs. If k4=M+2 and k5=M+3 are indicated (index4=M and index5=M+1), it may be determined that no second DL subband has been configured. This is because the start RB and last RB of the second DL subband are located in the virtual RBs.

Table 20 is an example of a method of jointly coding six indexes. The six indexes (index0, index1, index2, index3, index4, and index5) may be converted to k0, k1, . . . , k5 and jointly coded. Here, k0<k1< . . . <k5 may be satisfied. The relationship between jointly coded k0, k1, . . . , k5 and index0, index1, . . . , index5 may be as follows.
index0=k0−2, index1=k1−2, index2=k2−2, index3=k3−2, index4=k4−2, index5=k5−2

In this case, if index0=−2 (k0=0) and index1=−1 (k1=1), it may be determined that no first DL subband has been configured.

In this case, if index4=k4−2 and index5=k5−2 are greater than or equal to M (i.e., k4=M and k5=M+1), it may be determined that no second DL subband has been configured.

Here, a value configured via a higher-layer signal of carrierBandwidth or a value of 273 or 275 may be used for M.

TABLE 20
For a given M and M′ = M + 4, frequency indication of subbands is indicated by a combinatorial index
$r corresponding to the N = 6 indexes {\{ {k}_{i} \}}_{i = 0}^{N - 1} ( 0 \leq {k}_{i} - 1 \leq {M}^{′} - 1 , {k}_{i} < {k}_{i + 1} ) ,$
$where r is given by the equation r = {\sum }_{i = 0}^{N - 1} 〈 \begin{matrix}{M}^{′} - {k}_{i} - 1 \\ N - i\end{matrix} 〉 ,$
$where 〈 \begin{matrix}x \\ y\end{matrix} 〉 = \{ \begin{matrix}( \begin{matrix}x \\ y\end{matrix} ) & x \geq y \\ 0 & x < y\end{matrix} , is the extended binomial coefficient , resulting in unique$
$label r ∈ \{ 0 , … , ( \begin{matrix}{M}^{′} \\ N\end{matrix} ) - 1 \} .$

| | |
|---|---|
| • | The first DL subband is started from PRB of index k₀ − 2 and ended at PRB |
| | of index k₁ − 2. If k₀ = 0, k₁ = 1, there is no first DL subband. |
| • | The second DL subband is started from PRB of index k₄ − 2 and ended at |
| | PRB of index k₅ − 2 If k₄ = M, k₅ = M + 1, there is no second DL subband |
| • | The UL subband is started from PRB of index k₂ − 2 and ended at PRB of |
| | index k₃ − 2. |

Frequency axis configuration information configured for the UE for an SBFD operation may include the following.
Four indexes (index1, index2, index3, and index4) may be jointly coded. The four indexes may be a last RB index (index1) of a first DL subband, a start RB index (index2) of a UL subband, a last RB index (index3) of the UL subband, and a start RB index (index4) of a second DL subband. In this case, a start RB index (index0) of the first DL subband may correspond to RB0 interpreted by the UE (or an RB indicated by offsetToCarrier, i.e., a CRB having an index of offsetToCarrier), and a last RB index (index5) of the second DL subband may correspond to a last RB of a bandwidth indicated by carrierBandwidth from the RB indicated by offsetToCarrier, i.e., a CRB having an index of offsetToCarrier+carrierBandwidth−1.

Table 21 is an example of a method of jointly coding four indexes. The four indexes (N=4) (index1, index2, index3, and index4) may be converted to k₀, k₁, k₂, and k₃, and jointly coded. Here, k0<k1<k2<k3 may be satisfied. The relationship between jointly coded k₀, k₁, k₂, and k₃ and index0, index1, . . . , index4 may be as follows.
index 1=k₀, index2=k₁, index3=k₂, index4=k₃

In Table 21, a value configured via a higher-layer signal of carrierBandwidth or a value of 273 or 275 may be used for M.

Referring to Table 21, the UE is always configured with the first DL subband (the start RB index is the RB indicated by offsetToCarrier, and the last RB index is k₀) and the second DL subband (the start RB index is k3, and the last RB index is the last RB of the bandwidth indicated by carrierBandwidth from the RB indicated by offsetToCarrier) from a base station. In other words, the UE cannot be configured with only one DL subband from the base station.

To address this, the UE may determine that no first DL subband has been configured if a value of k₀ corresponding to the first DL subband has a specific value. For example, if k-₀=0, the UE may determine that no first DL subband has been configured.

The UE may determine that no second DL subband has been configured if a value of k3 corresponding to the second DL subband has a specific combination. For example, if k3=M−1, the UE may determine that no second DL subband has been configured.

TABLE 21
For a given M, frequency indication of subbands is indicated by a combinatorial index
$r corresponding to the N = 6 indexes {\{ {k}_{i} \}}_{i = 0}^{N - 1} ( 0 \leq {k}_{i} \leq M - 1 , {k}_{i} < {k}_{i + 1} ) , where$
$r is given by the equation r = {\sum }_{i = 0}^{N - 1} 〈 \begin{matrix}M - {k}_{i} - 1 \\ N - i\end{matrix} 〉 , where 〈 \begin{matrix}x \\ y\end{matrix} 〉 = \{ \begin{matrix}( \begin{matrix}x \\ y\end{matrix} ) & x \geq y \\ 0 & x < y\end{matrix} , is the$
$extended binomial coefficient , resulting in unique label r ∈ \{ 0 , … , ( \begin{matrix}M \\ N\end{matrix} ) - 1 \} .$

| | |
|---|---|
| • | The first DL subband is started from PRB of index k0 and ended at PRB of |
| | index k1. |
| • | The second DL subband is started from PRB of index k4 and ended at PRB of |
| | index k5. |
| • | The UL subband is started from PRB of index k2 and ended at PRB of index |
| | k3 |

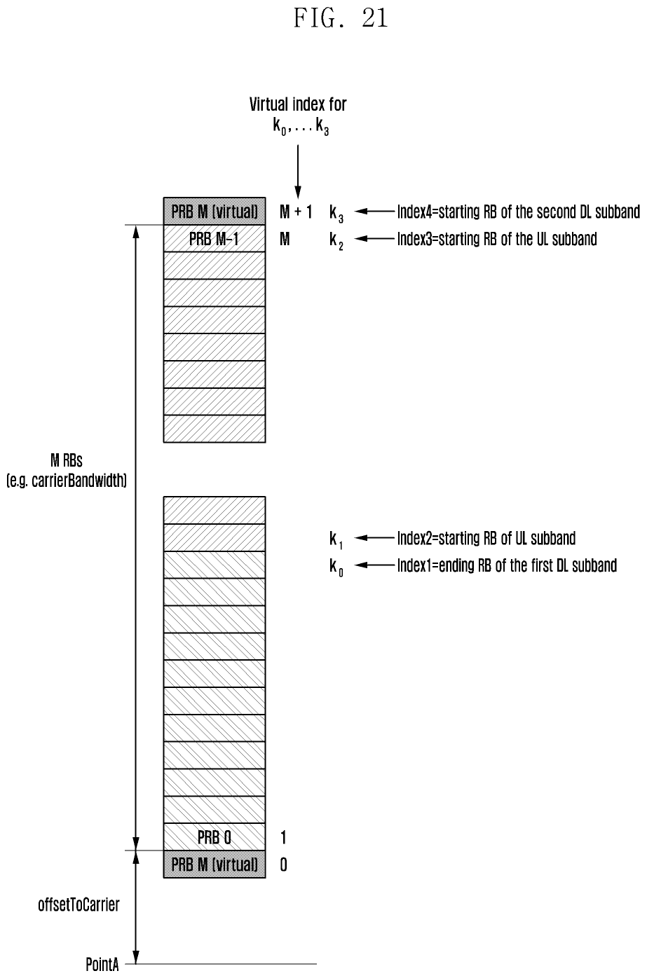

FIG. 21 illustrates an example of a method of adding virtual RBs to a frequency band where a DL subband and an UL subband are located according to an embodiment.

Referring to FIG. 21, a UE may add two virtual RBs in addition to M RBs. Here, one of the two virtual RBs may be added to the bottom of the frequency axis, and the remaining one may be added to the top of the frequency axis. Indexes of the M RBs may be 0, 1, . . . , M−1, an index of one virtual RB at the bottom of the frequency axis may be −1, and an index of one virtual RB at the top of the frequency axis may be M.

The UE may determine a unique combination value by changing a value of M to M+2. In addition, a start RB index of a first DL subband may be an RB indicated by offsetToCarrier, a last RB index of the first DL subband may be index1=k₀−1, a start RB index of a UL subband may be index2=k₁−1, a last RB index of the UL subband may be index3=k₂−1, a start RB index of a second DL subband may be index4=k₃−1, and a last RB index of the second DL subband may be a last RB of a bandwidth indicated by carrierBandwidth from the RB indicated by offsetToCarrier. Here, due to the one RB added to the bottom of the frequency axis, an offset of 1 has been applied to the start RB index and last RB index of the UL subband and the start RB index and last RB index of the second DL subband.

For example, if k₀=0 is indicated (index1=−1), it may be determined that no first DL subband has been configured. This is because the last RB of the first DL subband is located in the virtual RB. For example, if k3=M+1 is indicated (index4=M), it may be determined that no second DL subband has been configured. This is because the start RB of the second DL subband is located in the virtual RB.

Table 22 is an example of a method of jointly coding four indexes. The four indexes (index1, index2, index3, and index4) may be converted to k₀, k₁, k₂, and k₃ and jointly coded. Here, k₀<k₁<k₂<k₃ may be satisfied. The relationship between jointly coded k₀, k₁, . . . , k₃ and index0, index1, . . . , index4 may be as follows.
Index1=k₀−1, index2=k₁−1, index3=k₂−1, index4=k₃−1

If index1=−1 (k₀=0), it may be determined that no first DL subband has been configured.

If index4=k₃−1 is greater than or equal to M, it may be determined that no second DL subband has been configured.

Here, a value configured via a higher-layer signal of carrierBandwidth or a value of 273 or 275 may be used for M.

TABLE 22
For a given M and M′ = M + 2, frequency indication of subbands is indicated by a combinatorial index
$r corresponding to the N = 4 indexes {\{ {k}_{i} \}}_{i = 0}^{N - 1} ( 0 \leq {k}_{i} - 1 \leq {M}^{′} - 1 , {k}_{i} < {k}_{i + 1} ) ,$
$w here r is given by the equation r = {\sum }_{i = 0}^{N - 1} 〈 \begin{matrix}{M}^{′} - {k}_{i} - 1 \\ N - i\end{matrix} 〉 , where$
$〈 \begin{matrix}x \\ y\end{matrix} 〉 = \{ \begin{matrix}( \begin{matrix}x \\ y\end{matrix} ) & x \geq y \\ 0 & x < y\end{matrix} , is the extended binomial coefficient , resulting in unique label$
$r ∈ \{ 0 , … , ( \begin{matrix}{M}^{′} \\ N\end{matrix} ) - 1 \} .$

| | |
|---|---|
| • | The first DL subband is started from the lowest usable PRB (PRB0 (PointA + |
| | offsetToCarrier)) and ended at PRB of index k0 − 1 if k0 ≥ 1. If k0 = 0, |
| | there is no first DL subband. |
| • | The second DL subband is started from PRB of index k3 − 1 and ended at the |
| | last PRB within carrier bandwidth (PointA + offsetToCarrier + |
| | carrierBandwidth) if k3 ≤ carrierBandwidth. If k3 > carrierBandwith, |
| | there is no second DL subband. |
| | The UL subband is started from PRB of index k1 − 1 and ended at PRB of index |
| | k2 − 1 |

The UE may report a size of a guard band for an SBFD operation to a base station. The base station may configure a guard band for the UE, based on the size of the guard band. The UE may determine a DL subband or a UL subband by applying the guard band configured by the base station.

The guard band configuration may be different for each UE. This guard band configuration may be referred to as a UE-specific guard band. The UE may be configured with the UE-specific guard band based on an RRC signal from the base station. In addition, the UE may be configured with multiple candidate values via the RRC signal from the base station, and one of the multiple candidate values may be indicated via a MAC-CE signal. In addition, the base station may change some or all of the multiple candidate values via the MAC-CE signal transmitted to the UE.

The UE may report a size of a guard band for an SBFD operation to the base station as follows. Here, a size of a guard band may be at least one of the number of RBs, the number of subcarriers, or an absolute frequency bandwidth (KHz or MHz) unit. For convenience, in the following description, the number of RBs is expressed, but this may be replaced with the number of subcarriers or an absolute frequency bandwidth unit, and then applied.

In the following description, the number of RBs or the number of subcarriers may include a corresponding SCS. That is, when the UE reports the number of RBs or the number of subcarriers as a size of a guard band, a corresponding SCS may be included in the report.

When the UE reports a size of a guard band, the UE may report a size of a guard band corresponding to each of multiple SCSs. For example, the report of the UE may include a first guard band size corresponding to a SCS of 15 kHz and a second guard band size corresponding to a SCS of 30 kHz.

Here, the UE may include, in the report, only guard band sizes corresponding to SCSs supported by the base station. More specifically, the UE may receive an SIB from the base station. The UE may acquire, from the SIB, the SCSs supported by the base station. For example, the SCSs supported by the base station may be acquired via SubCarrierSpacing of an SCS-SpecificCarrier information element (IE). The UE may report guard bands corresponding to the SCSs. In this case, the SCSs may not be included in the report. For example, the UE may report guard band sizes (e.g., a first size and a second size) to the base station, in which case, a first reported value (i.e., the first size) may be a guard band size corresponding to a smallest SCS (e.g., 15 kHz SCS when 15 kHz SCS and 30 kHz SCS are supported) among the SCSs supported by the base station, and a second reported value (i.e., the second size) may be a guard band size corresponding to a second smallest SCS (e.g., 30 kHz SCS when 15 kHz SCS and 30 kHz SCS are supported) among the SCSs supported by the base station.

Alternatively/in addition, according to the disclosure, the UE may report guard band sizes to the base station according to a modulation order (Qₘ). The UE may report, to the base station, guard band sizes corresponding to respective quadrature phase shift keying (QPSK), 16 quadrature amplitude modulation (QAM), 64 QAM, 256 QAM, and 1024 QAM which are modulation orders available when receiving a PDSCH. That is, the UE may report, to the base station, a guard band size when using QPSK, a guard band size when using 16 QAM, a guard band size when using 64 QAM, a guard band size when using 256 QAM, and a guard band size when using 1024 QAM to the base station. The UE may report, to the base station, guard band sizes corresponding to respective pi/2-BPSK, QPSK, 16 QAM, 64 QAM, 256 QAM, and 1024 QAM which are modulation orders available when transmitting a PUSCH. That is, the UE may report, to the base station, a guard band size when using pi/2-BPSK, a guard band size when using QPSK, a guard band size when using 16 QAM, a guard band size when using 64 QAM, a guard band size when using 256 QAM, and a guard band size when using 1024 QAM to the base station. In the example above, the UE may separately report, to the base station, the guard band sizes corresponding to the modulation orders of PDSCH and the guard band sizes corresponding to the modulation orders of PUSCH. Alternatively, the UE may report, to the base station, the guard band sizes that may be commonly applied to the PDSCH modulation orders and the PUSCH modulation orders. That is, when reporting the guard band size corresponding to QPSK, the guard band size may be used for PDSCH reception and PUSCH transmission.

The UE may report, to the base station, a maximum supported modulation order where an SBFD symbol (e.g., symbol in which an SBFD subband has been configured) may be scheduled. That is, when a PDSCH is scheduled in an SBFD symbol, the UE may receive a PDSCH scheduled with a modulation within the maximum supported modulation order, but cannot receive a PDSCH scheduled with a modulation order exceeding the maximum supported modulation order. For example, the UE may be scheduled with a PDSCH in a non-SBFD symbol (e.g., symbol in which no SBFD subband has been configured) regardless of the maximum supported modulation order.

When a PUSCH is scheduled in an SBFD symbol, the UE may transmit a PUSCH scheduled with a modulation within the maximum supported modulation order, but cannot transmit a PUSCH scheduled with a modulation order exceeding the maximum supported modulation order. For example, the UE may be scheduled with a PUSCH in a non-SBFD symbol (e.g., a symbol in which no SBFD subband has been configured) regardless of the maximum supported modulation order. In the example above, the UE may separately report the maximum supported modulation order of PDSCH and the maximum supported modulation order of PUSCH to the base station. Alternatively, the UE may report, to the base station, both the maximum supported modulation order of PDSCH and the maximum supported modulation order of PUSCH, or may report commonly applied modulation orders.

The UE may report, to the base station, candidates of modulation orders of a PDSCH or/and a PUSCH which may be scheduled in an SBFD symbol (e.g., symbol in which an SBFD subband has been configured). That is, when a PDSCH is scheduled in an SBFD symbol, the UE may receive a PDSCH scheduled with one modulation among the reported candidates of the modulation orders, but cannot receive a PDSCH scheduled with a modulation order other than the reported candidates of the modulation orders. For example, the UE may be scheduled with a PDSCH in a non-SBFD symbol (e.g., symbol in which no SBFD subband has been configured) regardless of the reported candidates of the modulation orders.

When a PUSCH is scheduled in an SBFD symbol, the UE may transmit a PUSCH scheduled with one modulation among the reported candidates of the modulation orders, but cannot transmit a PUSCH scheduled with a modulation order other than the reported candidates of the modulation orders. For example, the UE may be scheduled with a PUSCH in a non-SBFD symbol (e.g., symbol in which no SBFD subband has been configured) regardless of the reported candidates of the modulation orders. In the example above, the UE may separately report the candidates of modulation orders of PDSCH and the candidates of modulation orders of PUSCH to the base station. Alternatively, the UE may report, to the base station, both the candidates of modulation orders of PDSCH and the candidates of modulation orders of PUSCH, or may report commonly applied modulation orders.

The UE may report a guard band size to the base station according to an index of an MCS including a modulation order and a code rate. An MCS table that the UE may use when receiving a PDSCH may include up to 32 rows. The respective 32 rows may include corresponding modulation orders or code rates. The UE may receive an indication of one row among the 32 rows, and may determine a TB length of a PDSCH or a TB length of a PUSCH, based on a modulation order or code rate of the indicated row. The UE may report guard band sizes for the respective 32 rows to the base station. Alternatively, the UE may combine the 32 rows into groups and report, to the base station, guard band sizes corresponding to the respective groups. Here, the group may be a set of rows having the same modulation order. Here, the group may be a set of rows having code rates within a certain range. For example, when dividing the rows into four groups, group 1 may include rows having a code rate lower than X1, group 2 may include rows having a code rate equal to or higher than X1 but lower than X2, group 3 may include rows having a code rate equal to or higher than X2 but lower than X3, and group 4 may include rows having a code rate equal to or higher than X3.

The UE may report guard band sizes to the base station according to MCS tables. The UE may be configured with MCS tables which may be used during PDSCH reception. For example, a first MCS table may include 64 QAM as a maximum modulation order. A second MCS table may include 256 QAM as a maximum modulation order. Here, the first MCS table may be an MCS table for more reliable communication. The UE may report guard band sizes corresponding to the respective MCS tables to the base station.

The UE may report guard band sizes to the base station according to waveforms. The UE may use a CP-OFDM waveform and a discrete Fourier transform (DFT)-s-OFDM waveform when receiving a PDSCH from the base station. In addition, the UE may use a CP-OFDM waveform and a DFT-s-OFDM waveform when transmitting a PUSCH to the base station. The CP-OFDM waveform and the DFT-s-OFDM waveform may require different guard band sizes. Therefore, the UE may report, to the base station, guard band sizes corresponding to CP-OFDM and DFT-s-OFDM, respectively.

The UE may report, to the base station, a size of a guard band at the upper frequency end of a UL subband and a size of a guard band at the lower frequency end of the UL subband, respectively. The size of the guard band between the lower frequency end of the UL subband and a DL subband, and the size of the guard band between the upper frequency end of the UL subband and a DL subband may be different from each other. This is because a frequency response of a subband filter (an rx filter, a baseband filter, or a digital filter) of the UE may be different. Therefore, the UE may report, to the base station, the size of the guard band at the upper frequency end of the UL subband and the size of the guard band at the lower frequency end of the UL subband, respectively.

The UE may report a type of the UE to the base station. A guard band size corresponding to the type of the UE may be predefined, or may be configured for the UE by the base station. For example, an SIB transmitted by the base station to the UE may include a value of a guard band corresponding to the type of the UE. For example, when a first type UE and a second type UE are defined, the first type UE may be a UE capable of operating based on a small guard band, and the second type UE may be a UE capable of operating based on a large guard band (a low-complexity UE, e.g., a reduced capability (RedCap) UE). A first size of a guard band corresponding to the first type UE and a second size of a guard band corresponding to the second type UE may be included in the SIB. The UE may report, to the base station, whether the type of the UE is the first type or the second type, and may determine, as a UE-specific guard band, a size of a guard band corresponding to the type.

The UE may be configured with a first guard band size and a second guard band size from the base station. Here, the first guard band size may be a cell-common guard band size. The second guard band size may be a UE-specific guard band size. The UE may receive the cell-common guard band size from the base station via the SIB. The UE may determine the UE-specific guard band size based on a UE capability report, or the UE-specific guard band size may be configured from the base station.

According to an embodiment, a method is provided for determining sizes of an UL subband, a DL subband, and a guard band when the UE is configured with the first guard band size and the second guard band size.

The UE may determine start RB indexes and last RB indexes of respective subbands, which are configured via cell-common signaling (e.g., an SIB). Here, SCSs are omitted for convenience.
An index of a starting RB and an index of a last RB of a cell-common first DL subband may be RBₛₜₐᵣₜ^{DL-SB1} and RB_{end}^{DL-SB1}. The number of RBs included in the cell-common first DL subband may be RB_{end}^{DL-SB1}−RBₛₜₐᵣₜ^{DL-SB1}+1. The cell-common first DL subband may be located at the lower frequency end of a cell-common UL subband.
An index of a starting RB and an index of a last RB of a cell-common second DL subband may be RBₛₜₐᵣₜ^{DL-SB2} and RB_{end}^{DL-SB2} The number of RBs included in the cell-common second DL subband may be RB_{end}^{DL-SB2}−RBₛₜₐᵣₜ^{DL-SB2}+1. The cell-common second DL subband may be located at the upper frequency end of the cell-common UL subband.
An index of a starting RB and an index of a last RB of the cell-common UL subband may be RBₛₜₐᵣₜ^{UL-SB} and RB_{end}^{UL-SB} The number of RBs included in the cell-common UL subband may be RB_{end}^{UL-SB}−RBₛₜₐᵣₜ^{UL-SB}+1.
An index of a starting RB and an index of a last RB of a cell-common lower frequency end guard band between the cell-common first DL subband and the cell-common UL subband may be RBₛₜₐᵣₜ^{guard_low} and RB_{end}^{guard_low}. The number of RBs included in the cell-common lower frequency end guard band may be RB_{end}^{guard_low}−RBₛₜₐᵣₜ^{guard_low}+1.
An index of a starting RB and an index of a last RB of an upper frequency end guard band between the cell-common second DL subband and the cell-common UL subband may be RBₛₜₐᵣₜ^{guard_high} and RB_{end}^{guard_high}. The number of RBs included in the cell-common upper frequency end guard band may be RB_{end}^{guard_high}−RBₛₜₐᵣₜ^{guard_high}+1.

Here, RB_{end}^{DL-SB1}+1=RBₛₜₐᵣₜ^{guard_low}, RB_{end}^{guard_low}+1=RBₛₜₐᵣₜ^{UL-SB}, RB_{end}^{UL-SB}+1=RBₛₜₐᵣₜ^{guard_high}, and RB_{end}^{guard_high}+1=RBₛₜₐᵣₜ^{DL-SB2} may be satisfied.

A size of the cell-common lower frequency end guard band and a size of the cell-common upper frequency end guard band may be determined based on a first guard band size (i.e., a cell-specific guard band size).

The UE may be configured with a second guard band size (i.e., a UE-specific guard band size). The UE may determine an index of a start RB and an index of a last RB of a UE-specific subband, based on the size configuration of each subband and a second guard band configured via cell-common signaling.

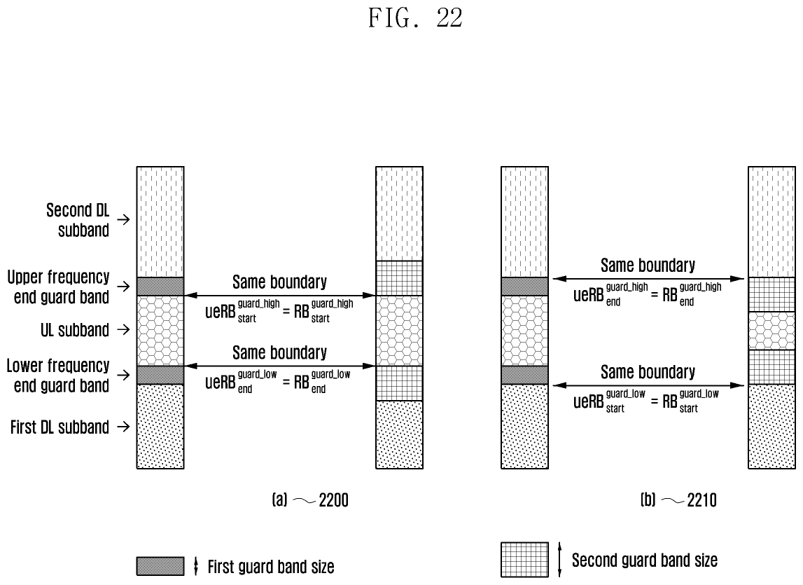

FIG. 22 illustrates a method in which a UE determines a UE-specific subband based on subband and guard band configurations according to an embodiment.

Referring to FIG. 22, diagram (a) 2200 illustrates a first method in which a UE determines a UE-specific subband based on subband and guard band configurations.

The UE may maintain (without changing) a cell-common UL subband, and determine, as a size of a second guard band (i.e., a UE-specific guard band size), sizes of guard bands at the lower frequency end and upper frequency end of the cell-common UL subband. In addition, RBs below the lower frequency end guard band may be determined as a UE-specific first DL subband, and RBs above the upper frequency end guard band may be determined as a UE-specific second DL subband.

More specifically, according to the size configuration of the second guard band, indexes of starting RBs and indexes of last RBs of the UE-specific subbands may be as follows.
An index of a starting RB and an index of a last RB of a UE-specific UL subband may be ueRBₛₜₐᵣₜ^{UL-SB}=RBₛₜₐᵣₜ^{UL-SB} and ueRB_{end}^{UL-SB}=RB_{end}^{UL-SB}. The number of RBs included in a cell-common UL subband may be ueRB_{end}^{UL-SB}−ueRBₛₜₐᵣₜ^{UL-SB}+1. That is, the UE-specific UL subband may be the same as the cell-common UL subband.
An index of a starting RB and an index of a last RB of a UE-specific lower frequency end guard band may be ueRBₛₜₐᵣₜ^{guard_low} and ueRB_{end}^{guard_low}=RB_{end}^{guard_low}. The number of RBs included in the UE-specific lower frequency end guard band may be ueRB_{end}^{guard_low}−ueRBₛₜₐᵣₜ^{guard_low}+1, which may be a value determined according to the second guard band size. That is, the index of the starting RB of the UE-specific lower frequency end guard band may be different from an index of a starting RB of a cell-common lower frequency end guard band. The index of the last RB of the UE-specific lower frequency end guard band may be the same as an index of a last RB of the cell-common lower frequency end guard band.
An index of a starting RB and an index of a last RB of a UE-specific upper frequency end guard band may be ueRBₛₜₐᵣₜ^{guard_high}=RBₛₜₐᵣₜ^{guard_high} and ueRB_{end}^{guard_high}. The number of RBs included in the UE-specific upper frequency end guard band may be ueRB_{end}^{guard_high}−ueRBₛₜₐᵣₜ^{guard_high}+1, which may be a value determined according to the second guard band size. That is, the index of the starting RB of the UE-specific upper frequency end guard band may be the same as an index of a starting RB of a cell-common upper frequency end guard band. The index of the last RB of the UE-specific upper frequency end guard band may be different from an index of a last RB of the cell-common upper frequency end guard band.
An index of a starting RB and an index of a last RB of a UE-specific first DL subband may be ueRBₛₜₐᵣₜ^{DL-SB1}=RBₛₜₐᵣₜ^{DL-SB1} and ueRB_{end}^{DL-SB1}.
An index of a starting RB and an index of a last RB of a UE-specific second DL subband may be ueRBₛₜₐᵣₜ^{DL-SB2} and ueRB_{end}^{DL-SB2}=RB_{end}^{DL-SB2}.

Here, ueRB_{end}^{DL-SB1}+1=ueRBₛₜₐᵣₜ^{guard_low}, ueRB_{end}^{guard_low}+1=ueRBₛₜₐᵣₜ^{UL-SB}, ueRB_{end}^{UL-SB}+1=ueRBₛₜₐᵣₜ^{guard_high}, and ueRB_{end}^{guard_high}+1=ueRBₛₜₐᵣₜ^{DL-SB2} may be satisfied.

Diagram (b) 2210 of FIG. 22 illustrates a second method in which a UE determines a UE-specific subband based on subband and guard band configurations. The UE may maintain (without changing) cell-common DL subbands, and determine, as a size of a second guard band (i.e., a UE-specific guard band size), a size of a guard band at the upper frequency end of a cell-common first DL subband and a size of a guard band at the lower frequency end of a cell-common second DL subband. In addition, RBs above the lower frequency end guard band and RBs below the upper frequency end guard band may be determined as a UE-specific UL subband.

More specifically, according to the size configuration of the second guard band, indexes of starting RBs and indexes of last RBs of the UE-specific subbands may be as follows.
An index of a starting RB and an index of a last RB of a UE-specific first DL subband may be ueRBₛₜₐᵣₜ^{DL-SB1}=RBₛₜₐᵣₜ^{DL-SB1} and ueRB_{end}^{DL-SB1}=RB_{end}^{DL-SB1}. The UE-specific first DL subband may be the same as the cell-specific first DL subband.
An index of a starting RB and an index of a last RB of a UE-specific second DL subband may be ueRBₛₜₐᵣₜ^{DL-SB2}=RBₛₜₐᵣₜ^{DL-SB2} and ueRB_{end}^{DL-SB2}=RB_{end}^{DL-SB2} The UE-specific second DL subband may be the same as the cell-specific second DL subband.
An index of a starting RB and an index of a last RB of a UE-specific lower frequency end guard band may be ueRBₛₜₐᵣₜ^{guard_low}=RBₛₜₐᵣₜ^{guard_low} and ueRB_{end}^{guard_low}. The number of RBs included in the UE-specific lower frequency end guard band may be ueRB_{end}^{guard_low}−RBₛₜₐᵣₜ^{guard_low}+1, which may be a value determined according to the second guard band size. That is, the index of the starting RB of the UE-specific lower frequency end guard band may be the same as an index of a starting RB of a cell-common lower frequency end guard band. The index of the last RB of the UE-specific lower frequency end guard band may be different from an index of a last RB of the cell-common lower frequency end guard band.
An index of a starting RB and an index of a last RB of a UE-specific upper frequency end guard band may be ueRBₛₜₐᵣₜ^{guard_high}=RBₛₜₐᵣₜ^{guard_high} and ueRB_{end}^{guard_high} The number of RBs included in the UE-specific upper frequency end guard band may be ueRB_{end}^{guard_high}−ueRBₛₜₐᵣₜ^{guard_high}+1, which may be a value determined according to the second guard band size. That is, the index of the starting RB of the UE-specific upper frequency end guard band may be different from an index of a starting RB of a cell-common upper frequency end guard band. The index of the last RB of the UE-specific upper frequency end guard band may be the same as an index of a last RB of the cell-common upper frequency end guard band.
An index of a starting RB and an index of a last RB of the UE-specific UL subband may be ueRBₛₜₐᵣₜ^{UL-SB}=ueRB_{end}^{guard_low}+1 and ueRB_{end}^{UL-SB}=ueRBₛₜₐᵣₜ^{guard_high}−1. The number of RBs included in a cell-common UL subband may be ueRB_{end}^{UL-SB}=ueRBₛₜₐᵣₜ^{UL-SB}+1.
The index of the starting RB and the index of the last RB of the UE-specific first DL subband may be ueRBₛₜₐᵣₜ^{DL-SB1}=RBₛₜₐᵣₜ^{DL-SB1} and ueRB_{end}^{DL-SB1}=RB_{end}^{DL-SB1}.
The index of the starting RB and the index of the last RB of the UE-specific first DL subband may be ueRBₛₜₐᵣₜ^{DL-SB2}=RBₛₜₐᵣₜ^{DL-SB2} and ueRB_{end}^{DL-SB2}=RB_{end}^{DL-SB2}.

Here, ueRB_{end}^{DL-SB1}+1=ueRBₛₜₐᵣₜ^{guard_low}, ueRB_{end}^{guard_low}+1=ueRBₛₜₐᵣₜ^{UL-SB}, ueRB_{end}^{UL-SB}+1=ueRBₛₜₐᵣₜ^{guard_high}, and ueRB_{end}^{guard_high}+1=ueRBₛₜₐᵣₜ^{DL-SB2} may be satisfied.

A UE may determine only a size of a UE-specific guard band, or may be configured with the size of the UE-specific guard band from a base station. Alternatively, in addition to the size of the UE-specific guard band, the UE may be configured with an index of a starting RB and/or an index of a last RB of the UE-specific guard band from the base station. In this case, the UE may determine a UE-specific subband based on the size of the guard band, the index of the start RB or/and the index of the last RB of the UE-specific guard band. In this case, the UE may disregard cell-common subbands and perform DL reception and UL transmission based on the UE-specific subband.

At least one of the aforementioned methods of determining subbands and guard bands may be used together.

More specifically, the UE may be configured with a guard band size from the base station, based on at least one of modulation orders, MCS indexes, UE types, and waveforms. In this case, the UE may perform DL reception and UL transmission according to a cell-common subband configuration, but may determine whether the following conditions are satisfied.

For example, when a guard band size is configured for each modulation order, the UE may operate as follows.

For example, the UE may be scheduled with a PDSCH on a DL subband. Here, the UE may determine validity of the PDSCH, based on a guard band size corresponding to a modulation order of the scheduled PDSCH. If it is valid, the UE may receive the PDSCH on the DL subband. If it is invalid, the UE may not receive the PDSCH. If a distance (e.g., the number of RBs and the guard band size, which may be identified in various methods described above) between RBs on which the PDSCH is scheduled and a UL subband is greater than or equal to the guard band size corresponding to the modulation order of the scheduled PDSCH, the UE may determine that the PDSCH is valid. Otherwise, the PDSCH may be determined to be invalid.

For example, the UE may be scheduled with a PUSCH on a UL subband. Here, the UE may determine validity of the PUSCH, based on a guard band size corresponding to a modulation order of the scheduled PUSCH. If it is valid, the UE may transmit the PUSCH on the UL subband. If it is invalid, the UE may not transmit the PUSCH. If a distance (e.g., the number of RBs and the guard band size, which may be identified in various methods described above) between RBs on which the PUSCH is scheduled and a DL subband is greater than or equal to the guard band size corresponding to the modulation order of the scheduled PUSCH, the UE may determine that the PUSCH is valid. Otherwise, the PUSCH may be determined to be invalid.

Although the embodiments above has been described with reference to a modulation order, but the present disclosure is applicable to at least one of an MCS index, a UE type, and a waveform.

A UE may receive or acquire, from a base station, configuration information for determining UL subbands, DL subbands, and guard bands for SBFD operations. The configuration information may be the aforementioned first information, second information, or frequency axis configuration information related to one of FIGS. 17 to 19, 22, 23, and 24. In addition, the UE may receive or acquire, from the base station, at least one of information for identifying CRBs (e.g., offsetToPointA), DL BWP information, UL BWP information, information for determining a reference SCS, and information on an SCS corresponding to each BWP.

The UE may identify at least one of UL subbands, DL subbands, and guard bands, based on the received or acquired information. For example, if the UE acquires the aforementioned first information or second information, the UE may identify at least one of UL subbands, DL subbands, and guard bands according to at least one combination of methods 1 to 4 described above. Alternatively, if the UE acquires the frequency axis configuration information related to one of FIGS. 17 to 19, 22, 23, and 24, the UE may identify at least one of UL subbands, DL subbands, and guard bands according to the methods described above.

The UE having identified at least one of UL subbands, DL subbands, and guard bands may perform the SFBD operation in at least one of the identified UL subbands, DL subbands, and guard bands.

The aforementioned examples of the operations illustrate exemplary methods that may be implemented according to the principles of the disclosure, and various modifications may be made to the aforementioned methods. For example, while illustrated as a series of operations, respective various operations may overlap, occur in parallel, occur in a different order, or occur multiple times. In another example, operations may be omitted or replaced by other operations.

A base station may determine at least one of UL subbands, DL subbands, and guard bands to be configured for a UE. The base station generates information indicating at least one of the determined UL subbands, DL subbands, and guard bands. The generated information may be the aforementioned first information, second information, or frequency axis configuration information related to one of FIGS. 17 to 19, 22, 23, and 24. In addition, the base station may transmit, to the UE, at least one of information for identifying CRBs (e.g., offsetToPointA), DL BWP information, UL BWP information, information for determining a reference SCS, and information on an SCS corresponding to each BWP. Alternatively, the base station may identify some of the information.

The base station may perform the SFBD operation with the UE in at least one of the UL subbands, DL subbands, and guard bands.

The aforementioned examples of the operations illustrate exemplary methods that may be implemented according to the principles of the disclosure, and various modifications may be made to the aforementioned methods. For example, while illustrated as a series of operations, respective various operations may overlap, occur in parallel, occur in a different order, or occur multiple times. In another example, operations may be omitted or replaced by other operations.

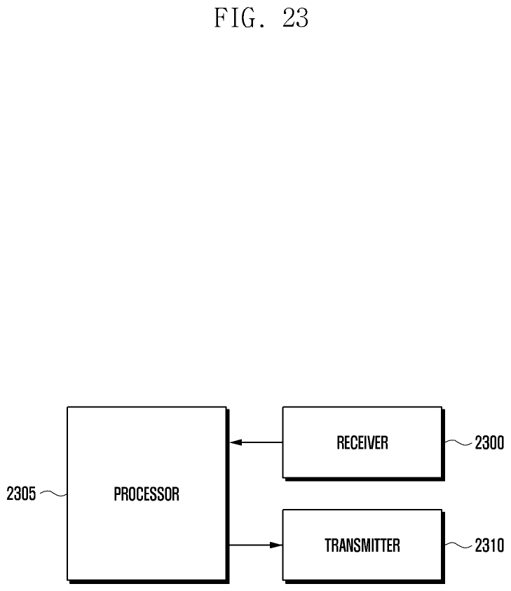

FIG. 23 illustrates a UE in a wireless communication system according to an embodiment.

Referring to FIG. 23, the UE includes to a receiver 2300, a transmitter 2310, and a processor 2305. The receiver 2300 and the transmitter 2310 may be collectively referred to as a transceiver. Although not illustrate, the UE may also include a memory. The receiver 2300, transmitter 2310, the memory, and the processor 2305 may operate according to the above-described communication methods of the UE as described above. The processor 2305 may control operations of the UE according to not only the above-described respective embodiments but also combinations of at least one thereof. Components of the UE are not limited to the above-described example. For example, the UE may include a more or fewer components than the above-described components. Furthermore, the transceiver, the memory, and the processor 2305 may be implemented in the form of a single chip.

The receiver 2300 and the transmitter 2310 may transmit/receive signals with a base station. The signals may include control information and data. To this end, the receiver 2300 and the transmitter 2310 may include a radio frequency (RF) transmitter configured to up-convert and amplify the frequency of transmitted signals, an RF receiver configured to low-noise-amplify received signals and down-convert the frequency thereof, etc. However, this is only an embodiment of the transceiver, and the components of the transceiver are not limited to the RF transmitter and the RF receiver.

In addition, the receiver 2300 may receive signals through a radio channel, and output the same to the processor, and the transmitter 2310 may transmit signals output from the processor through a radio channel.

The memory may store programs and data necessary for operations of the UE. In addition, the memory may store control information or data included in signals transmitted/received by the UE. The memory may include a storage medium such as a read only memory (ROM), a random access memory (RAM), a hard disk, a compact disc (CD)-ROM, a digital versatile disc (DVD), or a combination of storage media. In addition, the memory may include multiple memories.

Furthermore, the processor 2305 may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

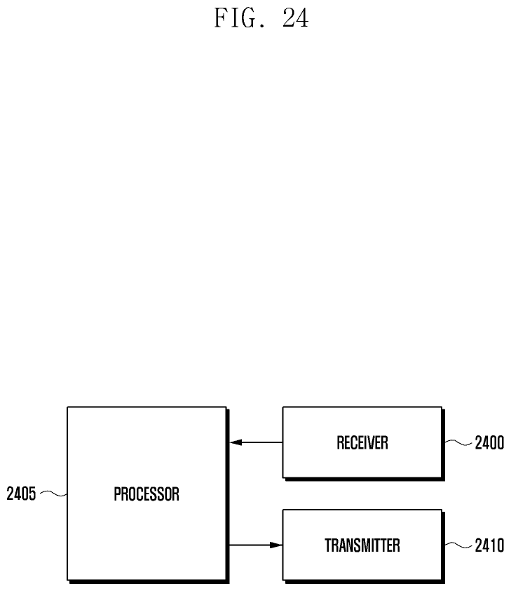

FIG. 24 illustrates a base station in a wireless communication system according to an embodiment.

Referring to FIG. 24, the base station includes a receiver 2400, a transmitter 2410, and station processor 2405. The receiver 2400 and the transmitter 2410 may be collectively referred to as a transceiver. Although not illustrated in FIG. 24, the base station includes a memory. The receiver 2400, the transmitter 2410, the memory, and processor 2405 may operate according to the above-described communication methods of a base station.

The processor 2405 may control operations of the base station according to not only the above-described respective embodiments but also combinations of at least one thereof.

Further, components of the base station are not limited to the above-described example, and the base station may include more or fewer components than the above-described components. Furthermore, the receiver 2400, the transmitter 2410, the memory, and the processor 2405 may be implemented in the form of a single chip.

The transmitter 2410 and the receiver 2400 may transmit/receive signals with the UE. The signals may include control information and data. To this end, the transmitter 2410 and the receiver 2400 may include an RF transmitter configured to up-convert and amplify the frequency of transmitted signals, an RF receiver configured to low-noise-amplify received signals and down-convert the frequency thereof, etc. This is only an embodiment of the transmitter 2410 and the receiver 2400, and the components of the transmitter 2410 and the receiver 2400 are not limited to the RF transmitter and the RF receiver.

In addition, the receiver 2400 may receive signals through a radio channel, and output the same to the processor, and the transmitter 2410 transmit signals output from the processor through the radio channel.

The memory may store programs and data for operations of the base station. In addition, the memory may store control information or data included in signals transmitted/received by the base station. The memory may include a storage medium such as a ROM, a RAM, a hard disk, a CD-ROM, a DVD, or a combination of storage media. In addition, the memory may include multiple memories.

The processor 2405 may control a series of processes such that the base station can operate according to the above-described embodiments of the disclosure. For example, the processor 2405 may control components of the base station to configure DCI configured in two layers including allocation information regarding multiple PDSCHs and to transmit the same. The processor 2405 may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a RAM, a flash memory, a ROM, an electrically erasable programmable ROM (EEPROM), a magnetic disc storage device, a CD-ROM, DVDs, other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

While the present disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a user equipment (UE) in a communication system, the method comprising:
receiving, from a base station, first information on a guard band between an uplink (UL) subband and a downlink (DL) subband for a subband non-overlapping full duplex (SBFD) via system information, wherein the first information on the guard band is cell-specific;
transmitting, to the base station, capability information on the guard band of the UE;
obtaining second information on the guard band, wherein the second information is UE-specific; and
identifying the UL subband, the DL subband, and the guard band based on the first information and the second information.

2. The method of claim 1, wherein the capability information on the guard band includes at least one of a configuration on the guard band per each of subcarrier spacings (SCSs), a configuration on the guard band per each of modulation orders, a configuration on the guard band per each of modulation and coding scheme (MCS) indices, a configuration on the guard band per each of waveforms supported by the UE, or a configuration on the guard band of a UE type.

3. The method of claim 1, wherein the UL subband is identified as a first UL subband indicated by the first information, and a size of the guard band is based on a size of second guard band indicated by the second information.

4. The method of claim 1, further comprising:
receiving, from the base station, scheduling information for DL data or UL data; and
identifying a validity of the scheduling information based on a configuration on the guard band associated with the scheduling information.

5. A method performed by a base station in a communication system, the method comprising:
transmitting, to a user equipment (UE), first information on a guard band between an uplink (UL) subband and a downlink (DL) subband for a subband non-overlapping full duplex (SBFD) via system information, wherein the first information on the guard band is cell-specific;
receiving, from the UE, capability information on the guard band of the UE; and
identifying the UL subband, the DL subband, and the guard band based on the first information and the capability information.

6. The method of claim 5, wherein the capability information on the guard band includes at least one of a configuration on the guard band per each of subcarrier spacings (SCSs), a configuration on the guard band per each of modulation orders, a configuration on the guard band per each of modulation and coding scheme (MCS) indices, a configuration on the guard band per each of waveforms supported by the UE, or a configuration on the guard band of a UE type.

7. The method of claim 5, wherein the UL subband is identified as a first UL subband indicated by the first information, and a size of the guard band is based on a size of second guard band associated with the capability information.

8. The method of claim 5, further comprising transmitting, to the UE, second information on the guard band of the UE based on the capability information, wherein the second information is UE-specific.

9. A user equipment (UE) in a communication system, the UE comprising:
a transceiver; and
a controller configured to:
receive, from a base station, first information on a guard band between an uplink (UL) subband and a downlink (DL) subband for a subband non-overlapping full duplex (SBFD) via system information, wherein the first information on the guard band is cell-specific,
transmit, to the base station, capability information on the guard band of the UE,
obtain second information on the guard band, wherein the second information is UE-specific, and
identify the UL subband, the DL subband, and the guard band based on the first information and the second information.

10. The UE of claim 9, wherein the capability information on the guard band includes at least one of:
a configuration on the guard band per each of subcarrier spacings (SCSs),
a configuration on the guard band per each of modulation orders,
a configuration on the guard band per each of modulation and coding scheme (MCS) indices,
a configuration on the guard band per each of waveforms supported by the UE, or
a configuration on the guard band of a UE type.

11. The UE of claim 9, wherein the UL subband is identified as a first UL subband indicated by the first information, and a size of the guard band is based on a size of second guard band indicated by the second information.

12. The UE of claim 9, wherein the controller is further configured to:
receive, from the base station, scheduling information for DL data or UL data, and
identify a validity of the scheduling information based on configuration on the guard band associated with the scheduling information.

13. A base station in a communication system, the base station comprising:
a transceiver; and
a controller configured to:
transmit, to a user equipment (UE), first information on a guard band between an uplink (UL) subband and a downlink (DL) subband for a subband non-overlapping full duplex (SBFD) via system information, wherein the first information on the guard band is cell-specific,
receive, from the UE, capability information on the guard band of the UE, and
identify the UL subband, the DL subband, and the guard band based on the first information and the capability information.

14. The base station of claim 13, wherein the capability information on the guard band includes at least one of:
a configuration on the guard band per each of subcarrier spacings (SCSs),
a configuration on the guard band per each of modulation orders,
a configuration on the guard band per each of modulation and coding scheme (MCS) indices,
a configuration on the guard band per each of waveforms supported by the UE, or
a configuration on the guard band of a UE type.

15. The base station of claim 13, wherein the UL subband is identified as a first UL subband indicated by the first information, and a size of the guard band is based on a size of second guard band associated with the capability information.

16. The base station of claim 13, wherein the controller is further configured to transmit, to the UE, second information on the guard band of the UE based on the capability information, and
wherein the second information is UE-specific.
